(19) United States
(12) Patent Application Publication
(10) Pub. No.: US 2016/0210707 A1
(43) Pub. Date: Jul. 21, 2016

(54) COMPUTER-IMPLEMENTED SYSTEMS AND METHODS FOR SIMULATING LARGE SCALE AUTOMATIC DATA COMBINATIONS

(71) Applicant: Domos, LLC, Stanford, CA (US)

(72) Inventor: James Frank STRNAD, II, Stanford, CA (US)

(21) Appl. No.: 15/085,711

(22) Filed: Mar. 30, 2016

Related U.S. Application Data
(62) Division of application No. 12/689,132, filed on Jan. 18, 2010.
(60) Provisional application No. 61/145,938, filed on Jan. 20, 2009.

(51) Int. Cl. G06Q 50/16; G06Q 40/06; G06Q 40/08

(52) U.S. Cl. CPC G06Q 50/167; G06Q 40/08; G06Q 40/06

(57) ABSTRACT

Computer-implemented systems and methods for simulating large scale automatic data combinations are provided for evaluating performance of equity models. A plurality of equity models are evaluated using large scale automatic data combinations. At least one equity model from the plurality of equity models is selected for use in generating and evaluating a simulation of equity amounts for a first stakeholder and a second stakeholder. Representations of the plurality of equity models are redisplayed to enable a new selection of a new model for generating and evaluating a new simulation of equity amounts.

### CROSS REFERENCE TO RELATED APPLICATIONS

This application is a divisional patent application of U.S. patent application Ser. No. 12/689,132, filed Jan. 18, 2010, both claiming priority from U.S. provisional patent application Ser. No. 61/145,938, filed 20 Jan. 2009, the entirety of each of which is incorporated herein by this reference thereto.

### BACKGROUND OF THE INVENTION

1. Technical Field

The invention relates to a computer implemented method and apparatus for establishing and executing a dynamic equity instrument. More particularly, the invention relates to a computer implemented method and apparatus for establishing and executing a class of dynamic owner occupied real estate (DOOR) instruments that provide equity investors with new methods to invest in owner-occupied real estate.

2. Description of the Background Art

Traditional mortgage finance and most proposed equity finance vehicles for owner-occupied real estate involve “capital structure” based payoffs at sale to homeowners and investors or creditors. Under a conventional financing consisting of a first mortgage and homeowner equity, the first mortgagee (typically a bank or an investor in a securitized pool) has a priority right to all of the proceeds from sale up to the principal balance, and the mortgagor (typically the homeowner) receives 100% of the excess over the principal balance.

Typical simple equity finance instruments combined with a first mortgage treat the contributions of the equity investor as a second mortgage with respect to priority, but instead of receiving interest payments, the equity investor receives a share of any appreciation of the home upon sale. For example, suppose that a home is purchased for $200,000 with a first mortgage of $160,000, a $20,000 equity note, and a $20,000 down payment. Assume that the equity note has a right to 25% of the appreciation. Ignoring possible amortization of the mortgage principal balance, upon sale the linear schedule of payments in decreasing priority order is: the first mortgagee receives the $160,000 principal balance, the equity note holder receives the $20,000 invested, the homeowner recovers his or her $20,000 down payment, then the homeowner and equity note holder split any amount in excess of $200,000 on a 75/25 basis.

Both these approaches are “static” in nature: The sharing rules are not a function of economic conditions such as the price path of the home or the evolution of interest rates. The sharing rules are piecewise linear as well as capital structure based: Returns to various parties at sale are fixed percentages of various capital structure slices.

### SUMMARY OF THE INVENTION

Computer-implemented systems and methods for simulating large scale automatic data combinations are provided for evaluating performance of equity models. A plurality of equity models are evaluated using large scale automatic data combinations. At least one equity model from the plurality of equity models is selected for use in generating and evaluating a simulation of equity amounts for a first stakeholder and a second stakeholder. Representations of the plurality of equity models are redisplayed to enable a new selection of a new model for generating and evaluating a new simulation of equity amounts.

This invention concerns a series of “DOOR instruments.” DOOR stands for “dynamic owner occupied real estate.” DOOR instruments provide equity investors with new methods to invest in owner-occupied real estate. Current equity instruments typically have piecewise linear schedules that assign equity shares, and these schedules are static, i.e., they do not change based on economic conditions or the actual value of the home. For example, suppose a home is purchased for $200,000 with a first mortgage of $140,000, an investment of $40,000 by an equity investor, and a $20,000 down payment. A typical sharing rule might be that all appreciation over the purchase price is split 50-50 between the equity investor and the homeowner while for amounts received at sale up to $200,000, the first mortgage ($140,000) is paid first, then the equity investor ($40,000), then the homeowner ($20,000). This approach is static because the sharing rule, e.g., the 50-50 split for appreciation, does not change as a function of economic variables or the home value. The sharing rule also is piecewise linear. The equity investor receives a flat percentage of the outcome over particular ranges of sales prices.

DOOR instruments permit allocations between the homeowner and equity investor that are preferably non-linear and dynamic. In a preferred embodiment of a DOOR instrument, the sharing rule can be more general than a linear schedule over various home value ranges, and it can be dynamic, i.e., the rule itself may change as a result of economic conditions or the value of the home. This approach allows the sharing rule to address many problems that are irreconcilable under a piecewise linear, static approach. Some of these problems include: financial strategies for the homeowner that are not sensible, e.g., effectively investing a large share of wealth in a single leveraged asset that is correlated with life outcomes so that home value and total wealth tend to decline sharply at the same time as income declines or a job loss occurs; suboptimal homeowner incentives to maintain the home; the inability of the investor to receive returns on owner occupied housing in a pure and transparent form; the inability to increase borrowing against the home without a costly refinance of the equity instrument; the inability to value instruments easily for purposes of creating or accepting new investments in investment pools; and the presence of incentives to strategically refinance equity instruments when home values fall.

A particular DOOR variant, referred to herein as ANZIE-DOOR, solves all of the aforementioned problems simultaneously. (The acronym “ANZIE-DOOR” is a tentative name. Commercial applications may use a different acronym for the same instrument. Provisional patent application Ser. No. 61/145,938 used “ANZ-DOOR” instead of “ANZIE-DOOR.”) This instrument lumps the homeowner's borrowing (first mortgage, second mortgage, etc.) and the homeowner's cash equity contributions (down payment, payments of principal on mortgages, etc.) into a single block (“the priority block”) and gives them legal priority over returns to the equity investor in the event of a low sales price outcome. This block effectively provides leverage for the investor's returns, and in the ANZIE-DOOR scheme the homeowner is credited with servicing the priority block “loan” via imputed interest payments. The homeowner's equity consists of two types. First, there is “committed equity” which includes all of the homeowner's cash equity contributions (down payment, payments of principal on mortgages, etc.), as well as certain other elements such as increments to home value due to homeowner improvements. Second, the instrument generates “insured equity” under a non-linear algorithm. At any given moment, this algorithm specifies a percentage. Upon sale the investor must pay the homeowner this percentage of the gross sales price regardless of the amount of gain or loss on the home computed in a conventional linear manner. For example, if the percentage is 10%, the home sells for $100,000, and $120,000 is due on the first mortgage, the investor must pay the homeowner $10,000 even though the situation is effectively a foreclosure. Any return computed in this manner is “insured equity” of the homeowner. The instrument also preferably creates a homeowner obligation to maintain the home to certain contractual standards. Failure to do so creates a right for the investor to reduce the amount of insured equity and other returns to the homeowner at sale (such as “committed equity” discussed below) by the cost of remediation. In many economic scenarios, the percentage used to compute the insured equity share under ANZIE-DOOR increases over time. The rate of increase is set to balance the equity investor's and homeowner's relative contributions and benefits (implicit rent, imputed interest on the priority block “loan,” property tax payments, etc.) and to reflect current economic conditions, e.g. non-mortgage and mortgage interest rates, as well as the value of the home.

(This introductory discussion presumes that the homeowner's net contribution is consistently positive. If it is negative for a period of time, during that period insured equity accumulates in favor of the investor rather than the homeowner. This possibility is discussed later in this disclosure both with respect to ANZIE-DOOR and other DOOR variants that involve insured equity.)

The rate is reset periodically, resulting in the parties receiving an updated, economically balanced deal at any point in time. As a result, there is no purely economic incentive for the homeowner to refinance, and valuing the instruments for pooling purposes is easy. Table 1 below shows an example of the operation of an ANZIE-DOOR instrument over time. The example assumes that a home is purchased for $200,000 financed by a $160,000 first mortgage and a $40,000 ANZIE-DOOR instrument. In Table 1 values are rounded to the nearest dollar. Various price paths are possible, and the exact results (rates of build up for insured equity and the time sequence of the percentage used compute insured equity) differ for alternative paths. The example is for a single possible price path: constant 7% annual appreciation in the value of the home. The “rate factor” in the second column of the table summarizes the impact of home value and various economic variables on the speed with which the percentage in column three used to compute insured equity increases. A higher rate factor results in faster increases in that percentage. The example assumes that homeowner contribution elements, other than implicit interest on the priority block “loan” that provides leverage for the investor, net out to zero. In the example, the rate factor declines persistently over time because the degree of leverage provided by the homeowner to the investor falls off over time. This decline is captured by “loan to value” (“LTV”) where the “loan” is the priority block, constant at $160,000 in the example, and “value” is equal to home value. The fact that the rate factor always declines as the years pass in the example is an artifact of the particular price path.

The homeowner's insured equity at any moment in time (sixth column in the table) is equal to the insured equity percentage (third column in the table) multiplied by the home value at that time (fourth column in the table). Although the insured equity percentage increases over time, if declines in home value overwhelm the impact of increases in the percentage during some period of time, insured equity falls during that period. Insured equity always increases in the example because no declines in home value occur.

As the homeowner pays down the mortgage, committed equity accumulates. Committed equity has priority over any payments to the instrument investor upon sale. The first mortgage balance and the committed equity are both part of the priority block, the “loan” from the homeowner that provides leverage for the investor. As a result, neither computing the rate factor nor computing the return to the investor in the example requires knowing how much the homeowner has paid down the first mortgage. Principal payments plus remaining principal always equal $160,000, the size of the priority block. As a result, for purposes of computing the rate factor, the homeowner's contribution in the form of supporting leverage for the instrument investor is the same regardless of how much principal remains on the mortgage. Furthermore, amounts upon sale available to the instrument investor equal the maximum of zero and an amount equal to home value minus $160,000. In the example, home value minus $160,000 is always greater than zero. Thus, the investor's position (seventh column of the table) is equal to home value (fourth column in the table) minus two amounts: $160,000 (the priority block that includes the remaining mortgage principal and accumulated principal payments by the homeowner) and the amount of homeowner's insured equity (sixth column in the table). The final column indicates the investor's annual percentage return based on the investor's position at the beginning of the year.

TABLE 1
Operation Of An ANZIE-DOOR Instrument Over Time
$200,000 Initial Value, $160,000 Priority Block, and $40,000 ANZIE-DOOR
Price Path: Constant 7% Appreciation Compounded

| | | insured | | LTV | homeowner | | investor |
|---|---|---|---|---|---|---|---|
| | rate | equity | home | (priority | insured | investor | % annual |
| year | factor | percentage | value | block) | equity | position | return |
| 0 | | 0% | $200,000 | 80.00% | | $40,000 | |
| 1 | 0.571 | 2.75% | $214,000 | 74.77% | $5,884 | $48,116 | 20.29% |
| 2 | 0.534 | 5.25% | $228,980 | 69.88% | $12,023 | $56,957 | 18.37% |
| 3 | 0.499 | 7.53% | $245,009 | 65.30% | $18,450 | $66,559 | 16.86% |
| 4 | 0.466 | 9.61% | $262,159 | 61.03% | $25,196 | $76,963 | 15.63% |
| 5 | 0.436 | 11.51% | $280,510 | 57.04% | $32,295 | $88,215 | 14.62% |
| 6 | 0.407 | 13.25% | $300,146 | 53.31% | $39,783 | $100,363 | 13.77% |
| 7 | 0.381 | 14.85% | $321,156 | 49.82% | $47,696 | $113,460 | 13.05% |
| 8 | 0.356 | 16.32% | $343,637 | 46.56% | $56,071 | $127,566 | 12.43% |
| 9 | 0.333 | 17.66% | $367,692 | 43.51% | $64,949 | $142,743 | 11.90% |
| 10 | 0.311 | 18.90% | $393,430 | 40.67% | $74,370 | $159,060 | 11.43% |
| 11 | 0.290 | 20.04% | $420,970 | 38.01% | $84,381 | $176,590 | 11.02% |
| 12 | 0.271 | 21.10% | $450,438 | 35.52% | $95,026 | $195,412 | 10.66% |
| 13 | 0.254 | 22.07% | $481,969 | 33.20% | $106,357 | $215,612 | 10.34% |
| 14 | 0.237 | 22.96% | $515,707 | 31.03% | $118,425 | $237,282 | 10.05% |
| 15 | 0.222 | 23.79% | $551,806 | 29.00% | $131,286 | $260,520 | 9.79% |
| 16 | 0.207 | 24.56% | $590,433 | 27.10% | $145,000 | $285,433 | 9.56% |
| 17 | 0.194 | 25.27% | $631,763 | 25.33% | $159,630 | $312,133 | 9.35% |
| 18 | 0.181 | 25.92% | $675,986 | 23.67% | $175,243 | $340,743 | 9.17% |
| 19 | 0.169 | 26.53% | $723,306 | 22.12% | $191,912 | $371,394 | 9.00% |
| 20 | 0.158 | 27.10% | $773,937 | 20.67% | $209,712 | $404,225 | 8.84% |
| 21 | 0.148 | 27.62% | $828,112 | 19.32% | $228,726 | $439,387 | 8.70% |
| 22 | 0.138 | 28.11% | $886,080 | 18.06% | $249,041 | $477,040 | 8.57% |
| 23 | 0.129 | 28.56% | $948,106 | 16.88% | $270,749 | $517,357 | 8.45% |
| 24 | 0.121 | 28.98% | $1,014,473 | 15.77% | $293,952 | $560,521 | 8.34% |
| 25 | 0.113 | 29.37% | $1,085,487 | 14.74% | $318,754 | $606,732 | 8.24% |
| 26 | 0.105 | 29.73% | $1,161,471 | 13.78% | $345,271 | $656,200 | 8.15% |
| 27 | 0.098 | 30.06% | $1,242,774 | 12.87% | $373,622 | $709,151 | 8.07% |
| 28 | 0.092 | 30.38% | $1,329,768 | 12.03% | $403,939 | $765,828 | 7.99% |
| 29 | 0.086 | 30.67% | $1,422,851 | 11.25% | $436,360 | $826,491 | 7.92% |
| 30 | 0.080 | 30.94% | $1,522,451 | 10.51% | $471,034 | $891,417 | 7.86% |

Because the investor's obligation to pay the homeowner an amount equal to the homeowner's insured equity is independent of the gain or loss from selling the home, the investor might have a net payment obligation upon sale. To illustrate outcomes upon sale in more detail, we assume that between purchase and sale the homeowner's insured equity percentage builds up to 10% and that the homeowner has paid $10,000 in principal on the $160,000 first mortgage, leaving a balance of $150,000. Table 2 below indicates the cash flows received by the various parties at sale for four different sales prices. (The table does not build in cost or investment amounts and thus does not indicate losses, gains, or profits.) The total cash flow outcome for each party at sale is the sum of the payout to that party dictated by the capital structure plus the net insured equity transfer to that party, if any. The cash flow outcomes illustrate that: (i) the homeowner's committed equity, as well as the first mortgagee's principal balance, have higher priority to the sales returns than the investor's equity; (ii) the homeowner's committed equity is subject to risk of loss due to a low sales price; (iii) in contrast, the homeowner always receives the insured equity due, assuming a solvent investor at the time of sale, even in the case of default on the first mortgage; and (iv) at sale, the investor may be required to make a net payment as high as the total amount of insured equity.

TABLE 2
Cash Flow at Sale -- Various Sales Prices
Total Amount Realized

| | | | | |
|---|---|---|---|---|
| Sales Price | $300,000 | $200,000 | $155,000 | $140,000 |

Capital Structure Outcome
(divide up Total Amount Realized)

| | | | | |
|---|---|---|---|---|
| 1st Mortgagee: | $150,000 | $150,000 | $150,000 | $140,000 |
| Principal | | | | (default) |
| Homeowner: | $10,000 | $10,000 | $5,000 | $0 |
| Committed Equity | | | | |
| Investor: | $140,000 | $40,000 | $0 | $0 |
| Residual Claim | | | | |

Insured Equity Transfer
(insured equity percentage = 10%)

| | | | | |
|---|---|---|---|---|
| Homeowner: | $30,000 | $20,000 | $15,500 | $14,000 |
| Investor: | −$30,000 | −$20,000 | −$15,500 | −$14,000 |

Cash Flow Outcome at Sale
(Capital Structure Outcome + Insured Equity Transfer)

| | | | | |
|---|---|---|---|---|
| Homeowner: | $40,000 | $30,000 | $20,500 | $14,000 |
| Investor: | $110,000 | $20,000 | −$15,500 | −$14,000 |

This example illustrates only a few features of the ANZIE-DOOR instrument, a single variant of the broad class of DOOR instruments. Some of the other variants operate quite differently.

Algorithms and methods for valuing and defining the instruments can be implemented using any number of ways known in the art. For example, for the variant described above, an algorithm for computing and updating the percentage that determines the insured equity due on sale can be used with embodiments of the invention.

Accordingly, embodiments of the invention provide a general approach to non-linear, dynamic home equity instruments and encompass variants other than the one described above. Some of these variants may involve additional mechanisms. For example, under some variants, the equity investor has an option or an obligation to pay down part of the principal of the homeowner's first mortgage by a specified amount each period or under certain defined circumstances. Another set of variants allow the homeowner to borrow against insured equity or to transform part or all of it into committed equity by reducing it and shifting it into the priority block that includes mortgage borrowing and committed equity. Still other variants permit the homeowner's initial down payment to be allocated between insured and committed equity, resulting in a situation where insured equity starts at a positive amount rather than at zero as in the example above. These and other variants will be apparent to skilled artisans from reading the description herein.

Some variants involve extensions in which a DOOR instrument is combined with debt financing or other interests in the home. For example, the investor or allied parties might lend the first mortgage funds, as well as making an equity investment in the home. Extensions of this kind permit mechanisms that adjust the mortgage terms, or other debt or equity terms, dynamically in coordination with the terms of the DOOR instrument. For example, the mortgage interest rate and amortization schedule for the mortgage might adjust each period along with the DOOR instrument terms. These and other extensions and the associated DOOR variants and mechanisms will be apparent to skilled artisans from reading the description herein.

Some variants include another feature: The DOOR instrument contract requires or allows cash payments from the homeowner to the investor prior to sale of the home or other events that terminate the instrument. These payments may be voluntary, may conform to some pre-set schedule or may be adjusted period-to-period under some preferably dynamic algorithm. Bringing such payments into the picture allows the homeowner to accumulate home equity under the DOOR instrument even when investors and homeowners anticipate that the main return to the home is implicit or explicit net rent rather than appreciation. (For purposes of the discussion herein, “net rent” is imputed or actual rent minus expenses such as property taxes and depreciation. In an explicit rental situation, it is the amount that the landlord would realize.) Without these payments, the accruals of insured equity to the homeowner might be small or even negative.

Even when expected appreciation is high compared to implicit or explicit net rent, adding homeowner payments to the investor results in a faster build up and higher ultimate level of homeowner insured equity, which is a contractual feature that might create a desirable bargain. The various possible payment schemes all meld easily into the dynamic adjustment algorithms that preferably are an element of DOOR instruments.

In other embodiments of the invention, payment schemes run in the other direction, i.e., from the investor to the homeowner. These DOOR variants and others that include cash payment schemes between the parties will be apparent to skilled artisans from reading the description herein.

### BRIEF DESCRIPTION OF THE DRAWINGS

FIG. 1 is a block schematic diagram showing a Z capital structure according to the invention;

FIG. 2 is a block schematic diagram showing a gain case for an ANZIE-DOOR arrangement according to the invention;

FIG. 3 is a block schematic diagram showing a loss case for an ANZIE-DOOR arrangement according to the invention;

FIG. 4 is a block schematic diagram showing a net contribution according to the invention;

FIG. 5 is a flow chart diagram illustrating the analytic machine that implements ANZIE-DOOR;

FIG. 6 is a flow chart diagram illustrating the analytic machine that implements SAVING-DOOR;

FIG. 7 is a block schematic diagram showing fixed supplemental payments to an investor for an ANZIE'S SIDE DOOR arrangement according to the invention;

FIG. 8 is a flow chart diagram illustrating the analytic machine that implements a version of ANZIE'S SIDE DOOR that incorporates supplemental payments to an investor;

FIG. 9 is a block schematic diagram showing a targeted insured equity scheme for an ANZIE'S SIDE DOOR arrangement according to the invention;

FIG. 10 is a flow chart diagram illustrating the analytic machine that implements a version of ANZIE'S SIDE DOOR that incorporates a targeted insured equity scheme;

FIG. 11 is a flow chart diagram illustrating the analytic machine that implements versions of LAZIE-DOOR;

FIG. 12 is a flow chart diagram illustrating the analytic machine that implements versions of FIXED-DOOR;

FIG. 13 is a block schematic diagram showing a gain case for an ANZIE'S NU DOOR arrangement according to the invention;

FIG. 14 is a block schematic diagram showing a loss case for an ANZIE'S NU DOOR arrangement according to the invention;

FIG. 15 is a flow chart diagram illustrating the analytic machine that implements ANZIE'S NU DOOR;

FIG. 16 is a flow chart diagram illustrating the analytic machine that implements ANZ TRIE DOOR;

FIG. 17 is a block schematic diagram showing an insured equity annuity version of a COZIE-DOOR arrangement according to the invention;

FIG. 18 is a flow chart diagram illustrating the analytic machine that implements the insured equity annuity version of COZIE-DOOR;

FIG. 19 is a block schematic diagram showing a committed equity lump sum version of a COZIE-DOOR arrangement according to the invention;

FIG. 20 is a flow chart diagram illustrating the analytic machine that implements the committed equity lump sum version of COZIE-DOOR;

FIG. 21 is a flow chart diagram illustrating the machine that implements IS-A-DOOR; and

FIG. 22 is a block schematic diagram of a machine in the exemplary form of a computer system 1600 within which a set of instructions for causing the machine to perform any one of the foregoing DOOR methodologies may be executed.

### DETAILED DESCRIPTION OF THE INVENTION

Equity Types and the “Z Capital Structure”

“Insured equity” and the “Z capital structure” characterize certain DOOR instruments. Central to these attributes is a distinction between two types of equity that an owner might have in a home. First, there is “committed equity.” The name arises from the fact that in most applications, this equity results from cash investments by the homeowner in the home: down payments, payments of mortgage principal, value increases due to improvements financed by cash, etc. Under conventional mortgage-financed housing, this type of equity is the only type. It sits on top of the debt layers of the capital structure, exposed to the first dollar of loss.

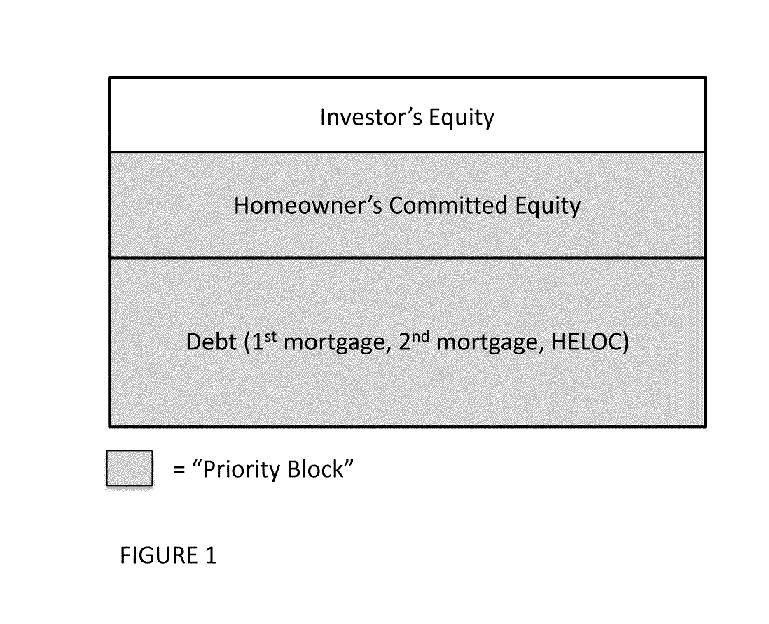

Under a “zero equity based capital structure” (“Z capital structure” for short), committed equity has priority over the DOOR instrument investor's equity. At the same time, the Z capital structure dictates that any appreciation in the home flows to the equity investor, not to the homeowner. The homeowner's committed equity sits in a more protected position similar to a second mortgage in terms of priority, and, as illustrated in FIG. 1 where elements lower in the figure have higher priority, the homeowner's committed equity plus any mortgage debt comprise a “priority block” that creates leverage for the investor's equity.

The investor is the “residual claimant” in the Z capital structure, receiving whatever is left over after paying off all the debt and the committed equity. The committed equity does not share in any home appreciation and therefore resembles junior debt. It is as if the homeowner does not have equity at all. Thus, the term “zero equity based capital structure.” It is nonetheless convenient to use the term “committed equity” because, in many of the applications, it signifies what the homeowner “put in” to the home. It also is exposed to the risk of loss and corresponds to the “equity” contributed by investors in many proposed equity finance vehicles. (To illustrate the position of the “equity note” in such proposed vehicles, suppose that a home is purchased for $200,000 with a first mortgage of $160,000, a $20,000 equity note, and a $20,000 down payment. Assume that the equity note has a right to 25% of the appreciation. Ignoring possible amortization of the mortgage principal balance, upon sale the linear schedule of payments in priority order is: the first mortgagee receives the $160,000 principal balance, the equity note holder receives the $20,000 invested, the homeowner recovers his or her $20,000 down payment, then the homeowner and equity note holder split any amount in excess of $200,000 on a 75/25 basis.)

In many of the variants discussed herein, the homeowner does participate in any appreciation of the home but through a second kind of equity, “insured equity.” Committed equity fits into the conventional capital structure of home ownership: It is similar to a second mortgage. Insured equity does not. Instead, insured equity is a contractual commitment by one party, typically the investor, to pay the other party a percentage of home value upon sale. (An arrangement that places the payment obligation on the investor is “typical” only in the sense that most homeowners want to be the recipient rather than the payer. Some instances are not “typical,” and it is desirable to permit or require the homeowner to be the payer. The discussion below includes examples of this “atypical” situation and corresponding DOOR implementations. For ease of exposition, much of the disclosure herein prior to that discussion simply presumes the “typical” situation where the investor is payer.)

Insured equity is “insured” in the sense that the investor is required to pay the requisite percentage of home value to the homeowner upon sale, even if the resulting amount exceeds the investor's equity in the home. In that case, the investor must front more money at sale, and that amount is very much like an insurance policy payout, mitigating the impact on the homeowner of a poor market outcome. It is worth emphasizing that insured equity is not based on a percentage of any particular capital structure slice. The capital structure is irrelevant. If the home ends up being worth less at sale than the principal balance on the first mortgage, then there is no equity in a conventional, capital structure sense, but the investor still must pay the requisite percentage of home value to the homeowner.

Having an insured equity stake does not mean the homeowner is totally insulated from market forces. If the insured equity is 10% of value, then the amount received on sale is higher if there are gains instead of losses on the home. What the scheme does is create an unleveraged stake in the home for the homeowner. This puts the homeowner in a position of being “in the market” regardless of whether home prices are high or low. The homeowner cannot be wiped out by moderate price declines in the face of a leveraged position and has a percentage interest if prices skyrocket. Thus, the insured equity approach is potentially valuable whenever the goal is to give the homeowner a market position in the home, but one that does not suffer from the risks inherent in leverage. The approach shifts those risks to the investor.

The discussion herein identifies subclasses of DOOR instruments by adding a suitable prefix to “DOOR.” Thus, “Z-DOOR” instruments are DOOR variants where there is the Z capital structure just described.

To make the Z-DOOR approach more concrete, consider an example. An individual purchases a home with no down payment for $200,000, financing the purchase with a $160,000 first mortgage and a $40,000 Z-DOOR instrument. Initially, the individual has no committed equity, but over time the individual makes principal payments totaling $10,000 on the mortgage, reducing the principal balance from $160,000 to $150,000. Those principal payments create $10,000 of committed equity. The priority block consisting of the committed equity plus mortgage debt remains the same size, $160,000. The payments merely shift the composition of the block toward committed equity and away from debt. Suppose that the insured equity percentage at the time of sale is 10%. Table 3 illustrates the sharing rule for various sale outcomes. (Table 3 is the same as Table 2 but is reproduced here for the convenience of the reader.)

TABLE 3
Results for Four Sales Outcomes - Z Capital Structure
Total Amount Realized

| | | | | |
|---|---|---|---|---|
| Sales Price | $300,000 | $200,000 | $155,000 | $140,000 |

Capital Structure Outcome
(divide up Total Amount Realized)

| | | | | |
|---|---|---|---|---|
| 1st Mortgagee: | $150,000 | $150,000 | $150,000 | $140,000 |
| Principal | | | | (default) |
| Homeowner: | $10,000 | $10,000 | $5,000 | $0 |
| Committed Equity | | | | |
| Investor: | $140,000 | $40,000 | $0 | $0 |
| Residual Claim | | | | |

Insured Equity Transfer
(insured equity percentage = 10%)

| | | | | |
|---|---|---|---|---|
| Homeowner: | $30,000 | $20,000 | $15,500 | $14,000 |
| Investor: | −$30,000 | −$20,000 | −$15,500 | −$14,000 |

Cash Flow Outcome at Sale
(Capital Structure Outcome + Insured Equity Transfer)

| | | | | |
|---|---|---|---|---|
| Homeowner: | $40,000 | $30,000 | $20,500 | $14,000 |
| Investor: | $110,000 | $20,000 | −$15,500 | −$14,000 |

The “insurance” aspect is clear from the two cases where the sales price is $155,000 or less. In both cases, the investor realizes nothing as residual claimant at sale, not even return of the amount originally invested. But the investor ends up making a payment to the homeowner, ensuring a return for the homeowner.

Priority Block Loan Status

The priority block functions as a “loan” from the homeowner to the investor. The example above assumed that this loan was non-recourse. To the extent that home value at sale is less than the priority block “principal,” the associated loss falls on the homeowner or on mortgagees that financed part or all of the block on behalf of the homeowner. The investor is not obligated to make up the losses.

Arrangements where part or all of the priority block loan is recourse are quite useful in some DOOR variants. The arrangement where the entire priority block loan is recourse is indicated by the letters “TR”—“totally recourse.” Under this arrangement, the investor is providing what amounts to complete “mortgage insurance” to the homeowner and to any mortgagees that have financed any part of the block. The outcomes for the Z capital structure in the example from the previous section would be quite different, as shown in Table 4 below.

TABLE 4
Four Sales Outcomes - Totally Recourse Priority Block Loan
Total Amount Realized

| | | | | |
|---|---|---|---|---|
| Sales Price | $300,000 | $200,000 | $155,000 | $140,000 |

Capital Structure Outcome
(divide up Total Amount Realized)

| | | | | |
|---|---|---|---|---|
| 1st Mortgagee: | $150,000 | $150,000 | $150,000 | $150,000 |
| Principal | | | | |
| Homeowner: | $10,000 | $10,000 | $10,000 | $10,000 |
| Committed Equity | | | | |
| Investor: | $140,000 | $40,000 | −$5,000 | −$20,000 |
| Residual Claim | | | | |

Insured Equity Transfer
(insured equity percentage = 10%)

| | | | | |
|---|---|---|---|---|
| Homeowner: | $30,000 | $20,000 | $15,500 | $14,000 |
| Investor: | −$30,000 | −$20,000 | −$15,500 | −$14,000 |

Cash Flow Outcome at Sale
(Capital Structure Outcome + Insured Equity Transfer)

| | | | | |
|---|---|---|---|---|
| Homeowner: | $40,000 | $30,000 | $25,500 | $24,000 |
| Investor: | $110,000 | $20,000 | −$20,500 | −$34,000 |

As illustrated by some DOOR variants discussed below, there are many useful possibilities that lie between the non-recourse and totally recourse extremes. To avoid a plethora of letter labels in instrument names, it is assumed that the non-recourse situation is the default, which is not indicated by a letter or acronym.

Adjustments, Periodicity & Embedded Options

DOOR instruments permit dynamic adjustment of quantities, such as insured equity, committed equity, and periodic transfer payments between the homeowner and investor.

Defining a particular DOOR-variant that involves dynamic adjustments requires specifying an algorithm that determines the nature, amount, and timing of the adjustments. Dynamic adjustments differ from static schedules. A DOOR instrument that is not dynamic might nonetheless incorporate pre-determined changes in particular parameters. For example, at origination an instrument might include a schedule specifying how the insured equity percentage changes over time. A static schedule of this sort is not affected by the evolution of stochastic variables, such as interest rates or the underlying home price. Dynamic adjustments themselves may involve changes in schedules. For instance, it might be that insured equity increases every year in favor of the homeowner but that the rate of accrual is adjusted annually based on economic conditions at the start of the year.

Dynamic adjustments can be periodic, stochastic, or elective. Periodic adjustments of various frequencies are possible, e.g., yearly, quarterly, monthly, or daily. A useful category of stochastic adjustments involves changing the instrument terms when key parameters reach certain values. Parties may elect to change certain instrument terms, triggering adjustment of other terms to compensate. The examples herein include instances of all three adjustment schemes. In many cases, the same instrument incorporates more than one scheme.

Each dynamic adjustment involves changing the terms of the instrument to reflect new conditions. There is an initial “adjustment”—the terms of the instrument when it is originated. In the case of a static instrument, these initial terms specify all future changes in instrument parameters. It is worth keeping in mind that a static instrument is the limit of a sequence of periodic dynamic instruments, where the period grows longer and longer. The DOOR instrument typically terminates on sale of the home. When the period is long enough, the probability of ever having an adjustment becomes vanishingly small because it is overwhelmingly likely that the home will be sold before any adjustment occurs. Effectively, the terms of the instrument are set once and for all when it originates.

Why would it be desirable to make periodic dynamic adjustments? There are a variety of reasons, but one is worth introducing early on: Dynamic adjustments can eliminate various options or reduce their value to negligible levels. Doing so makes valuation of the instruments easier, reduces moral hazard problems associated with strategic exercise of the options, eliminates conflicts of interest when the investor has a non-investment connection with the homeowner, and can make open investment pools viable.

When options are present, the instrument's actual value tends to deviate from its intrinsic value. Consider the conventional first mortgage loan. Such mortgages include a set of embedded options, most prominently the homeowner's option to default and the homeowner's option to prepay. These options complicate valuing the mortgage in the hands of the mortgagee. The intrinsic value of the mortgage is the amount of principal the mortgagee would receive if the mortgagor paid off the principal balance, thereby extinguishing the mortgage. This value is only realized prior to expiration if the mortgagor prepays. If interest rates drop enough, there is a financial incentive for the homeowner to refinance, exercising the option to prepay the existing mortgage and replacing it with a new one. In this situation the old mortgage in its alive state is worth more to the mortgagee than the amount of principal due. That is, the mortgagee is receiving interest payments on the remaining principal balance at a rate that is higher than market. As a result the present value of the future interest and scheduled principal payments exceeds the remaining principal balance.

Prepayment also may occur for other reasons. The homeowner may be better off moving to another city. Prepayment in this instance may result in a financial penalty for the homeowner. The interest rate on the mortgage on the new home may be higher than the one on the old home because rates have increased. Prepayment is a complicated phenomenon. It is made even more complicated by the fact that homeowner prepayment behavior is not optimal. Homeowners do not refinance when they should. The same is true with respect to the default option, the homeowner's option to stop making payments on the mortgage, surrendering the home to the mortgagee. The presence of prepayment and default options and the complexities of homeowner behavior with respect to these options make mortgage valuation difficult. If homeowners behaved “rationally,” defaulting and prepaying precisely when it was in their financial interest, default and prepayment patterns would be predictable in any economic environment. Valuation might not be simple, but it would be straightforward. Because homeowners do not behave rationally, valuation models must rely on past behavior patterns to predict future default and prepayment propensities. But there is no guarantee that past behavior patterns will persist under different economic conditions in the future, creating an additional layer of complexity and uncertainty.

Valuation difficulties tend to reduce the viability of open investment pools—arrangements where new investors may join the pool after it is originally created. Determining the proportional share of any new investor requires a valuation of the existing assets in the pool. If that valuation is infeasible, uncertain or very expensive, it is hard to run an open pool. Instead, a series of investment funds are required, each pooling investments finalized at a particular point in time.

Static equity instruments, including static DOOR variants, usually also include valuable embedded options. Consider a typical equity instrument. An individual finances a $200,000 home purchase with a $160,000 first mortgage, a $40,000 equity instrument, and no down payment. Assume that under the equity instrument contract, the instrument investor receives a specified share, say 50%, of any appreciation in the home's value. Suppose that the value falls to just above $160,000. At this point the intrinsic value of the equity instrument, the amount that the investor would realize on sale, is close to $0. However, the instrument would have substantial option value from the investor's standpoint if it were possible to preclude the homeowner from selling in the near future. The investor would capture the entire first $40,000 of any price advance from the $160,000 base and would realize 50% of all gains from appreciation above $200,000. The homeowner has a strong incentive to sell the home and purchase an equivalent one nearby to extinguish the investor's option. In effect, the homeowner has a “strategic sale option” that is worth exercising if the investor's option value (assuming no near term sale) exceeds the intrinsic value by a wide enough margin. The strategic sale option is analogous to the default option on a mortgage but there is no “default” trigger analogous to the mortgagor ceasing to make required interest and principal payments. No contractual terms are violated by selling the home to extinguish the equity note. The equity investor receives the amounts required by the terms of the note. (Consequently, in contrast to the case of defaulting on a mortgage, there should be no credit rating effects for the homeowner.)

Typically, the terms of equity instruments block the ability of the homeowner to achieve the strategic sale result by refinancing. For instance, the required payment to extinguish the note might be the maximum of the intrinsic value of the note and the amount originally invested. In the example above, the homeowner would have to pay $40,000 to extinguish the note.

As is the case with prepayment and default options on a mortgage, the potential return from exercising a strategic sale option changes the calculus for events, such as moving to another city, as well as creating an incentive for purely strategic behavior.

The strategic sale option can create conflicts of interest when the investor has a fiduciary or other relationship of trust with the homeowner. An example is a pension fund that uses equity notes to finance the homes of employees whose pensions are held by the fund. The pension fund as fiduciary should counsel the homeowner to act to extinguish the equity note when the intrinsic value is sufficiently below the investor's option value, but the pension fund as investor would bear the loss of any such action.

In sum, reducing the value of embedded options to negligible amounts or eliminating them altogether has some benefits. Doing so simplifies valuation, makes open pools viable, eliminates moral hazard problems arising from strategic exercise of the options, and alleviates any associated conflicts of interest when investors have an additional non-investment relationship with the homeowners receiving the investment funds.

How do periodic dynamic adjustments assist in this task? Consider the case of a conventional mortgage in an idealized setting that includes perfect competition and consummation of the loan coincident with deciding on the terms. Under these assumptions, at origination the intrinsic value of the mortgage must equal its actual value to the parties. The intrinsic value is the initial principal balance, the amount of the loan. The default and prepayment options have value at origination, but the terms of the mortgage compensate the lender for issuing the options to the homeowner. Typically, the mortgage interest rate is higher as a result of the options, and other features such as points also may figure into the compensation. This balance quickly dissipates as interest rates and the home price vary. Intrinsic value deviates from actual value.

This scenario also applies to static equity instruments, including static DOOR variants. Intrinsic value and actual value should be equal at origination in a market transaction, but this equality does not persist. A way to address the situation is to make adjustments in the instrument terms that restore the equality. After each round of adjustments, the actual and intrinsic values tend to diverge again. However, by making suitably frequent periodic adjustments, it should be possible to hold actual value close to intrinsic value at all times. In sum, periodic dynamic adjustments that restore a “market deal” by making actual value equal intrinsic value are a way to curtail or reduce the value of embedded options. If the homeowner terminates the instrument by exercising an embedded option, the homeowner does not realize any value in excess of the amount needed to replicate the deal under current market conditions.

It is important to note that not all investors agree on the intrinsic value or actual value of an instrument. In particular, different tax treatments may result in different valuations. Some investors are “inframarginal” for particular instruments. They would be willing to pay more than the market price for the instrument because they experience a net tax benefit not enjoyed by the “marginal” investor who sets prices. When the text speaks of equating actual value and intrinsic value, it is speaking on a pre-tax basis. Pre-tax prices including interest rates are affected by taxes because they reflect the marginal investor's tax situation. The issue of whether there is a need to take taxes into account as part of the dynamic adjustment process is discussed in the tax section later in this document.

Neutrality and Net Contribution Balance

A DOOR instrument is “continuously and strictly neutral” if its actual value is equal to its intrinsic value at all times. This very pure version of neutrality is not a practical target. Even if the adjustment process were continuous, leaving no time gaps for intrinsic value to diverge from actual value, the data required by the process is neither continuously available nor error free. There is an unavoidable element of approximation. As a result, the paper uses the terms “neutral” and “neutrality” somewhat loosely, connoting an approximation of continuous and strict neutrality. The accuracy of the approximation is not fixed but depends on the DOOR variant and on the details of its implementation.

“Net contribution balance” is a necessary and sufficient condition for neutrality and a key concept in the definition and implementation of neutral DOOR variants. Net contribution balance exists if the terms of an instrument reflect the relative contributions of the homeowner and the DOOR investor considered as joint venturers. One way to achieve this balance is to adjust the rate at which insured equity builds up, and several of the DOOR variants discussed below use the insured equity account as the balancing residual. Under these variants, typically the homeowner is making a net positive contribution to the venture absent taking insured equity into account. The build up of insured equity in favor of the homeowner compensates for that net contribution. The underlying rate of contribution over time fluctuates continuously with economic conditions and the value of the home. Dynamic instruments incorporate periodic adjustments that respond to those fluctuations by creating corresponding changes in the rate at which insured equity accrues.

If the adjustment process is accurate enough and frequent enough, the instrument reflects a “market deal” consistently. If it does not, either the homeowner or the investor is receiving a net benefit and the actual value of the instrument deviates from intrinsic value. The investor would be willing to invest more or would not be willing to invest as much as the amount the instrument would yield if terminated forthwith. In this sense, net contribution balance is a necessary condition for neutrality. It also is a sufficient condition. If the parties are experiencing a market deal, terminating the instrument to rewrite the terms while retaining the form of the deal cannot be beneficial to either party. The new deal is identical to the old one, and the transaction costs of “refinancing” are wasted. One or both parties may wish to change the form of the deal, exchanging one DOOR version for another. But, if all the alternatives are neutral, the parties simply are exchanging one market deal for another. There may be consumer or producer surplus in doing so, but neither party can garner a benefit from eliminating a deal that is worse than market or from retaining one that is better. The existing deal is “at market” because the relevant embedded options are valueless.

Implementing net contribution balance requires an examination of the various costs and benefits to the homeowner and investor of the joint enterprise. Rather than attempt to parse all of the relevant contribution elements, consideration is limited to a few major elements that are expressed in term of instantaneous flow rates with annual time units. These rates correspond to simply compounded spot interest rates where time is in annual units. If y(t) is a simply compounded rate at time t; then the amount y(t) dt accrues during an infinitesimal time period of dt years. If the investor faces an after-tax instantaneous constant borrowing and lending rate of i, then with continuous reinvesting or borrowing, the accrual at a constant rate y(t)=y during a year results in

$$\frac{y}{i} ( {e}^{i} - 1 )$$

of additional account value at the end of the year. For purposes of the discussion herein, income taxes are ignored both at the homeowner and investor level.

Four elements suffice to capture key features and result in a stylized but informative model:

r: Gross rent. Because the home is owner occupied, this “rent” is implicit or “imputed,” representing the consumption value of the home to the occupant.

m: Mortgage interest.

d: Physical depreciation in dollar terms. It is assumed that the homeowner or investor continuously pays this amount to maintain the structure in the same physical condition as at purchase.

p: Property tax.

Possible time variation in the rates is suppressed by not writing them as a function of time. These four rates describe the major features of a conventional investor-owned rental home situation. Ignoring the possibility that owner occupied implicit rent might differ from explicit rent, the instantaneous total cash flow rate to the investor is: f=r−m−d−p.

Several level variables that change over time, t, play a role. Some are stochastic and others are deterministic or under the control of the homeowner, investor or both:

H(t): The market value of the home.

M(t): The mortgage principal balance. (For simplicity, only the case where there is a single mortgage is considered, ignoring possible second mortgages, home equity lines of credit, etc.)

Mᵥ(T): The value of the mortgage. (In general Mᵥ(t)≠M(t) because of the value of the embedded prepayment and default options. Assuming no points or other one time compensation to the mortgagee and ignoring any divergence in values between the time the terms of the mortgage are agreed on and the time of origination, it should be the case that Mᵥ(0)=M(0). That is, the value of the default and prepayment options to the mortgagor (homeowner) should be offset by a higher interest rate paid to the mortgagee.)

Iₚ(t): The insured equity percentage.

I(t): The amount of insured equity accrued in favor of the homeowner. I(t)=Iₚ(t)H(t).

C(t): The “principal” amount of committed equity. (This amount is similar to the principal due on a second mortgage. It is not realized at the time of sale unless the sales price is sufficiently high.)

Cᵥ(t): The value of the committed equity. Cᵥ(t)≦C(t). At the time of sale, tₛ, if M(tₛ)<H(tₛ)−[M(tₛ)+C(tₛ)], then Cᵥ(tₛ)=[H(tₛ)−M(tₛ)]=C(tₛ). If H(tₛ)<M(tₛ), then Cᵥ(tₛ)=0.

P(t): The amount of the priority block. Note that P(t)=M(t)+C(t) even if H(t)≦M(t)+C(t). Thus, P(t) is the “principal” amount of the leverage provided by the homeowner to the investor.

L_{P}(t): The “loan-to-value ratio” for the priority block.

$${L}_{P} ( t ) = \frac{P ( t )}{H ( t )} .$$

E(t): The intrinsic value of the investor's equity in the home. E(t)=H(t)−P(t).

Three flow rates play an important role in defining some of the DOOR variants. These flow rates describe actual or putative flows between the homeowner and the investor.

iₚ(t): The applicable mortgage interest rate at time t if the priority block is a mortgage without default or prepayment rights, except at the time of sale. This mortgage has indefinite life, terminating only upon sale of the home or certain other specified events. At that time it is non-recourse with respect to the investor. i_{P}(t) depends on factors such as H(t), P(t) and L_{P}(t).

i_{f}(t): The risk free, i.e., default free, rate for a loan with a stochastic duration equal to the future life span of the home as a productive asset, assuming that the current structure remains in a fully functional state, i.e., the owners invest in the repairs required to offset depreciation.

x(t): Transfer payments from the homeowner to the investor specified or permitted under the contract governing the DOOR instrument. x is negative if the investor is making payments to the homeowner. The amounts of these payments do not correspond to traditional market-defined amounts, such as rent or interest. Instead, these transfer payments are one vehicle for adjusting the DOOR instrument terms to achieve the desired deal between the investor and homeowner.

Elements such as H(t) are stochastic. The change in such elements, as well as deterministic elements, during an infinitesimal time interval dt is denoted using the standard terminology of stochastic differential equations, e.g., “dH” for the instantaneous change in home value.

With all of these components in hand, how does one implement neutrality? There are many ways to do so, and different approaches are described below, each of which is a defining element of a DOOR variant or version.

Nonetheless, there are three common aspects:

First, it is important to assess the relative contributions of the parties. Exactly what these contributions are depend on the terms of the instrument. For example, suppose the homeowner is obligated on any mortgages. Then the homeowner is contributing the funds that comprise the priority block, P, directly in the form of committed equity and through borrowing as a mortgagor. The flow rate i_{P} is useful because it describes the benefit received by the investor in terms of leverage. The investor cannot default or prepay the priority block. As a result, i_{P} is a putative mortgage interest rate that is reduced to allow for the absence of default or prepayment options. (The homeowner has both these options with respect to any mortgage borrowing, but that borrowing is an aspect of how the homeowner finances the priority block. The block itself provides leverage for the investor.)

Second, if there is an imbalance in the contributions, neutrality is achieved by making offsetting contractual allowances. In some of the variants below, the key offsetting vehicle is the insured equity percentage. This vehicle is useful when transferring home value to or from the homeowner is a desirable aspect of the arrangement. But approaches using other accounts as the residual balancing element are sometimes superior. For example, using contractual transfer payments between the homeowner and investor as the balancing residual is a powerful method for creating DOOR variants with desirable characteristics.

Third, absent dynamic adjustments, neutrality does not persist. As the value of the home and economic parameters fluctuate, the original offsetting contractual allowances no longer achieve neutrality. Although in some variants the instrument works best if there are no adjustments or if adjustments are infrequent, neutrality is desirable in many cases.

A more exact description of how neutrality might be achieved is put off to the discussion of the first variant, ANZIE-DOOR. The letter “N” in its name indicates that the intention is for the instrument to be neutral. Prior to defining and discussing ANZIE-DOOR, it is necessary to describe certain maintenance conventions and the nature of the numerical simulations that underlie some of the examples herein.

Maintenance Conventions

DOOR instrument approaches create equity-like ownership shares for more than one party. As a result, it is necessary to specify contractual sharing rules for the cost of maintenance and for any reduction in value from physical depreciation of structures. These two items are intimately related because maintenance directly offsets depreciation.

The variants discussed below impose a maintenance obligation on the homeowner. Failure to meet this obligation results in the right to deduct commensurate amounts at the time of sale from the homeowner's insured equity and committed equity, in that order. Suppose it costs $4,000 to paint the home and that the maintenance contract requires the homeowner to do so periodically. If the homeowner fails to do it, then at sale, $4,000 is deducted in escrow from the insured equity amount due the homeowner.

This maintenance obligation creates dollar-for-dollar consequences for failure to maintain the home with respect to the items covered by the contract. Assuming fairly comprehensive coverage, this feature alleviates some very serious incentive problems with both traditional mortgage finance and most equity finance approaches. If a mortgage-financed home falls in value so that there is very little or no equity left, then the owner has, at best, reduced incentives to maintain the home. Any maintenance expenditures are likely to benefit the mortgagee rather than the homeowner. When the situation gets to the point where the homeowner has decided to default on the mortgage, the incentive to maintain the home falls to zero. The ensuing failure to do so contributes significantly to the large observed drops in value associated with foreclosures. The classic image, and sometimes the reality, includes looting, e.g., stripping the copper pipes, as well as vandalism with a homeowner who no longer cares and takes no protective steps.

In the case of an equity note, the situation usually is even worse. The same incentive problem exists when home value approaches the level of the first mortgage balance, but there also is a more general problem. Equity notes typically involve a shared appreciation rule, i.e., the homeowner and investor split any increase in value of the home. Under such rules, the homeowner who spends a dollar maintaining the home reaps less than a dollar of benefit upon sale. The homeowner maintains the home for consumption reasons, e.g., keeping it nicely painted to enjoy living in a nice looking home. But as sale approaches, there is an incentive to cut back on maintenance.

Combining a scheme where the homeowner builds up substantial insured equity with a fairly comprehensive maintenance obligation fixes the incentive problem even if mortgage finance is present. The insured equity creates a substantial stake for the homeowner even if the homeowner defaults on the mortgage and the home ends up “underwater” at sale, i.e., worth less than the mortgage principal due. Because this stake is subject to dollar-for-dollar reduction for failure to maintain the home, the homeowner has the correct economic incentives. The homeowner wants to spend on maintenance whenever the expenditures yield at least a dollar of benefit per dollar spent. The homeowner certainly wants to avoid the downward spiral of physical deterioration that typically begins during the pre-foreclosure period under conventional financing schemes. The new image is the armed homeowner warding off any potential looters or vandals. Thus, the goal is to deliver the home in good condition at sale to maximize the insured equity stake due at the close of escrow.

Maintenance obligation schemes are not self-executing. The nature of the obligation must be defined, and there is the possibility of disputes at the time of sale. There may be a trade off between clarity and comprehensiveness. Even a detailed list that includes items such as paint and plumbing tends to be incomplete. On the other hand, contractual maintenance obligations exist currently in several different forms. Rental contracts typically impose obligations on tenants to maintain the home and the requirement of a security deposit as surety. “Home warranty” insurance contracts exist in very large numbers. These contracts typically cover many of the major home elements, e.g., electrical or plumbing. The homeowner pays a premium, and the insurer pays for maintaining the specified home elements under contract. Clearly, maintenance obligation schemes are commercially practical. It is also worth noting that conventional homeowner's insurance covers some maintenance and repair, particularly work necessitated by certain casualties. A maintenance obligation scheme may include mandatory insurance, just as mortgages often do. The mandatory insurance may combine or even extend the coverage currently available under home warranty policies and conventional homeowner's policies.

The fact that maintenance obligation schemes are necessarily incomplete means that for many DOOR variants depreciation is split into two parts. One part involves items covered by the maintenance obligation or associated insurance. This part typically is the responsibility of the homeowner. The second part is what is left over. In many DOOR variants, including the whole subclass of Z-DOOR instruments, the investor is the residual claimant and suffers loss from any depreciation not covered by the homeowner's obligations. This reality means that implementation of a DOOR scheme typically requires finer parsing of the “flow of depreciation,” d, defined above. At a minimum, d might be broken down into two components, dₕ and dᵢ, the depreciation flows that are liabilities for the homeowner and the investor respectively. For simplicity, this parsing is ignored in the numerical examples that accompany explication of the DOOR variants below.

Numerical Simulations

The numerical examples developed herein are designed to create a stylized heuristic view of particular DOOR variants.

One major choice in modeling is to specify a price process for housing. The examples herein presume that home price, H, follows geometric Brownian motion with a constant drift, α, and a constant volatility, σ:

dH=αHdt+σHdZ.

This price process is particularly simple, leading to simulations that are easy to understand.

As a “baseline model” for the examples, geometric Brownian motion is used with σ=0.09 and α=0.07+σ²/2=7.405%. This value for α results in a geometric mean return of almost exactly 7%, a feature that is useful when comparing stochastic results to a case of a fixed 7% return. The fixed return outcomes correspond roughly to the mean returns under the stochastic version.

These values also contain an element of “realism.” The arithmetic means for annual price appreciation of Federal Housing Finance Agency (“FHFA”) housing prices indices for various Metropolitan Statistical Areas (“MSAs”) from 1976 to 2008 are concentrated in the 3% to 9% range. The 7.4% figure is therefore moderately high, i.e., considerably above the experience in MSAs such as Atlanta, Chicago or St. Louis, but distinctly below the outcomes in MSAs such as Boston, Los Angeles, New York or San Francisco. (Until recently, the FHFA indices were known as Office of Federal Housing Enterprise Oversight (“OFHEO”) indices. In late 2008, the FHFA took conservatorship of Fannie Mae and Freddie Mac and also absorbed OFHEO.)

Standard deviations for the FHFA MSA annual returns clump in the 3% to 11% range. Since home prices within each MSA were not perfectly correlated during 1976 to 2008, these index-based standard deviations are lower than the average standard deviation of the individual homes in the corresponding MSAs. Thus, it cannot be said that the 9% annual volatility used in the baseline model represents moderately high volatility based on being in the upper part of the 3% to 11% range. Nonetheless, the 9% volatility figure results in interesting examples for our purposes. In particular, using this volatility and 12,000 simulations in each example results in a suitably wide set of price results for the durations of interest. Because some of the examples will be compared to each other, the same seed is used for the random process in each example. As a result, each of the examples is based on the same simulated sample of 12,000 price paths.

The minimum and maximum outcomes bracket the vast majority of historical outcomes. As a result, the examples generated by the baseline model provide suitable intuition about the likely range of outcomes for various DOOR instruments.

The exercise has another very substantial element of artificiality. Home prices do not follow geometric Brownian motion. In particular, home price return series typically are positively auto-correlated and exhibit stochastic volatility. However, it is enough for purposes of the discussion herein to use a price generating process that results in a suitable range of outcomes for various durations. In addition, geometric Brownian motion is particularly easy to understand, yielding readily interpretable examples.

There are two final elements to specify to define the baseline model completely. First, as detailed below, outcomes under DOOR instruments may be a function of the expected duration of the instrument. The baseline model presumes a Poisson duration process with a mean length of ten years that is independent of the geometric Brownian motion that generates home prices. This process is described below in detail. A mean length of ten years corresponds to a median length of seven years, values that represent a degree of realism with respect to the duration of homeownership and of “long-term” financing for that ownership.

The second element to specify comprises two crucial interest rates. One of them is a very long-term riskless rate, and the other is the sum of a medium-term riskless rate and a risk premium. The baseline model presumes that all relevant riskless rates are constant across time and term at 0.05 annualized. That is, there is a flat term structure for riskless rates that persists during the time period of the examples. A more realistic model would include a time varying, stochastic term structure, but the assumed flat, constant term structure is appropriate given that the goal is to create examples that are clear and simple.

ANZIE-DOOR

Many of the features of ANZIE-DOOR have been explicated above. In the acronym “ANZIE,” the “N” stands for the goal of maintaining neutrality, the “Z” stands for application of the Z capital structure, and the “IE” stands for the presence of insured equity. The “A” stands for annual dynamic adjustments. Although more frequent adjustments might be desirable to keep the instrument close to being neutral, annual adjustments make examples easy to understand.

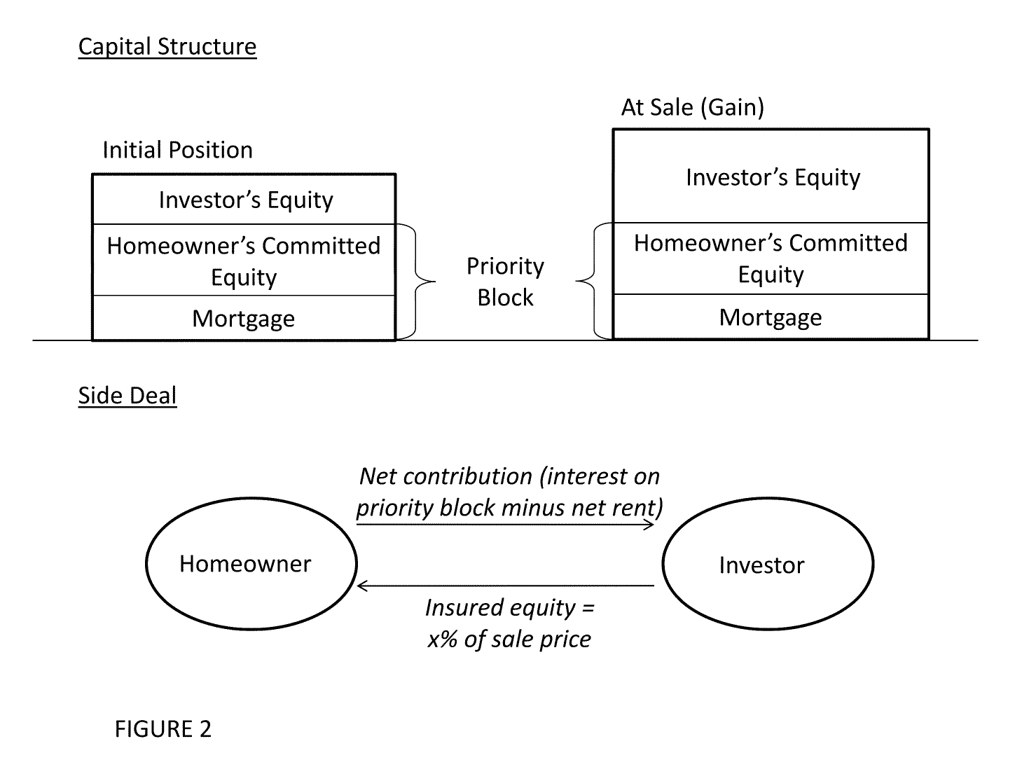

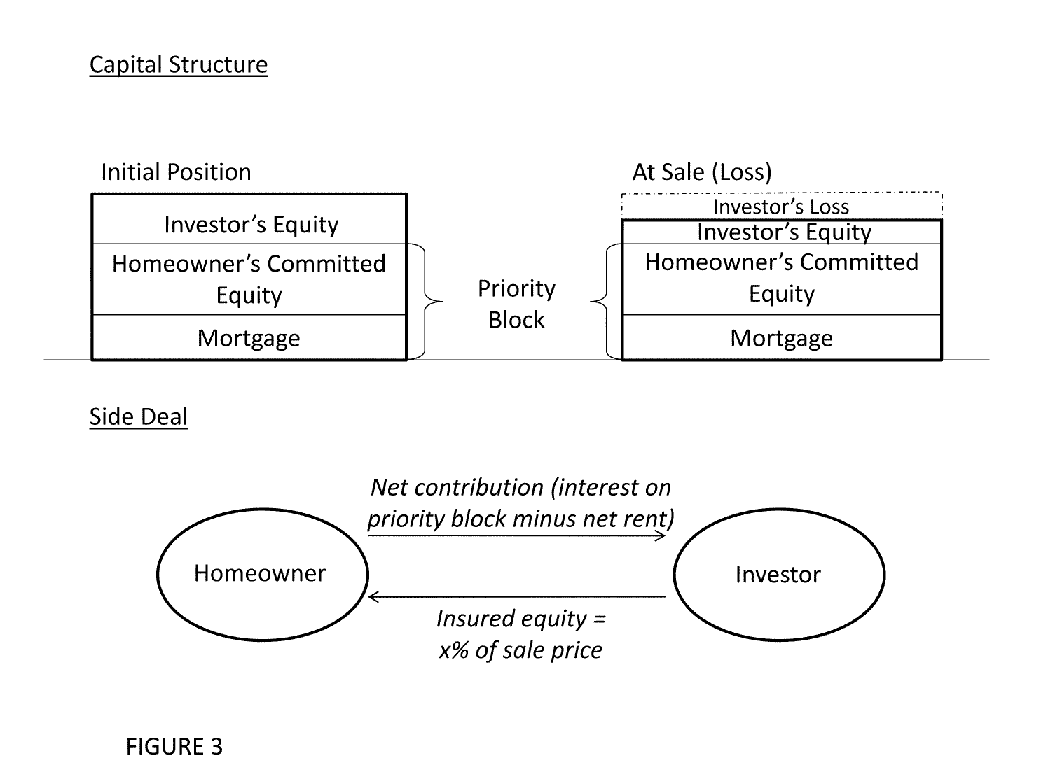

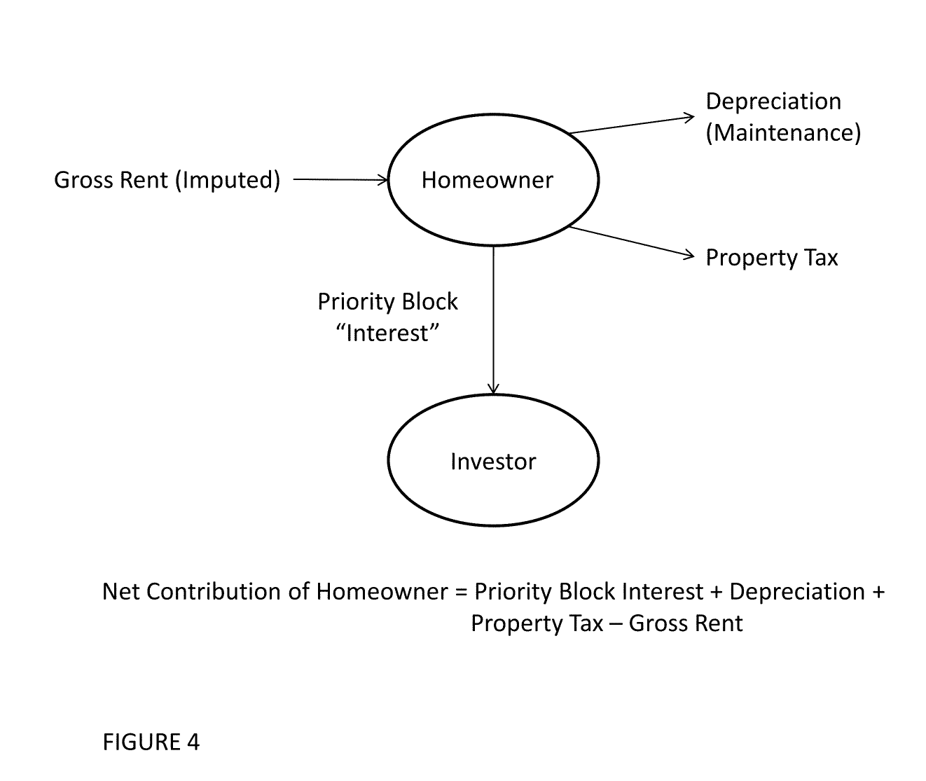

FIG. 2 is a block schematic diagram showing a gain case for an ANZIE-DOOR arrangement according to the invention; FIG. 3 is a block schematic diagram showing a loss case for an ANZIE-DOOR arrangement according to the invention; and FIG. 4 is a block schematic diagram showing a net contribution analysis according to the invention.

The major element that has not yet been described is the operation of the dynamic engine, i.e., the algorithm for making annual adjustments. As discussed previously, there are many ways to adjust to achieve neutrality. The different ways result in instruments suitable for different purposes. The discussion of this aspect of the invention, therefore, begins by describing the purposes that motivate the design of ANZIE-DOOR.

Normative Goals

ANZIE-DOOR has many possible applications but it is particularly suitable for: (i) workforce housing; (ii) homeowners with modest total wealth but adequate income, including the bulk of U.S. homeowners, as well as some modest income, low wealth families and individuals; and (iii) young workers with substantial incomes who are just beginning to build up wealth. Workforce housing involves workers such as teachers, firemen, and police officers who face high housing costs relative to their income in and near the communities they serve. There are public benefits to these workers living where they work.

Many U.S. homeowners have the bulk of their wealth in their home and have substantial mortgage debt. In addition, local home prices tend to be correlated with local economic conditions. When the local economy is stressed, drops in income and loss of jobs often coincide with loss of home equity. Anyone who has spent more than a few minutes in a basic finance course realizes that this financial strategy is just about the worst possible one. The homeowner has most or all of his or her wealth tied up in a single highly leveraged asset, and negative outcomes on this asset are correlated with negative human capital outcomes. There is a total lack of diversification, and instead of insuring against employment or income risk, the strategy amplifies that risk.

ANZIE-DOOR addresses this situation by allowing the homeowner to put little or no money into the home. The homeowner builds up an ownership stake through the accrual of insured equity. Cash savings may be used to invest in stocks, bonds, and other vehicles to create an intelligent portfolio in light of the homeowner's economic situation. The growing insured equity component permits the homeowner to establish a firm position in the housing market after a period of some years. This component is a percentage of home value. Once it reaches 15-20 percentage points, the homeowner potentially is in a position to use conventional finance on a subsequent home, if desired. In addition, because insured equity is in percentage terms, it protects both against a runaway housing market and a housing crash. In the former situation, the homeowner retains a very solid percentage interest independent of how high the run up goes, thereby remaining “in the game.” On the downside, the homeowner is in a strong position even if the conventional, capital structure based equity is wiped out and the home ends up being worth less than the mortgage balance.

In addition to being a financially sensible instrument, ANZIE-DOOR inherits all of the nice properties that follow from neutrality: (i) there are no incentives for a strategic sale or default; (ii) there are no conflicts of interest when the investor has fiduciary or other connections to the homeowner; (iii) valuation is easy because value equals intrinsic value; and (iv) as a result of (iii), it is easy to create open investment pools. ANZIE-DOOR includes a fairly comprehensive contractual maintenance obligation for the homeowner. Because insured equity typically builds up quickly, and the instrument or variants of it can be designed to ensure that it does, the homeowner has very deep dollar-for-dollar incentives to maintain the home even in the absence of having much, if any, of a conventional (capital structure based) equity position in the home.

The Z capital structure plus the presence of a substantial priority block leaves the investor with a very risky position in the home, the equivalent of the risk that the current system places upon the homeowner. This risky position is a very valuable diversification tool. For many years, economists and finance experts have known that owner-occupied real estate is an asset category with returns that are relatively uncorrelated with the major classes of investments available to institutional investors: stocks, bonds, commercial real estate and rental real estate. The problem has been that there are no tradable instruments for owner-occupied real estate issued in quantities sufficient to provide a vehicle for diversification on a large scale. ANZIE-DOOR and some related DOOR variants are possible vehicles of that kind. In addition, ANZIE-DOOR and the related variants are a powerful vehicle for investors who desire exposure in particular regions, cities or neighborhoods. It would be easy to pool DOOR instruments from the desired locale to achieve such exposure.

The Dynamic Engine—Achieving Neutrality over Time

Implementing neutrality in a dynamic fashion requires that in each period there is a balance of contributions and benefits between the investor and the homeowner. This balance depends on the details of the DOOR instrument. The discussion in this section addresses the particular balance achieved by ANZIE-DOOR, but it also serves as a general introduction to the “dynamic engine” that returns a DOOR instrument to neutrality periodically. This dynamic engine is a feature that makes DOOR instruments very flexible. Many aspects of the instrument may be altered periodically, but whatever the nature of the alterations, the dynamic engine makes adjustments that restore a “market deal” between the homeowner and investor.

The Contribution Balance

ANZIE-DOOR requires the homeowner to: (i) fund the “priority block” portion of the capital structure; (ii) cover depreciation charges to the extent required by the maintenance contract; and (iii) pay property taxes. For simplicity, it is assumed that the maintenance contract covers all depreciation charges. The homeowner receives the rental value of occupancy. It is convenient to define “net rent,” a flow variable equal to gross rent minus depreciation and property taxes:

n: Net rent. n=r−d−p.

Net rent is the homeowner's occupancy benefit offset by the depreciation and property tax liabilities. In the case of a pure rental property, net rent equals what the investor/landlord receives as rental cash flow before considering financing costs such as mortgage interest. The overall return on the home is equal to the net rent plus any appreciation. Both of these elements are stochastic. Let v(t) equal the expected annual rate of net rent accrual (approximately equal to the (net rent)/(price) ratio) and α(t) be the expected annual rate of appreciation as of time t. Then the expected total annual rate of return at that time is:

ρ(t)=v(t)+α(t) (1)

This expected rate of return includes a market-dictated risk premium.

During the year following an adjustment point at time tₐ, what is the balance of contributions and benefits between the homeowner and investor? The homeowner receives the net rent benefit but also funds the priority block. The investor as residual claimant receives any appreciation and also bears the risk of loss at the margin assuming that H(tₐ)>P(tₐ), i.e., home value is above the dollar amount of the priority block. The insured equity account sits on the sideline, representing a percentage of home value due the homeowner upon sale in compensation for cumulated past net contributions.

Under ANZIE-DOOR, the rate of accrual of insured equity is the balancing factor that achieves neutrality. Neutrality requires that the value of each participant's share under the operation of the DOOR instrument be equal to its intrinsic value. If this equality exists for the investor, it also must exist for the homeowner. (As discussed herein, neutrality is achieved on a pre-tax basis.)

It therefore suffices to focus on the investor. There are two elements of intrinsic value for the investor: the investor's liability under the insured equity account and the investor's equity as residual claimant to capital structure based returns. It is possible to narrow consideration to the expected return on the investor's residual claim, setting aside the insured equity account. The investor's liability with respect to that account is equal precisely to what the liability would be upon sale: the specified percentage of home value. The insured equity account is therefore left on the sideline. It belongs there conceptually in any event since it represents compensation for past net due contributions. What is important for neutrality is that the future accrual of insured equity compensates for any future imbalance in the relative contributions with respect to the home itself.

At an adjustment time, tₐ, the intrinsic value of the investor's equity in the home is E(tₐ)=H(tₐ)−P(tₐ). For E(tₐ) to equal the actual value of the DOOR instrument to the investor putting aside the current balance in the insured equity account, the remaining terms must result in an expected return on E(tₐ) equal to the expected return required by the market. E(tₐ) is a leveraged equity position. Underlying the position is a “priority block loan” from the homeowner to the lender with principal balance equal to P(tₐ) as of time tₐ. What is the relevant interest rate for the priority block loan? The loan is very similar to a mortgage loan except that the mortgagee (here, the homeowner) rather than the mortgagor (here, the investor) decides when the loan terminates. It terminates when the homeowner sells the home or pays off the DOOR instrument. The investor does not have a prepayment option. The loan is non-recourse with respect to the investor because the investor does not have to pay any part of the balance if the home value falls below P(tₐ), but the investor has only a partial default option. The investor cannot choose to stop paying “interest” or “principal” to the homeowner on the loan because those payments are mandated by the DOOR instrument, effectively in a “recourse” manner. The sense in which a default option exists is that the investor has no obligation to make good on any priority block balance remaining at the time of sale. The duration of the priority block loan is similar to the duration of a mortgage with no prepayment or default options. As a result, the applicable rate is iₚ(tₐ) as defined above. As a rough approximation, one might think of this rate equaling the hypothetical rate on a 30 year fixed rate mortgage stripped of its prepayment and default options except for default at the time of sale. If L_{P}(tₐ) is appropriately low, e.g., 0.8 or less, then a market rate that might be an appropriate approximation is the rate on 10-year US Treasury bonds. If L_{P}(tₐ) is large, e.g., at, approaching, or above 1.0, then a premium is necessary to reflect the added risk to the mortgagee (homeowner) of a high loan to value mortgage that is non-recourse at the time of sale. The issue of what rate to use is discussed comprehensively below.

The required rate of return for E(tₐ) given leverage equal to P(tₐ) expressed as a proportion of total home value is:

ρ_{P}(tₐ)=v(tₐ)+α(tₐ)−iₚ(tₐ)L_{P}(tₐ) (2)

The homeowner is contributing iₚ(tₐ)L_{P}(tₐ), but the net rent v(tₐ) flows to the homeowner rather than to the investor. Thus, the net contribution of the homeowner is:

Yₕ(tₐ)=iₚ(tₐ)Lₚ(tₐ)−v(tₐ) (3)

a quantity that represents the proportion πₕ(tₐ) of ρ(tₐ)=v(tₐ)+α(tₐ), the expected unleveraged market rate of return on the home:

$${π}_{h} ( {t}_{a} ) = \frac{{γ}_{h} ( {t}_{a} )}{ρ ( {t}_{a} )} = \frac{{i}_{P} ( {t}_{a} ) {L}_{P} ( {t}_{a} ) - v ( {t}_{a} )}{v ( {t}_{a} ) + α ( {t}_{a} )} \qquad ( 4 )$$

The accumulation algorithm that governs the accrual of home equity allocates the proportion πₕ(tₐ) of returns from the home during the period following adjustment time tₐ to the homeowner by translating that proportion in a risk adjusted fashion into an increase in the insured equity percentage of home value due the homeowner on sale. That algorithm is described next. Because πₕ is the critical driver of the rate of change of the insured equity percentage, it is referred to as the “rate factor.”

The Accumulation Algorithm

Various accumulation schemes are possible, each one defining a different DOOR variant. The goal under ANZIE-DOOR is for the homeowner to accumulate insured equity equal to a percentage of home value in a side account that represents the cumulative result of the homeowner's net contributions to the venture. As discussed above, this approach has an insurance aspect. The leverage provided by the priority block “loan” affects the investor's returns, but not the homeowner's insured equity position. If the outcome at sale ends up being low enough, the investor pays out more to the homeowner on the insured equity obligation than the investor realizes from the leveraged position on the home.

At the same time, the homeowner is not entirely insulated from fluctuations in home value. These fluctuations affect the homeowner because the insured equity account delivers a particular percentage of home value, not a particular amount of money. This dependence on home value is entirely appropriate if the goal is to put the homeowner in the housing game no matter where the housing market goes. For instance, if the insured equity percentage builds up to 20%, the homeowner is effectively in the game to the extent of having equity equal to the traditional minimum down payment amount to secure a “conforming loan.” ANZIE-DOOR makes this possible after some years of homeownership without requiring an actual down payment. It ensures that the homeowner is in the housing game without requiring the homeowner to engage in the financial foolishness of putting most or all of his or her resources into a single leveraged investment.

There are two key aspects to the accumulation scheme under ANZIE-DOOR.

First, the goal under ANZIE-DOOR is to leave the pure housing value risk in the hands of the investor. Thus, the rate of return used to accrue insured equity ownership to the homeowner is the certainty equivalent of the risky return (equals net rent plus appreciation) on the home rather than the risky return itself. The key rate of return is therefore i_{f}(t), the riskless rate for an investment of the same (very long) duration of the home as an asset. The algorithm allocates the proportion πₕ of this riskless return to the homeowner because πₕ, the rate factor, represents the homeowner's share of total return based on the homeowner's net contribution.

Second, consistent with the goal of ANZIE-DOOR to deliver a share in the home to the homeowner via the insured equity account, the algorithm translates this share of total return from each period into an overall percentage of ownership at the time of sale.

There is a third property that the accumulation scheme should have: neutrality. There should be no incentive for the homeowner (investor) to terminate the DOOR instrument prematurely in order to realize (pay out) the insured equity. Neither the homeowner's actual option to terminate the instrument nor a hypothetical option of the investor to terminate the instrument should have any value. Otherwise, the DOOR instrument is plagued with difficult valuation issues, and there are moral hazard costs associated with the homeowner's ability to terminate or delay terminating the instrument.

The ANZIE-DOOR accumulation scheme approximates neutrality by adjusting πₕ and i_{f}(t) to keep these parameters in alignment with current market values. As indicated by the “A” in the name, the instrument calls for adjusting πₕ, the rate factor, annually. One approach would be to do the same for i_{f}(t), adjust it annually along with πₕ. However, if i_{f}(t) is based on market prices, it would be easy and relatively costless to achieve greater accuracy by adjusting it more frequently, e.g., at the end of each trading day. In general, then, for purposes of accruing insured equity under ANZIE-DOOR, i_{f} and πₕ are set initially at time t₀ when the instrument is created and then one or both of them change at a sequence of times t₁, t₂, . . . , tₛ where tₛ is the time of termination. It is convenient to define the length of each time segment sᵢ=tᵢ−tᵢ₋₁ with Σᵢ₌₁^{s}sᵢ=tₛ−t₀, the lifespan of the instrument. That lifespan is equal to the duration of home ownership if the instrument terminates due to sale of the home but may be shorter if termination is due to other events such as refinancing.

The insured equity percentage at tₛ, the time of termination under ANZIE-DOOR is:

Iₚ(tₛ)=100*(1−e^{-Σ}^{ᵢ₌₁}^{^{s}}^{π}^{ₕ}^{(t}^{_{i−1}}⁾ⁱ^{_{f}}^{(t}^{_{i−1}}^{)s}^{ᵢ}₎ (5)

Consider the case where πₕ is positive, i.e., the homeowner continually is making a net contribution. Then, Iₚ is 0% initially and grows toward 100% as time goes on. It can never exceed 100%. The rate of growth increases with larger values of πₕ or i_{f}. If the homeowner's net contribution is a bigger proportion, πₕ, of total return or if the certainty equivalent value, i_{f}, of the return is higher, then insured equity accrues more quickly.

Application of equation (5) results in an accumulation scheme with both of the first two aspects. The scheme compensates the homeowner for making a net contribution to the venture by allocating an appropriate share of home value to the homeowner. By using the certainty equivalent return to compute the share, the scheme ensures that the investor, and not the homeowner, is exposed to the risk inherent in a leveraged position in the home. As a result, the homeowner tends to experience a steady increase in the insured equity percentage regardless of the direction or volatility of the housing market.

There are many possible accumulation algorithms that implement neutrality for DOOR instruments. The choice between algorithms depends on how the homeowner and the investor want to allocate risk among themselves and also on the vehicle they find desirable as a way to compensate one party for net contributions by the other party. ANZIE-DOOR uses insured equity, computed through equation (5) as the “residual account” that balances the contributions of the parties. Other variants considered later herein allocate risk differently than ANZIE-DOOR, and some of them use different residual accounts.

To situate ANZIE-DOOR among the various alternatives, it is worth focusing in more depth on the nature of the risk allocation inherent in the particular algorithm that defines the instrument. An especially clear explication of that algorithm is possible by considering apparently unrelated efforts to address the “realization problem” in capital gains taxation. Most tax systems require a “realization” event, such as sale, before imposing a tax on capital gains or allowing a deduction for capital losses. This realization requirement creates two problems: “lock-in” and “strategic loss taking.” Investors benefit from delaying sales of assets with accumulated gains (“lock-in”) and accelerating sales of assets with accumulated losses (“strategic loss taking”). Delaying sale to put off taxes on gains results in a time value of money benefit for the investor. The investor can earn interest on the amount that otherwise would have been paid to the government during the period of delay. “Lock-in” results because investors continue to hold assets with gains, even if they believe the assets earn a below market rate of return before tax. The investor only sells if the anticipated shortfall in pre-tax return is severe enough to offset the deferral advantage. On the other side of the coin, realizing losses currently reduces the tax burden if these losses can be used to offset realized gains or other income. By immediately repurchasing the asset sold or by purchasing substitute assets that result in the same portfolio characteristics, the taxpayer can “wash out” the losses without making any portfolio change. If the repurchased asset shares or the substitute shares appreciate, then there is an offsetting accumulated gain that corresponds to the realized loss. But the taxpayer can delay any tax consequences for that gain by delaying sale of the asset or assets. (Modern tax codes typically have rules that negate such “wash sales,” but these rules have limited effectiveness and also collateral costs due the impact on investors who are buying and selling for purposes other than reducing taxes.) This “strategic loss taking” is worthwhile if the value accruing from taking the losses early on exceeds the transaction costs of making the required trades.

There is an analogy between the capital gains tax situation and the operation of neutral DOOR instruments. The tax rate on gains and losses in the capital gains situation corresponds to the rate factor, πₕ, which is the “tax rate” on home returns required by the DOOR instrument to compensate the homeowner for being a net contributor to the venture. No insured equity payout on the DOOR instrument occurs until sale or termination, just as the tax on capital assets does not occur until a sale or other realization event takes place. “Lock-in” obtains for the DOOR instrument if the investor expects to experience a favorable risk-adjusted compounding of past accrued insured equity versus taking the money out and investing it. If the opposite is the case, the investor has a purely financial incentive to terminate the DOOR instrument. The latter behavior is analogous to strategic loss taking. The similarity between the capital gains tax and neutral DOOR situations is what makes the proposed capital gains tax solutions relevant. Although none of the solutions apply directly in the DOOR setting, considering them sheds light on the properties of the ANZIE-DOOR accumulation algorithm.

One solution in the capital gains tax setting is to impose a “mark to market” system by computing losses and gains for tax purposes on a frequent periodic basis for assets that the taxpayer continues to hold. Under this system the taxpayer cannot delay the realization of gains and losses because all losses and gains are automatically realized. After each mark to market reconciliation, there are no tax losses or gains, and the option to trade the asset (or hold it) has no value if the purpose is tax reduction.

It is possible to delay the actual tax consequences until a later date but achieve the same result as a mark to market system by charging (crediting) the taxpayer interest at after-tax rates on delayed taxes (refunds). Such an approach was proposed by Vickrey (see W. Vickrey, Averaging Income for Income Tax Purposes, Journal of Political Economy, vol. 47, pp. 379-97 (June 1939)). Taxes for a particular asset accumulate in an account with two accrual components: (i) after-tax interest charges (credits) based on the account balance; plus (ii) taxes (credits) added to (subtracted from) the account due to current fluctuations in asset value. Using notation similar to Auerbach (see, A. J. Auerbach, Retrospective Capital Gains Taxation, American Economic Review, vol. 81, pp. 167-178 (March 1991)) the tax account, Tₛ, at time s in the Vickrey scheme evolves according to the following differential equation:

\dot{T}ₛ=r_{f}(1−τ)Tₛ+τãₛAₛ

where ãₛ is the stochastic rate of return at time s for an asset with value Aₛ, r_{f} is the riskless rate of return, and τ is the tax rate. The first term on the right hand side of the equation captures interest charges on the existing balance, while the second term represents the tax consequences of current gains or losses. When the asset is sold at time tₛ, the taxpayer pays Tₜ_{ₛ} to the government.

The Vickrey scheme works if the asset price path, past interest rates and past tax rates all are known. In that case, it is possible to compute Tₜ_{ₛ} based on past data. Auerbach, supra, creates a tax based on past data that eliminates strategic trading and lock-in when the asset's price path is not known, but the holding period, past interest rates, and past tax rates are known. For the simple case where during the holding period there is a flat term structure with a constant instantaneous risk free rate equal to r_{f} and a constant tax rate equal to τ, the tax due upon realization at time s for an asset purchased at time 0 is:

Tₛ=(1−e^{-τr}^{_{f}}^{s})Aₛ (6)

This tax is equivalent to imposing a tax at rate τ continuously on gains for an asset that increased at the riskless rate from time 0 until time s, reaching a final value of Aₛ. Under this imaginary price path, the asset's value at time 0 would have been A₀=e^{-τr}^{_{f}}^{s}Aₛ.

The insured equity account is analogous to the tax account in the Vickrey scheme. The insured equity account compensates the homeowner at sale for the past net contributions to the enterprise. These contributions are known, and it is possible to cumulate them with interest in a “reconciliation account” and then pay the homeowner the value of the account at the time of sale. Instead, as is apparent from equation (5), ANZIE-DOOR uses a scheme similar to the Auerbach approach: the insured equity account is expressed as an increasing proportion of home value. In the simple tax case described by equation (6), the proportion is equal to (1−e^{-τr}^{_{f}}^{s}), a quantity that starts out at 0 and grows to 1 in an inverse exponential manner. As mentioned above, one goal of ANZIE-DOOR is to ensure that the diligent homeowner who makes timely mortgage payments and does the required maintenance on the home is in the housing market game after a certain number of years. A scheme in which the homeowner accrues an increasing percentage of home value over time is ideal for this purpose. Whether prices explode or collapse, the homeowner has secured a certain percentage of home value and is in the game. The tax account in the Vickrey scheme does not have this property. If home prices explode, the account may end up being a trivial portion of home value, even if the homeowner has been diligent for a large number of years. It also may end up being negative if the underlying asset declines in value during part or all of the holding period.

The Auerbach scheme smoothes out the Vickrey outcomes relative to the asset price path by using a certainty equivalence version of the Vickrey approach. This version effectively substitutes the relevant risk free rate of return for the risky asset outcomes. ANZIE-DOOR uses an analogous scheme to achieve the desired results: (i) a homeowner making net contributions to the venture experiences a monotonic and pretty smooth increase in the insured equity percentage over time; and (ii) the asset return risk largely is shifted to the investor.

It is worth explaining the sense in which the Auerbach scheme is a certainty equivalence version of the Vickrey approach. At the heart of matter is a decomposition of the stochastic return on the asset, ã into the riskless return r_{f} plus excess return \tilde{∈}:

ã=r_{f}+\tilde{∈}.

Gordon (see R. H. Gordon, Taxation of Corporate Capital Income: Tax Revenue versus Tax Distortions, Quarterly Journal of Economics, vol. 100, pp. 1-27 (February 1985)) observes that taxing the excess return to capital over a risk free return has no impact on the value of the investment being taxed. Following Auerbach, it is possible to express this fact through a certainty equivalence operator, V(•). This operator converts risky market-price returns into the equivalent riskless return. Thus, V(ã)=r_{f}, and V(∈)=0. An intuitive way to think about the operator is to assume that a riskless security exists, perhaps an idealized version of U.S. Treasury Inflation Protected Securities, and observe that this investment is an alternative to risky investments. For example, one can invest a given amount in the riskless security and earn a return r_{f} or invest the same amount in the risky security and earn a return ã. The difference in the returns, \tilde{∈}=ã−r_{f}, is the excess return. In equilibrium, this excess return must have a certainty equivalent value of 0. The expected excess return E(\tilde{∈}) must compensate precisely for the added risk.

As Auerbach is careful to note, it is not true that the expected excess return is zero. It is equal to the risk premium demanded by the marginal investor to assume the risk inherent in the stochastic return. Unless this risk is fully diversifiable across the economy, it is the case that E(\tilde{∈})≠0. Auerbach, p. 170, Proposition 1, shows that a necessary and sufficient condition for a tax system to be what he calls “holding period neutral,” i.e., with a certainty equivalent value that is independent of the length of the holding period or the pattern of past asset price movement, is that:

V(\dot{T}ₛ)=r_{f}(1−τ)Tₛ+τr_{f}Aₛ. (7)

Auerbach notes that this condition is the certainty equivalence version of the Vickrey tax scheme where the tax due account changes according to:

\dot{T}ₛ=r_{f}(1−τ)Tₛ+τãₛAₛ.

As mentioned previously, under the Vickrey scheme, the taxes account, Tₛ, grows by two factors: (i) interest accruing on the existing balance; and (ii) tax liability changes flowing from current fluctuations in asset value. The certainty equivalence version of this equation translates this relationship into certainty equivalent changes. Interest accrues on the existing balance and tax liability accrues as if the asset earned the riskless rate of return. Analogously, in the ANZIE-DOOR scheme, insured equity accrues based on applying a “tax rate” that compensates the homeowner for net contributions to “gains” on the home assuming that it increased in value at the applicable riskless rate.

Another goal of ANZIE-DOOR is to make any early or delayed termination option worthless. Equation (5) is the analog of the Auerbach scheme which removes any tax-based incentive for deferring gains by delaying sale or accelerating losses by strategic loss taking. It would seem that this property would carry over, removing any opportunity to profit by early or delayed termination of the DOOR instrument. That intuition is wrong. There are two crucial differences between the tax trading setting and the housing finance setting. First, in the tax trading setting, the taxpayer faces whatever tax rates the government establishes. Second, the taxpayer cannot choose the applicable interest rate regime for the tax account.

In the case of housing finance, the homeowner chooses to use a particular DOOR instrument to finance the home and has the option of refinancing or terminating the DOOR instrument by sale or otherwise. As a result, the homeowner is not bound to the particular rate factor or interest rate regime embedded in an existing DOOR instrument that finances the home. Consider the rate factor. If the DOOR instrument begins with a particular rate factor, but conditions change making it possible to secure a more favorable rate factor, then the homeowner has an incentive to refinance. In the opposite situation, selling the home and terminating the DOOR instrument has an additional cost: The homeowner must give up a deal that is more favorable than what is available in the market. A taxpayer cannot choose the applicable tax rate, but the homeowner can change the DOOR rate factor by refinancing. Similarly, the homeowner can refinance to change the applicable interest rate for the instrument when the market interest rate shifts in a direction that makes the original instrument terms unfavorable to the homeowner.

Neutral DOOR instruments adjust the rate factor and the applicable interest rates frequently enough to avoid any build up of option value in either direction. This contrasts with the Auerbach scheme for capital gain taxation, where the mechanism does not require any intermediate adjustments. Indeed, it is designed to work when such adjustments are difficult or impossible because observing values prior to sale is costly or is not possible.

Interest Rate Issues

There are two critical interest rates that affect the operation of ANZIE-DOOR. The rate i_{P} measures the contribution of the homeowner arising from financing the priority block that provides leverage to the investor. The level of this rate directly affects the rate factor, πₕ, as is apparent from equation (4). i_{P} reflects the expected “medium” term duration likely to be associated with the DOOR instrument and is analogous to a long term mortgage rate adjusted to remove pre-sale default and prepayment options. Prepayment possibilities result in average durations for 30-year and 15-year mortgages that are much shorter than full term. The observed mean duration on these instruments may resemble the expected duration for DOOR instruments. Under DOOR, the investor does not have an option to prepay or default prior to termination of the instrument by sale or otherwise. If the DOOR instrument is neutral, the homeowner does not have a financial incentive to terminate the instrument. Instrument life depends on the length of the ownership period or circumstances that lead the homeowner to prefer a different financing arrangement. Similar factors play a big role in the duration of mortgages.

The second critical interest rate is i_{f} which translates the risky house returns into a certainty equivalent rate. This rate typically is a long-term rate reflecting the fact that the underlying home is likely to remain a productive asset far into the future.

In both cases, fixing a rate at the time the DOOR instrument is originated leads to potential option-motivated behavior. If rates increase, the homeowner wants to refinance the DOOR instrument to receive a faster accrual of insured equity. The homeowner is able to retain any existing low rate mortgage financing. The DOOR instrument is separate from any mortgage that funds part or all of the priority block. If rates decrease, selling the home and moving means giving up a deal more favorable than market. The homeowner has an incentive to remain in the home and can arbitrage by refinancing the priority block with a loan reflecting the new low rates.

There are two general approaches to vitiate the associated option values and distortions in behavior. First, i_{P} and i_{f} might be adjusted along with the rate factor on a periodic basis. Second, these rates might be adjusted more frequently. If they are a function of market rates, it would be easy to adjust the rates at the end of each trading day.

The situations for i_{f} and i_{P} differ. The i_{f} rate is the certainty equivalent return on the house as an asset independent of the holding period for the homeowner or the duration of the DOOR instrument. The i_{P} rate reflects compensation for a homeowner loan to the investor in an amount equal to the priority block. The homeowner can terminate this loan by refinancing the DOOR instrument or selling the home and can attempt to arbitrage it by financing the priority block with market loans. If the variable interest rate terms that govern i_{f} or i_{P} are not exactly compensatory, then the DOOR instrument is not a market deal, its actual value is not equal to its intrinsic value, and the possibility of arbitrage exists.

Consider the simpler case of i_{f} first. As discussed above, for typical owner-occupied real estate, i_{f} is the certainty equivalent rate for a very long-term investment. Assuming a nearly flat term structure for zero coupon rates greater than or equal to 25 years, i_{f} might be approximated by the 25-year US Treasury strip rate. This rate fluctuates over time, reflecting changes in expected real rates and inflation. To achieve neutrality, i_{f} must equal the actual certainty equivalent rate at all times. (It is easy to understand this point in the framework of Auerbach. Equation (7) must apply at each point in time. Suppose that the instantaneous certainty equivalent rate at time s is i_{c}(s) while the instantaneous rate used in the tax scheme described in equation (6) is iᵣ(s). Then differentiating equation (6) with respect to time and applying the valuation operator yields

V(\dot{T}ₛ)=i_{c}(s)Tₛ+i_{τ}(s)τ(Aₛ−Tₛ),

and the condition in equation (7) fails unless i_{c}(s)=i_{τ}(s).)

If i_{f} equals the actual certainty equivalent rate at all times, then there is no problem. Assuming the rate factor is correct, the insured equity percentage always increases at the correct rate. There are no arbitrage opportunities or embedded options with value. If the approximating rate is close enough, then the associated departure from neutrality is small, and any embedded options have values that are low enough that any economic effects, such as impacts on refinancing or mobility decisions, are negligible.

The situation for i_{P} is more complex. Unless the value of the home is equal to the priority block, a variable version of this rate does not equal the fluctuating rate of return for the home. Instead, i_{P} is an imaginary variable financing rate for the implicit loan between the homeowner and the investor equal to the priority block. The homeowner (“lender”) controls the duration of the DOOR instrument and, consequently, of the implicit loan. The investor (“borrower”) has no say in the duration but is along for the ride. Furthermore, there is an information asymmetry. The homeowner might know that the period of ownership is likely to be brief which means that the DOOR instrument and the associated implicit loan are likely to have only a short life, but the investor often has little or no insight into the homeowner's intentions that affect the duration of the instrument.

To simplify the discussion, assume that the homeowner funds the entire priority block with committed equity. That is, there are no mortgage loans. This step is conceptually legitimate because the financing decision with respect to the priority block is distinct from the implicit loan. Mortgage financing involves agreements between the homeowner and third party lenders. It does not involve the investor directly. In contrast, the implicit loan is part of the DOOR instrument terms between the homeowner and the investor. (Some second order phenomena involving mortgage financing that factor into DOOR neutrality computations are discussed separately below.)

Setting aside the insured equity account, the investor holds a leveraged equity position in the home. The implicit loan is “non-recourse.” If the home value drops below the amount of the priority block, the loss falls on the homeowner. The investor has no right to close the position until the home is sold and must pay “interest” on the loan up until the time of sale.

Suppose that the parties knew the future date of the sale. Then the investor's position would be the sum of two components: a European call option with an exercise price equal to P, the size of the priority block, plus an obligation to pay interest on the priority block at the applicable riskless rate up until the time of sale. (Recall that P is the “principal due” on the priority block, not the intrinsic or actual value of the block. For example, P=$80,000 means that the homeowner has priority to the first $80,000 of sales proceeds. It does not matter that the current home value, and thus the intrinsic value of the priority block, might be less than $80,000.)

The put-call parity relationship applies to European options:

c=H+p−Pe^{-iτ}−R

where c is the value of the call with exercise price P, p is the value of the put with the same exercise price, H is the current value of the home, i is the riskless rate (assumed constant across maturities—a flat term structure), R is the present value of the net rent during the life of the options, and τ is the time until expiration. The call is equivalent to owning the home, not collecting the net rent, buying a put, and borrowing via a zero coupon bond yielding i that grows to equal P, the exercise price, when the options expire. The obligation to pay interest up until the sale date has a present value of:

P∫₀^{T}ie^{-is}ds=(1−e^{-iT})P

The investor's overall position is equivalent to:

c−(1−e^{-iT})P=H−P+p−R

Under ANZIE-DOOR, i_{P} must compensate the homeowner for providing the put, as well as for the time value of money. The situation is analogous to a mortgage at issuance, where the interest rate reflects not only the time value of money, but also compensates the mortgagee for the prepayment and default options enjoyed by the mortgagor (homeowner).

During each annual period, the investor is effectively “renting” a put from the homeowner. Market rental terms are:

rₚ=ip+δₚp

where δₚ equals the expected “depreciation” rate on the put during the year expressed as a proportion of the initial value of the put. This expected depreciation rate as of time t is equal to

$$1 - \frac{E [ p ( t + 1 ) ]}{p ( t )} .$$

The expected depreciation is negative if the expected value of the put in a year is higher than the current value. That situation can easily occur if the expected rate of return on the home is not substantially greater than the riskless rate.

Taking into account both the time value of money and provision of the put, neutrality requires that

iₚP=iP+ip+δₚp

and we have:

$${i}_{p} = i + \frac{i p + {δ}_{p} p}{P} . \qquad ( 8 )$$

In words, i_{P} equals the risk free rate plus the rental cost of the put expressed as a fraction of P. The rental cost term represents a premium to the risk free rate that compensates the homeowner for providing leverage on a nonrecourse basis.

Obviously, equation (8) is a drastic simplification, even assuming that the put value, p, is easy to compute. The investor does not know when the homeowner will sell. Although the homeowner has better information on that front, the homeowner also may be uncertain. This situation is analogous to the mortgage market where the same uncertainty and asymmetry in information is present. The mortgagee must offer mortgage terms based on an assessment of the likely duration of the mortgage. Unlike the mortgage situation where the default and prepayment options complicate that assessment, ANZIE-DOOR strips out option elements. But uncertainty about when the homeowner might terminate the DOOR instrument is still present.

This uncertainty matters. Consider a simple model where the assumptions behind the most basic Black-Scholes model for pricing European options apply: a flat term structure with a time invariant riskless rate, an underlying asset (the home) that follows geometric Brownian motion with time invariant drift and volatility parameters, and no net cash flow returns (here: net rent=0). Thus, home price dynamics are described by the simple stochastic differential equation:

dH=αH dt+σH dZ

where H is home price, α is the constant drift, σ is the constant volatility, and dZ is the underlying Brownian motion.

Add a simple complication to the model: the exercise time for the European options (the termination time for the DOOR instrument) is random, dictated by a Poisson process with constant intensity per year, λ. This process implies a constant termination rate with the consequence that the expected life of the DOOR instruments remains the same regardless of how many years have elapsed since origination. One would anticipate that the expected future life would begin dropping off at some point. Although it is unrealistic, assuming a Poisson process is convenient because it leads to insight through an example that is easy to construct and understand.

Assume that innovations in the Poisson process are independent of the innovations in the geometric Brownian motion process that characterizes home price dynamics. (This assumption makes the example simple and clear, but is not realistic. It is likely that the pattern of home prices affects the duration of ownership.)

Suppose that the baseline model assumptions apply: an instantaneous riskless rate corresponding to 5% per year; an instantaneous expected annual rate of appreciation for the home equivalent to 7% geometric mean return per year; and instantaneous volatility (standard deviation) of the home price equal to 9% per year. Finally assume that the current home value is 100 and that P=120.

Creating an example where the priority block is greater than the home price serves the subsidiary purpose of showing how quickly insured equity accumulates in that situation.

The final column of Table 5 below computes the rate factor under the assumption that net rent is zero. The rate factor is very high, exceeding 1 except when 1/λ, the expected duration of the instrument, is quite long. (1/λ is the expected length of time until termination of the instrument. The median time until termination is about 0.7 as long. These relationships hold for a Poisson process with a constant intensity, λ, the situation assumed for purposes of the example.)

The situation where the priority block is “underwater” results in very high put value and very high values of i_{P}, ranging up to almost twice the riskless rate when the expected duration of the instrument is short. Duration has a big impact on i_{P} and on the rate factor. Both decline sharply, but remain high, as expected duration increases. The reason for the sharp decline is clear: As expected duration increases, it is more likely that the home appreciates enough before the instrument terminates for home value to cover the priority block. If that happens, the put expires worthless.

TABLE 5
The Impact of Expected Duration
Imputed Interest Rate on Priority Block & Rate Factor
H = 100, P = 120, σ = .09, α = .07, i = .05
rate factor computation assumes net rent = 0% per year

| | current | expected | E(change) | | rate |
|---|---|---|---|---|---|
| 1/λ | put value | put value | put value | i_{P} | factor |
| 1 | 15.3067 | 10.4357 | 4.8709 | 0.0956 | 1.6389 |
| 2 | 12.5396 | 8.6519 | 3.8877 | 0.0863 | 1.4792 |
| 3 | 10.6807 | 7.4245 | 3.2562 | 0.0803 | 1.3760 |
| 4 | 9.3258 | 6.5156 | 2.8102 | 0.0760 | 1.3029 |
| 5 | 8.2870 | 5.8112 | 2.4758 | 0.0728 | 1.2478 |
| 6 | 7.4621 | 5.2474 | 2.2147 | 0.0703 | 1.2048 |
| 7 | 6.7899 | 4.7852 | 2.0047 | 0.0683 | 1.1701 |
| 8 | 6.2307 | 4.3989 | 1.8318 | 0.0666 | 1.1415 |
| 9 | 5.7578 | 4.0710 | 1.6868 | 0.0652 | 1.1175 |
| 10 | 5.3525 | 3.7891 | 1.5634 | 0.0640 | 1.0970 |
| 12 | 4.6932 | 3.3289 | 1.3643 | 0.0621 | 1.0640 |
| 15 | 3.9629 | 2.8168 | 1.1461 | 0.0600 | 1.0278 |
| 20 | 3.1484 | 2.2428 | 0.9055 | 0.0576 | 0.9877 |
| 50 | 1.4120 | 1.0104 | 0.4015 | 0.0527 | 0.9036 |
| 100 | 0.7361 | 0.5276 | 0.2085 | 0.0508 | 0.8713 |

An actual implementation would require many more elements of realism. The term structure is not flat. Interest rates are stochastic. House prices do not follow geometric Brownian motion, and so on. Although computing i_{P} in a realistic setting with a sufficient degree of accuracy is not trivial, the task is clearly delineated.

There remains the fact that the homeowner may have superior information about the likely duration of the instrument. The homeowner can arbitrage this information by financing the priority block appropriately. For instance, suppose the homeowner knows that duration in the home will be short. The homeowner can finance the priority block with an adjustable rate mortgage that results in very low interest costs in the early years of the loan. At the same time, the homeowner can enjoy high levels of i_{P} that reflect a longer expected duration.

This possibility is not a problem for two reasons. First, it would not create a financial incentive to refinance the DOOR instrument itself in a setting where all investors face the same information asymmetry. The terms of any refinanced instrument would not differ from the terms of the current instrument. Second, significant option elements that are present are entirely on the mortgage side, the deal between the homeowner and the mortgagee. Assuming frequent enough dynamic adjustments to come close to neutrality, the option elements associated with the DOOR instrument are not significant. The value of the instrument is very close to its intrinsic value.

The possibility of mortgage default does create some second order issues for the DOOR instrument. The DOOR instrument contract must address the situation where the default is credit related, i.e., whether or not the home is worth more than the principal due on the mortgage, the mortgagor is unable to make the payments on the mortgage due to loss of employment or other income-impairing events. For instance, the contract might give the investor the right to pay off part or all of the mortgage to avoid foreclosure costs and termination of the DOOR instrument. This possibility is implicit in ANZIE'S NU DOOR, a variant discussed below. It also is important to consider default that is not motivated by credit problems but by the home being “underwater,” i.e., worth less than the principal due on the mortgage. If the mortgage is non-recourse, the homeowner has an incentive to engage in strategic default. ANZIE'S NU DOOR completely eliminates this possibility, but for ANZIE-DOOR it makes the neutrality computation more complex. The computation must take into account the possibility that the DOOR instrument terminates due to the ensuing foreclosure sale. Of course, it is possible to address this situation through contract terms. ANZIE'S NU DOOR provides a complete contractual solution.

Adjustment Frequency

Even if the estimates of parameters such as i_{P} that determine the rate factor, πₕ, are errorless, periodic rather than continuous adjustment leaves an opening for embedded options to be significant. The homeowner has an incentive to re-finance the instrument in between adjustments if the rate factor on the existing instrument is unfavorable compared to the rate factor that applies to a fresh instrument. This situation arises when the home value and economic variables shift in such a way that the current rate factor understates the net contribution from the homeowner. If the current rate factor overstates that net contribution, then there is an embedded option effect in the opposite direction. The DOOR instrument is worth less than its intrinsic value in the hands of the investor, and the homeowner has an artificial incentive to remain in the home to enjoy the benefits of a DOOR that is more favorable than market.

Neither situation can arise under continuous and accurate adjustment, but adjustment is not costless. It involves among other tasks, valuing the home, typically without the benefit of a recent sale transaction.

Nonetheless, given current technologies and the costs thereof, in most cases it should be possible to assess and adjust the rate factor frequently enough that refinancing rarely will be profitable due to intraperiod fluctuations. For many homes quarterly, monthly or even daily assessment and rate factor adjustment is feasible. The most difficult element is valuing the home in the absence of a recent sale transaction. AVM (automatic valuation model) methods for estimating home values are quite accurate for many homes and involve computer calculations rather than appraisal or other labor-intensive methods. Many of the economic variables are readily available in the form of daily market prices or monthly data issued by governments, academic institutes or private sector analytic firms.

Thus, instead of ANZIE-DOOR, we might have QUANZIE-DOOR, MONZIE-DOOR, or DANZIE-DOOR, the same instrument with quarterly, monthly, and daily adjustment respectively.

Because adjustment is costly, the optimal approach probably is not to implement the shortest technically feasible adjustment period, i.e., some kind of approximation to “CANZIE-DOOR,” an instrument with continuous adjustment. (“CA” stands for “continuous adjustment.”) Such an approximation is possible and may even have a degree of accuracy in some cases. Certain data is periodic and only arrives monthly or quarterly.

Even actively traded instruments such as bonds and swaps that form a basis for the interest rates underlying the adjustment calculation are not traded every instant and are not traded at all during times when the market is closed. Various extrapolation and missing data techniques would be required to make the CANZIE-DOOR approximation as accurate as possible.

Trying to develop such an approximation is not crucial. It will suffice if the adjustment period is short enough to ensure that intraperiod fluctuations do not create potential refinancing gains in the face of transaction costs or departures from intrinsic value that are economically significant. Consider a monthly adjustment regime, MONZIE-DOOR for the variant we are considering. MONZIE-DOOR builds in an automatic monthly refinance that is virtually costless.

Refinancing during the month captures only the transitory benefit of a few days or weeks of a somewhat more advantageous rate factor. This benefit disappears at the next monthly adjustment. Moving forward from that point in time, the deal is the same whether or not the homeowner refinanced. Deviations from intrinsic value due to intraperiod fluctuations in the absence of refinancing have a similar transitory nature.

The extent to which transitory departures from intrinsic value are economically significant differs depending on which party, the homeowner or the investor, is the focus. Only the homeowner has the option to terminate DOOR instruments early. The cost to the homeowner of early termination depends on the context. If the goal is to “refinance” by remaining in the same home or an equivalent new home, then the relevant events are an actual refinance transaction or a “wash sale.” A wash sale is costly. Both selling the home and buying an equivalent one involve costs that are several percentage points of home value. A refinance transaction resembling current mortgage refinance also is costly. Closing costs in such mortgage refinances typically run a few percentage points of home value. However, one of the attractions of the DOOR approach is the possibility of refinance on the cheap. The potential is present to alter the terms of the instrument online for a few hundred dollars. If online refinance possibilities include a new instrument identical in form to the old one, then intraperiod refinances might be worthwhile in the face of very small gains that exploit transitory changes in economic conditions.

Controlling this possibility via a fee surcharge or restrictions on the ability to refinance into a substantially identical instrument is possible but would have undesirable side effects. Restrictions might postpone any adjustment until the next periodic adjustment time, when the terms of the instrument catch up to economic conditions in any event. The homeowner's other alternatives are a much more expensive refinancing arrangement or wash sale. Some homeowners might have refinance motives not related to exploiting intraperiod fluctuations to shift to a similar but not identical DOOR instrument. The scheme imposes a “refinance tax” on these homeowners that impedes welfare enhancing transactions.

On the other hand, a total failure to police this situation makes the adjustment calculation more complex. Embedded options would be back in play, and the adjustment calculation must take them into account. Very frequent adjustment might be the best approach because it avoids all of these problems.

Transaction costs loom large in the embedded option situation. If the cost of refinancing is high enough, the danger of homeowner option exercise via a strategic refinance or sale vanishes. On the investor side of the equation, and with respect to homeowner behavior that does not involve a “refinance,” the picture is quite different. For example, if the issue is a marginal impact on homeowner behavior such as moving to another city or, on the investor side, accurate valuation for purposes such as running an open investment pool, then the cost of deviations from intrinsic value is a continuous function of the size of the deviations rather than a function that jumps up from zero at the threshold level that triggers option exercise in the face of refinance costs. The potential gains from frequent adjustment are more obscure in these situations because the impact of failure to do so is harder to observe or estimate.

Assuming suitably accurate computer-based home valuation is feasible, daily adjustment might be easy and quite reasonable. Daily adjustment should eliminate any problems with deviations from intrinsic value due to temporal gaps between adjustments. Of course, the accuracy of the adjustment process itself remains a concern independent of frequency.

The Analytic Machine for Implementing ANZIE-DOOR

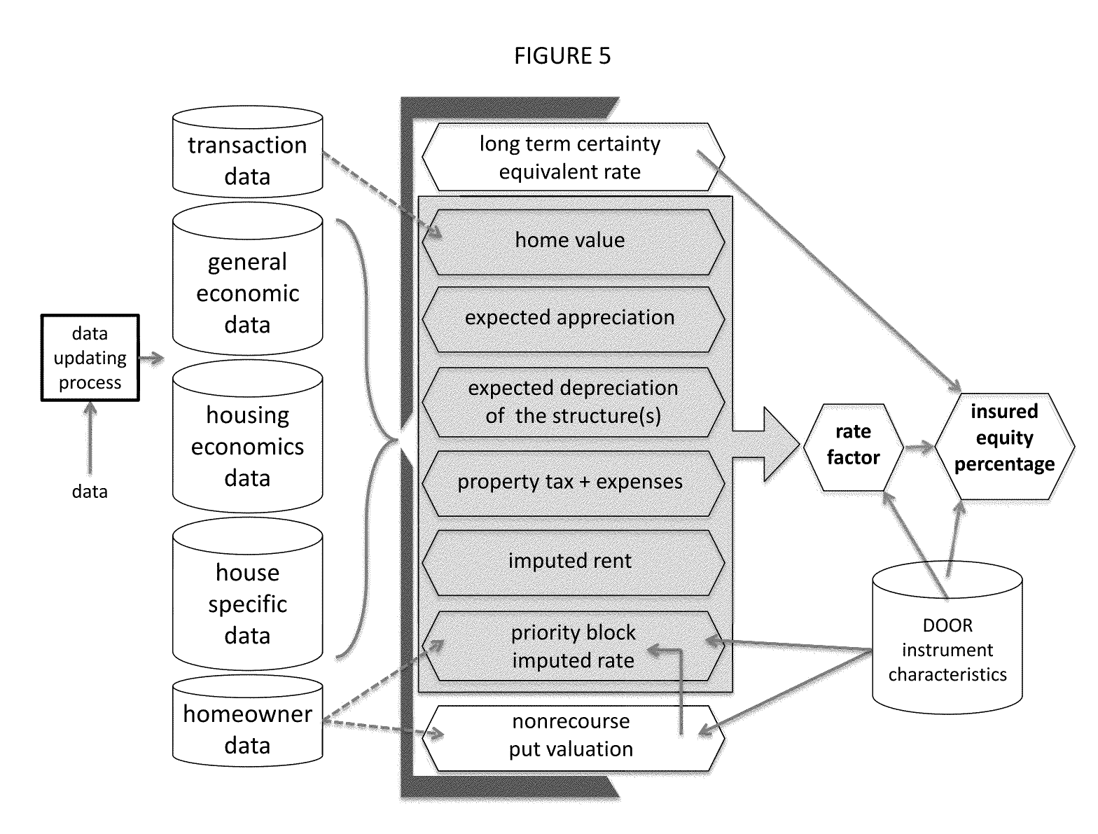

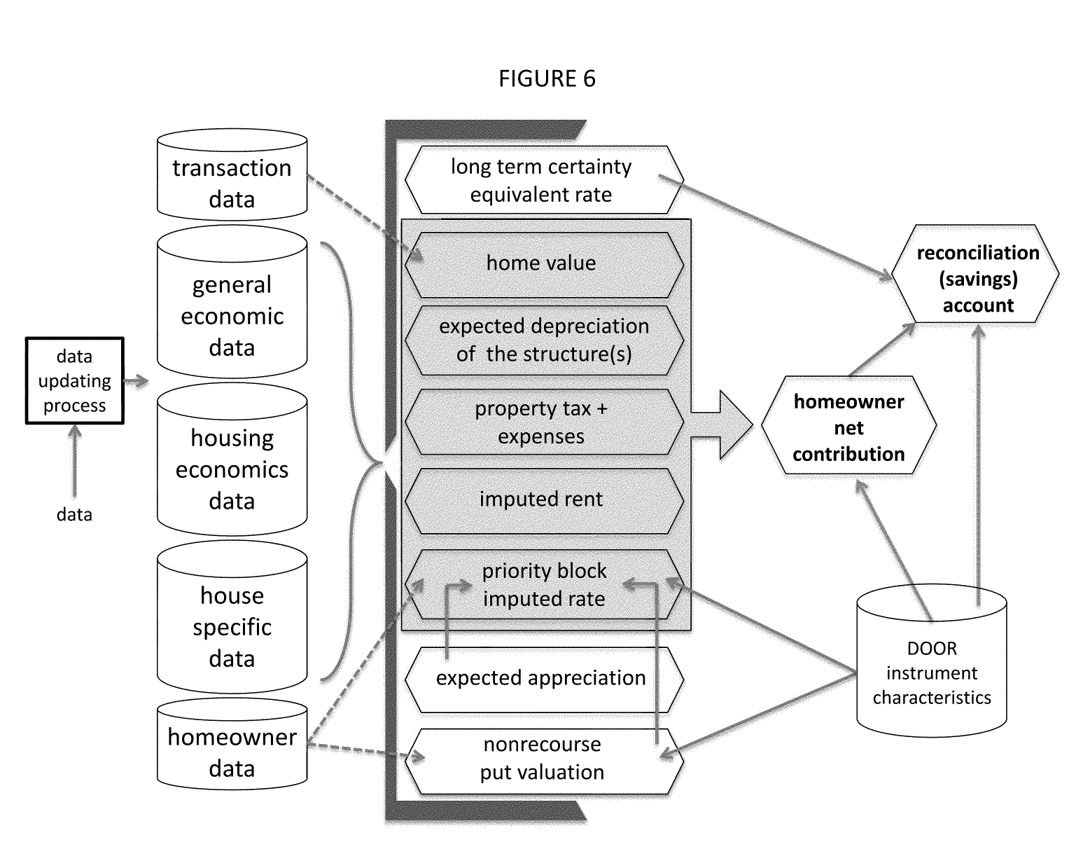

FIG. 5 is a flow chart diagram describing the analytic machine that implements ANZIE-DOOR. Ten other figures (FIGS. 6, 8, 10, 11, 12, 15, 16, 18, 20 and 21) are similar flow charts describing the analytic machine for other DOOR variants. This section discusses FIG. 5 in detail but also serves as the main discussion of the many elements in FIG. 5 that are common to the later figures.

All of the figures follow the same conventions with respect to flow chart objects and arrows. Cylindrical objects indicate devices that dynamically store data and the current data stored on the devices. The devices might include servers with dedicated hard drives, optical media that archive data of perpetual value, and other components useful in maintaining the large, expanding data sets relevant to the adjustment process for DOOR instruments. Hexagonal objects (both regular and irregular hexagons) indicate a major computational process. These processes need not occur on a single computing device. Some of the processes are mechanical in nature and can be implemented via fixed software or hardware-encoded logic. Other processes involve learning so that the software and logic elements evolve dynamically with or without human intervention. A bold rectangular or square box indicates a process that is a mixture of computation and information assembly. Arrows indicate the flow of data. If an arrow is solid, the corresponding flow of data is a necessary part of the process every time there is a dynamic adjustment to a DOOR instrument. Arrows with dashes indicate data flows that may or may not be involved in any particular adjustment. A non-bold rectangular or square box indicates information that is output from a cylinder or hexagon. This kind of box typically “defines” the information that is flowing along an arrow. It clarifies the content of the flow indicated by the arrow.

FIG. 5 shows the computation of a single adjustment or the computation of initial operational values (the “initial adjustment”) for ANZIE-DOOR. Explicating the figure is best accomplished by working backwards from the culminating calculation on the right hand side of the figure to the data assembly steps on the left hand side. The residual account for ANZIE-DOOR is insured equity. Upon initialization of the instrument and at every point where it is adjusted, it is necessary to determine the current insured equity percentage and how the insured equity percentage will change during the next period. Thus, the culminating computation in FIG. 5 is indicated by the “insured equity percentage” hexagon on right side of the figure. This hexagon implements equation (5) above, the formula that indicates the insured equity percentage at any given time and how it will evolve between the present time and the next dynamic adjustment. All of the arrows lead ultimately to this box.

It is clear from equation (5) that the necessary inputs to the insured equity percentage calculation are the past and present values of both the long-term certainty equivalent rate and the rate factor, i_{f} and πₕ respectively. The past values applied sequentially to each period between adjustments up until the present one. The present values apply during the period that begins with the current adjustment and that extends until the next adjustment or termination of the instrument, whichever occurs earlier. Accordingly, three arrows point into the insured equity percentage hexagon on the right side of the figure. First, there is an arrow from a computation hexagon labeled “long term certainty equivalent rate.” The output of that computation is the long term certainty equivalent rate that will apply during the next period. Second, there is an arrow from the computation hexagon labeled “rate factor.” The output of that computation is the rate factor that will apply during the next period. Third, there is an arrow from the data cylinder labeled “DOOR instrument characteristics.” This cylinder contains two types of data: (i) the contractual instructions for the DOOR instrument itself; and (ii) various quantities encoding the past history of the instrument. The contractual instructions for ANZIE-DOOR include the fact that insured equity is the residual account and that equation (5) is the method for computing the insured equity percentage. The past history of the instrument stored in the cylinder include, among many other items, the dates at which the instrument was initialized and adjusted and the applicable long term certainty equivalent rate and rate factor during each period delineated by the date sequence.

The DOOR instrument characteristics cylinder is the repository of the instructions that govern the analytic machine and the critical history that links present computations to what has happened previously. It would be appropriate in theory to have both a large arrow pointing from the DOOR instrument characteristics cylinder to the whole machine diagram and also a series of arrows pointing from the insured equity percentage computation hexagon and some of the other computation hexagons back into the cylinder. The first arrow would indicate that the nature of the analytic machine itself and many of its detailed aspects are dictated by the DOOR instrument contract. The second set of arrows would indicate that various computed values during the current adjustment become part of the history of the instrument preserved in the DOOR instrument characteristics cylinder. All of these arrows are omitted to make the figure simple and clear. The only arrows emanating to or from the DOOR instrument characteristics cylinder are those arrows that indicate key direct data or instruction input relevant to the particular adjustment at hand. The fact that output from the adjustment will become part of the critical history of the instrument or that the contractual instructions from the instrument dictate the nature and some of the specific elements of the analytic machine is considered obvious enough that no arrows or other indications in the flow chart are necessary.

The “rate factor” hexagon indicates the rate factor computation. In the simplified, illustrative development of ANZIE-DOOR here, the rate factor computation implements equation (4). The inputs are the priority block imputed rate (i_{P}), the “loan to value” ratio (L_{P}) for the priority block (equals priority block amount divided by home value), expected home appreciation (α), and the rate (v) at which net rent accrues. The net rent amount itself follows from several elements: imputed rent, expected depreciation, property taxes, and other expenses. Following the goal of being illustrative rather than exhaustive, FIG. 5 illustrates only the major elements, ignoring aspects such as the exact nature of the “other expenses.” In FIG. 5, there are two arrows leading into the rate factor computation hexagon. One is a large grey-shaded arrow from a grey-shaded block of six computation hexagons: home value, expected appreciation, expected depreciation of the structure(s), property tax+expenses, imputed rent, and the priority block imputed rate. These are the inputs to the rate factor computation just mentioned. There is a second arrow from the DOOR instrument characteristics cylinder. This arrow indicates the transfer both of data and instructions. The DOOR instrument contract instructions specify how the rate factor is computed, i.e., something like equation (4) or its equivalent. The DOOR instrument characteristics cylinder also includes data crucial to the computation. In particular, the size of the priority block is necessary information. The cylinder includes history such as the cash contributions of the homeowner, mortgage borrowing and other elements that determine the priority block size.

The long term certainty equivalent rate hexagon indicates the computation of the long term certainty equivalent rate (i_{f}) applicable during the next period. As discussed above, i_{f} is the certainty equivalent rate for a very long term investment. The computation of this rate typically involves term structure of interest rate models and data that includes present and past interest rate values, present and past values for various macroeconomic variables, and the present and past values of other indicators or variables. The data originate from the general economic data, housing economics data, and house specific data cylinders. House specific data is relevant because i_{f} incorporates the anticipated duration (or anticipated distribution of potential durations) of the home as a productive asset, assuming continual remediation of structural depreciation. For many homes, the likely duration will be very long—perhaps hundreds of years. However, it is possible to imagine situations where the duration is fixed, known and short, e.g., a leasehold for a number of years after which all structures will be demolished and the land becomes part of a nature preserve. As is the case for many of the computation hexagons, there may be methodological uncertainty about how to compute the desired quantity. The computational procedures may incorporate model uncertainty, or the DOOR contract may specify the applicable methodology.

Data inputs for the home value hexagon include general economic data, housing economics data, house specific and, possibly, transaction data—represented by four separate cylinders in FIG. 5. Transaction data include a purchase or sales price for the home where the analytic machine is creating initial values, updated values or terminal values simultaneous with a purchase or sale transaction. In this case, home value typically is easy to compute: the sales or purchase price after some straightforward adjustments. In many instances, however, the task is to compute the insured equity percentage schedule without the benefit of a contemporaneous sale or purchase transaction. As a result, the arrow from the transaction data cylinder to the home value hexagon is dashed, indicating that it does not always come into play.

When there is no contemporaneous transaction, the home value computation can be quite elaborate. The relevant housing economics data includes, among other items, historical sales prices and property characteristics from past transactions across the nation, as well as various local, regional and national indices relevant to home values. The relevant house specific data includes, among other items, sales prices from past transactions for the property in question along with a detailed specification of the past and present property characteristics. General economic data also are valuable, for example, variables such as general inflation rates, local unemployment rates, local demographic indicators (including net local population changes), and local income levels. There are a variety of methodologies for computing home values directly from such data including the current set of automatic valuation models, and it is possible to supplement this data and the associated methodologies with additional subjective data, in the nature of appraisal data, that typically would be collected only in conjunction with a sales or purchase transaction.

The expected appreciation hexagon embodies the computation of the expected rate of home appreciation from the available general economic data, housing economics data and house specific data. The relevant housing economics data includes futures prices for regional or national housing indices. Such futures markets already exist in the United States and are in the process of further development and elaboration. In most cases, however, it is not possible to extract the appropriate expected appreciation rate directly from futures prices. A satisfactory computation of that rate requires additional modeling and statistical assessment, both of which typically are elaborate.

The expected depreciation of structure(s) hexagon involves a simpler computation than the ones for home value or expected appreciation. Depreciation and maintenance of residential structures is well-studied, and depreciation forecasts and estimates are elements of national income accounting, business accounting, and various tax laws and regulations. Nonetheless, the expected depreciation computation does require substantial modeling and statistical assessment. This modeling and assessment is necessary not only to create generally applicable depreciation rates for the relevant structure(s) but also to capture elements that are specific to the location and nature of the particular property under examination. Structures with ocean exposure in locations where there are extreme temperature variations have different depreciation and maintenance characteristics than structures in desert areas characterized by a small temperature range and mild climate conditions.

The computation for the property tax+expenses hexagon draws more heavily from directly relevant data quantities and typically results in values that may be determinate or nearly so. In many instances the applicable property tax or property tax rate for the next period is a matter of state law or administrative regulation. “Expenses” include a variety of items that may be specified as the homeowner's responsibility under the DOOR contract. For instance, the contract may require particular casualty insurance coverage of the property. In that instance, the property tax+expenses hexagon includes the computation of the rates for such coverage applicable during the ensuing period. Assuming that coverage is standard, rate quotes are available. The computation consists simply of ascertaining a market rate from the quotes. There might be some residual uncertainty about the market rate, but it typically is close to being determinate. Of course, other expenses that are the responsibility of the homeowner under the DOOR contract may be less determinate. Nonetheless, the property tax+expenses hexagon generally involves quantities that follow rather directly from available housing economics data and house specific data.

The imputed rent hexagon represents a computation that often is similar in complexity to the computation of home value. Rental data for single family homes is sparse, and the property of interest is not itself being rented. There is extensive data on apartment rentals. This data is relevant, but not directly determinative of rental quantities for single family homes. As a result, it is necessary to estimate imputed rents from statistical data. The estimate of home value itself is an input, and the same kinds of data that go into the computation of the home value estimate are relevant to the estimate for imputed rent. Alternative models and methodologies exist, creating uncertainty on that front as in the case of estimating home value.

The priority block imputed rate hexagon embodies the computation of that rate (i_{P}) described illustratively and summarized in equation (8) above. Part of the computation involves estimating a rate representing the riskless time value of money—i in equation (8). The discussion of that equation simplified matters by assuming a flat term structure of interest rates. That simplification obviated having to consider the duration of the underlying “loan,” a duration equal to the remaining life of the instrument. An actual computation typically cannot rely on this simplification since the term structure usually displays substantial curvature. The elucidation of an appropriate value for i requires a riskless term structure derived from models and data along with an instrument duration estimate or distribution. With i in hand, three further elements required to compute i_{P} are apparent from equation (8): the value of the put representing the nonrecourse nature of the priority block loan, the expected depreciation of that put over the ensuring period, and the size of the priority block. The size of the priority block is input from the DOOR instrument characteristics cylinder as denoted by the arrow from that cylinder to the priority block imputed rate hexagon. The other two quantities are inputs from the nonrecourse put valuation hexagon. Finally, there is a dashed arrow from the homeowner data cylinder to the priority block imputed rate hexagon. This dashed arrow follows from the fact that computation of the priority block imputed rate turns on the length of the remaining life of the DOOR instrument. Homeowner characteristics such as age and income typically affect estimates of that length and its distribution and may be used in the priority block imputed rate calculation.

Homeowner characteristics also may affect some of the computations in the grey block other than the computation of the priority block imputed rate. For example, homeowners with certain traits may tend to maintain the home more effectively or make minor improvements that enhance value but do not lead to credit in the DOOR scheme. These traits would affect the home value, expected appreciation, expected depreciation, and, indirectly, property tax+expenses. Dashed arrows from the homeowner data cylinder are omitted with respect to these possibilities to keep the diagram simple. More generally some of the eight computation outputs in the stack in the middle of FIG. 5 are or may be inputs into the other computations. For instance, home value is an input into computing the priority block imputed rate and may affect some of the other computations such as property tax. Dashed or solid arrows for these interactions are omitted for the same reason: simplicity. Most of the associated actual or potential data flows are obvious in any event.

The nonrecourse put valuation hexagon is outside of the grey-shaded block of six computed quantities that are direct inputs into the rate factor computation. The value and expected depreciation of the nonrecourse put do not enter directly into that computation. Instead, they are inputs into the computation of the priority block imputed rate as indicated by the arrow from the nonrecourse put valuation hexagon to the priority block imputed rate hexagon. As discussed above, the value of the nonrecourse put depends on the distribution of the length of life remaining for the instrument. As a result, homeowner characteristics such as age are potentially relevant, and, accordingly, there is a dashed arrow from the homeowner data cylinder to the nonrecourse put valuation hexagon. The priority block size is critical to the put valuation, thus the solid arrow from the DOOR instrument characteristics cylinder to the nonrecourse put valuation hexagon. The nonrecourse put valuation calculation requires both modeling and statistical assessment. For example, the stochastic process for the home price affects the put value, and this process must be modeled and specified using past data. The computation is non-trivial and involves resolving various methodological and modeling uncertainties.

The five data cylinders stacked on the left side of FIG. 5 represent dynamic data collections. The general economic data includes, among other items, various interest rate and macroeconomic time series. These time series are updated periodically. Several items involve daily data. Although this data collection is large, it is well-defined and orderly for the most part. Many of the items are readily available from public or commercial sources.

The housing economics data is an entirely different matter. Although this data collection includes some standard, publicly available data such as publicly available regional and national housing price indices, it also includes transactional and characteristics data on individual homes across the country. This transactional and characteristic data is irregular. Very extensive assessments of characteristics (e.g., interior finishes such as kitchen countertops) are available for some homes at some points in time while only rudimentary assessments are available for other homes at other points in time. Transactions are reported with varying degrees of completeness and levels of detail. Data on depreciation of structures includes some very detailed information but suffers from major temporal and geographic gaps. The unevenness of the data presents two challenges. First, organizing the data collection in the face of irregularities is critical—a task “inside” the data cylinder. The various computational elements in the machine must be able to access and use different data elements together. The second challenge exists outside of the data cylinder: the computational procedures must operate in the face of the irregularities. Meeting this challenge requires data imputation routines and other methodologies to cope with missing and uneven data.

The house specific data cylinder includes the transaction history of the property as well as various past and present property characteristics. This data goes beyond what is available in the housing economics data cylinder. That cylinder includes data from public and commercial sources but not data that is generated from the processes surrounding origination and servicing of the DOOR instrument itself. Those processes generate additional data from sources such as property appraisals and home improvement reports.

The transaction data cylinder represents information generated from transactions contemporaneous with the adjustment of initialization process. This cylinder is only relevant if the home is being purchased or sold and the analytic machine is setting initial values specifying the evolution of the insured equity percentage or is determining the final value of that percentage. After the sale or purchase is complete, the data from the transaction data cylinder migrates to the housing economic data and house specific data cylinders.

The homeowner data cylinder includes information relevant to the duration of the DOOR instrument. The spectrum of such information may be quite broad. Personal characteristics such as age, health status and income are relevant. In addition, the duration of the DOOR instrument may be affected by the status of any mortgage borrowing. As a result, the homeowner's credit characteristics and history may be relevant.

Data in all of the cylinders is dynamic. Existing data in the cylinders such as financial time series are updated continually. In addition, entirely new data may become available. For example, information from new depreciation studies that involve new data sets may have no existing counterpart in the housing economics data cylinder. New housing futures markets may arise. The analytic machine includes a data updating process component represented by the bold rectangle on the left of FIG. 5. This process includes the full spectrum of data updating, ranging from routine additions to existing publicly available time series to the addition of entirely new data elements. The updating requires some computing since new data must be put in a form that comports with the data structures in the cylinders.

Many of the features of the analytic machine for ANZIE-DOOR captured by FIG. 5 recur again in later figures that embody the analytic machines for variants other than ANZIE-DOOR. Consideration of these later figures builds on the extensive discussion of FIG. 5 here. The disclosure simply explicates the new features of the later figures, often by explicit reference to FIG. 5, avoiding duplicative explanations of features already exposited.

Numerical Examples

To illustrate the accrual of insured equity under ANZIE-DOOR, consider an example. Suppose that during the entire applicable period net rent is zero, expected appreciation is 7% per year, and i_{P}=i_{f}=0.05. (The rate i_{f}=0.05 is annualized. In contrast, equation (5) requires the instantaneous version of i_{f}, ln(1+i_{f}).) The rate factor simplifies to:

$${π}_{k} ( {t}_{a} ) = \frac{{i}_{p} ( {t}_{a} ) {L}_{p} ( {t}_{a} ) - v ( {t}_{a} )}{v ( {t}_{a} ) + α ( {t}_{a} )} = \frac{{i}_{p} ( {t}_{a} ) {L}_{p} ( {t}_{a} )}{α ( {t}_{a} )} = \frac{.05 {L}_{p} ( {t}_{a} )}{.07}$$

Setting net rent to zero guarantees that the rate factor is positive. The only variable is L_{P}, the “loan to value” (“LTV”) for the implicit priority block loan. Because the size of the priority block remains constant, L_{P} and the rate factor shrink as the home appreciates in value, slowing down the accrual of insured equity. This example is not entirely fanciful. It can be considered to be a highly stylized version of “normal” conditions in certain real estate markets, such as the San Francisco Bay Area in California: strong appreciation persists for long periods of time along with negligible or even negative net rent.

Suppose the homeowner buys the home for $200,000 financed through a $40,000 ANZIE-DOOR instrument. The priority block is $160,000, representing an initial “LTV” of 80%. Consider a single illustrative price path: The home appreciates exactly at the expected 7% annual rate every year. Table 6 shows the pattern of accrual for insured equity along with investor and homeowner outcomes as of the end of each year. The penultimate column indicates the intrinsic value of the investor's overall position, and the final column shows the percentage increase in this position during the applicable year.

TABLE 6
ANZIE-DOOR—Single Price Path Example
$200,000 Initial Value, $160,000 Priority Block, and $40,000 ANZIE-DOOR
Price Path: Constant 7% Appreciation Compounded

| | | insured | | LTV | homeowner | | investor |
|---|---|---|---|---|---|---|---|
| | rate | equity | home | (priority | insured | investor | % annual |
| year | factor | percentage | value | block) | equity | position | return |
| 0 | | 0% | $200,000 | 80.00% | | $40,000 | |
| 1 | 0.571 | 2.75% | $214,000 | 74.77% | $5,884 | $48,116 | 20.29% |
| 2 | 0.534 | 5.25% | $228,980 | 69.88% | $12,023 | $56,957 | 18.37% |
| 3 | 0.499 | 7.53% | $245,009 | 65.30% | $18,450 | $66,559 | 16.86% |
| 4 | 0.466 | 9.61% | $262,159 | 61.03% | $25,196 | $76,963 | 15.63% |
| 5 | 0.436 | 11.51% | $280,510 | 57.04% | $32,295 | $88,215 | 14.62% |
| 6 | 0.407 | 13.25% | $300,146 | 53.31% | $39,783 | $100,363 | 13.77% |
| 7 | 0.381 | 14.85% | $321,156 | 49.82% | $47,696 | $113,460 | 13.05% |
| 8 | 0.356 | 16.32% | $343,637 | 46.56% | $56,071 | $127,566 | 12.43% |
| 9 | 0.333 | 17.66% | $367,692 | 43.51% | $64,949 | $142,743 | 11.90% |
| 10 | 0.311 | 18.90% | $393,430 | 40.67% | $74,370 | $159,060 | 11.43% |
| 11 | 0.290 | 20.04% | $420,970 | 38.01% | $84,381 | $176,590 | 11.02% |
| 12 | 0.271 | 21.10% | $450,438 | 35.52% | $95,026 | $195,412 | 10.66% |
| 13 | 0.254 | 22.07% | $481,969 | 33.20% | $106,357 | $215,612 | 10.34% |
| 14 | 0.237 | 22.96% | $515,707 | 31.03% | $118,425 | $237,282 | 10.05% |
| 15 | 0.222 | 23.79% | $551,806 | 29.00% | $131,286 | $260,520 | 9.79% |
| 16 | 0.207 | 24.56% | $590,433 | 27.10% | $145,000 | $285,433 | 9.56% |
| 17 | 0.194 | 25.27% | $631,763 | 25.33% | $159,630 | $312,133 | 9.35% |
| 18 | 0.181 | 25.92% | $675,986 | 23.67% | $175,243 | $340,743 | 9.17% |
| 19 | 0.169 | 26.53% | $723,306 | 22.12% | $191,912 | $371,394 | 9.00% |
| 20 | 0.158 | 27.10% | $773,937 | 20.67% | $209,712 | $404,225 | 8.84% |
| 21 | 0.148 | 27.62% | $828,112 | 19.32% | $228,726 | $439,387 | 8.70% |
| 22 | 0.138 | 28.11% | $886,080 | 18.06% | $249,041 | $477,040 | 8.57% |
| 23 | 0.129 | 28.56% | $948,106 | 16.88% | $270,749 | $517,357 | 8.45% |
| 24 | 0.121 | 28.98% | $1,014,473 | 15.77% | $293,952 | $560,521 | 8.34% |
| 25 | 0.113 | 29.37% | $1,085,487 | 14.74% | $318,754 | $606,732 | 8.24% |
| 26 | 0.105 | 29.73% | $1,161,471 | 13.78% | $345,271 | $656,200 | 8.15% |
| 27 | 0.098 | 30.06% | $1,242,774 | 12.87% | $373,622 | $709,151 | 8.07% |
| 28 | 0.092 | 30.38% | $1,329,768 | 12.03% | $403,939 | $765,828 | 7.99% |
| 29 | 0.086 | 30.67% | $1,422,851 | 11.25% | $436,360 | $826,491 | 7.92% |
| 30 | 0.080 | 30.94% | $1,522,451 | 10.51% | $471,034 | $891,417 | 7.86% |

The homeowner builds up quite a substantial insured equity stake after a few years. Even if the homeowner borrows the entire priority block amount on a non-amortizing basis, the homeowner is solidly “in the game.” This outcome shows the potential strength of ANZIE-DOOR for the typical homeowner. There is no need to put most or all of one's wealth into one's home to get in the game. What about other price paths? If the home appreciates sharply, the insured equity percentage accrues slowly. Will the homeowner still be “in the game” in most instances? To address this question, consider a stochastic version of the example using the baseline model described above: Home prices follow geometric Brownian motion with a constant expected annual geometric rate of return of 7% and an annual standard deviation of 9 percentage points, the expected duration of the instrument is ten years, and all relevant riskless rates are constant across term and time at 0.05. Continue to assume that net rents are constant at zero.

Table 7 indicates the range of the insured equity percentage each year for a simulation consisting of 12,000 separate instances. The table displays the mean, the standard deviation, the minimum, the maximum and the 1st, 10th, 90th and 99th percentiles. To create additional perspective, the final two columns indicate minimum and maximum home values each year over the 12,000 runs, assuming a starting value of 1. (The table is labeled “Non-recourse Case” because the priority block “loan” under ANZIE-DOOR is non-recourse. A simulation using the same baseline model for the recourse case is discussed later.)

TABLE 7
Example—Baseline Model, Non-recourse Case (ANZIE-DOOR)
End of Year Insured Equity Percentages & Home Value Extremes
net rent = 0% per year; expected appreciation = 7% per year

| | insured equity percentage—distribution over 12,000 runs | | | | | | | | home value | |
|---|---|---|---|---|---|---|---|---|---|---|
| year | mean | std dev | min | 1% | 10% | 90% | 99% | max | min val | max val |
| 1 | 2.75 | 0.00 | 2.75 | 2.75 | 2.75 | 2.75 | 2.75 | 2.75 | 0.73 | 1.47 |
| 2 | 5.27 | 0.22 | 4.58 | 4.84 | 5.01 | 5.55 | 5.88 | 6.98 | 0.69 | 1.71 |
| 3 | 7.57 | 0.46 | 6.22 | 6.66 | 7.02 | 8.16 | 8.83 | 11.48 | 0.61 | 2.10 |
| 4 | 9.67 | 0.72 | 7.62 | 8.25 | 8.81 | 10.60 | 11.63 | 16.15 | 0.66 | 2.41 |
| 5 | 11.60 | 0.99 | 8.73 | 9.65 | 10.42 | 12.87 | 14.27 | 20.66 | 0.68 | 2.91 |
| 6 | 13.37 | 1.26 | 9.76 | 10.90 | 11.86 | 15.01 | 16.74 | 23.54 | 0.63 | 3.47 |
| 7 | 15.00 | 1.53 | 10.64 | 11.96 | 13.17 | 16.97 | 19.16 | 26.07 | 0.65 | 3.84 |
| 8 | 16.50 | 1.79 | 11.32 | 12.96 | 14.35 | 18.79 | 21.40 | 28.63 | 0.61 | 4.38 |
| 9 | 17.88 | 2.04 | 11.97 | 13.85 | 15.42 | 20.49 | 23.53 | 32.60 | 0.61 | 5.12 |
| 10 | 19.15 | 2.29 | 12.58 | 14.66 | 16.40 | 22.08 | 25.48 | 36.84 | 0.68 | 4.77 |
| 11 | 20.32 | 2.52 | 13.13 | 15.38 | 17.31 | 23.58 | 27.41 | 39.85 | 0.60 | 5.35 |
| 12 | 21.40 | 2.74 | 13.68 | 16.07 | 18.13 | 24.94 | 29.12 | 41.87 | 0.62 | 6.03 |
| 13 | 22.41 | 2.95 | 14.23 | 16.67 | 18.88 | 26.22 | 30.79 | 43.56 | 0.71 | 6.43 |
| 14 | 23.33 | 3.15 | 14.70 | 17.25 | 19.57 | 27.41 | 32.17 | 45.33 | 0.74 | 7.70 |
| 15 | 24.19 | 3.35 | 15.17 | 17.78 | 20.19 | 28.49 | 33.52 | 46.83 | 0.72 | 8.67 |
| 16 | 24.99 | 3.53 | 15.60 | 18.28 | 20.77 | 29.54 | 34.78 | 48.43 | 0.76 | 9.56 |
| 17 | 25.73 | 3.70 | 15.91 | 18.70 | 21.30 | 30.51 | 35.91 | 49.89 | 0.83 | 11.72 |
| 18 | 26.41 | 3.86 | 16.16 | 19.10 | 21.79 | 31.40 | 37.02 | 51.38 | 0.79 | 11.47 |
| 19 | 27.05 | 4.02 | 16.36 | 19.46 | 22.24 | 32.24 | 38.08 | 52.91 | 0.77 | 11.85 |
| 20 | 27.64 | 4.16 | 16.57 | 19.80 | 22.65 | 33.03 | 39.04 | 54.31 | 0.87 | 14.24 |
| 21 | 28.18 | 4.30 | 16.77 | 20.10 | 23.03 | 33.74 | 39.92 | 55.58 | 0.87 | 15.12 |
| 22 | 28.69 | 4.43 | 16.95 | 20.40 | 23.37 | 34.44 | 40.79 | 57.00 | 0.88 | 17.33 |
| 23 | 29.17 | 4.55 | 17.11 | 20.67 | 23.70 | 35.08 | 41.70 | 58.35 | 0.94 | 19.88 |
| 24 | 29.61 | 4.67 | 17.27 | 20.91 | 24.02 | 35.70 | 42.57 | 59.50 | 0.91 | 24.01 |
| 25 | 30.02 | 4.78 | 17.42 | 21.13 | 24.33 | 36.25 | 43.35 | 60.72 | 0.91 | 27.49 |
| 26 | 30.41 | 4.88 | 17.58 | 21.37 | 24.59 | 36.76 | 44.07 | 61.91 | 0.81 | 31.27 |
| 27 | 30.76 | 4.98 | 17.73 | 21.58 | 24.82 | 37.28 | 44.85 | 63.23 | 0.84 | 37.38 |
| 28 | 31.10 | 5.07 | 17.88 | 21.76 | 25.07 | 37.76 | 45.46 | 64.45 | 0.93 | 40.68 |
| 29 | 31.41 | 5.16 | 18.01 | 21.89 | 25.28 | 38.16 | 46.05 | 65.50 | 1.03 | 43.26 |
| 30 | 31.70 | 5.24 | 18.15 | 22.05 | 25.47 | 38.58 | 46.56 | 66.42 | 1.00 | 43.25 |

The high degree of robustness is evident from the numbers in the table. The minimum outcome (out of 12,000 price paths) for each year tends to be about two-thirds of the mean which itself is close to the values for the fixed 7% appreciation price path. The first percentile outcomes are around three-quarters of the mean outcomes. The “two-thirds” and “three-quarters” fractions are close to exact for year 10. The fractions are somewhat greater for earlier years and somewhat less for later years.

Thus, even in the worst situations (involving extremely high levels of price appreciation), the homeowner still is substantially “in the game.”

This simulation is suggestive rather than definitive. House prices do not follow geometric Brownian motion. Changes in home prices period-by-period tend to exhibit substantial positive serial correlation and a degree of stochastic volatility. These traits tend to exacerbate run-ups and drops, stretching them out over time and intensifying them. Nonetheless, it is worth noting that the high appreciation outcomes in the simulation, which correspond to low values of the insured equity percentage, are as or more extreme than the most extreme instances in comparable real world settings. For example, the average rate of appreciation and home price variances in the simulation are distinctly less than historical values from 1976-2008 in the San Francisco Bay Area. But maximum price appreciation episodes from that region and period fall within the ranges in the simulation. Considering all one year, seven year, ten year and twenty year periods for the San Jose, San Francisco and Oakland MSAs, in no case did the accumulated appreciation come close to maximums in the simulation. For the four periods in order of increasing length the most extreme actual episode falls at about the 99th percentile, below the 99th but above the 95th, about the 95th percentile and just above the 75th percentile in the simulation. This pattern makes sense from the fact that actual prices exhibit positive serial correlation and stochastic volatility. One would expect to see more violent short and medium-run price changes than under geometric Brownian motion but less difference for long-run price changes.

A deeper issue with the simulations is that we have fixed net rent at zero, and have held i_{P}, i_{f}, and α constant. These assumptions are restrictive. Gross rents fluctuate considerably, and one advantage of owning a home is to provide a hedge against rent risk. The homeowner pays the purchase price for a home and then is insulated against changes in rent levels for the duration of ownership. Sinai & Souleles (see T. Sinai, N. S. Souleles, Owner-occupied Housing as a Hedge Against Rent Risk, Quarterly Journal of Economics, vol. 120, pp. 763-89 (May 2005)) make this point and provide considerable empirical evidence with respect to the volatility of rents.

In addition, assuming that net rent is zero (or negative) assures that the rate factor is positive and that insured equity accrues to the homeowner rather than the other way around. But net rent tends to be consistently positive in some geographic regions and is positive during some time periods even in some regions where the average tends to be zero or negative. If net rent fluctuates and may take on positive values, there is no guarantee that the rate factor always is positive. Interest rates and expected home appreciation also fluctuate. The serial correlation of home price changes implies that there are periods of low and high expected price appreciation.

It also is the case that economic principles imply a relationship between net rent, expected home price appreciation and interest rates. Although these principles do not appear to explain real world housing phenomena fully, they provide useful guidance with respect to the design of DOOR instruments. Armed with ANZIE-DOOR as a baseline example, much of the discussion below in the next section is devoted to explicating the principles and discussing some of the insights that are relevant to DOOR instrument design.

Finally, despite the restrictive nature of the simulations in this discussion, they are relevant to some of the DOOR variants considered below, in particular, LAZIE-DOOR and COZIE-DOOR. Instances of these variants have features that coincide exactly with some of the restrictions in the simulations.

An Economic Perspective

Economic models of housing valuation provide perspective that is relevant to the design of DOOR instruments. These models typically presume rational, forward-looking market participants. Although it seems clear that the models capture many aspects of actual markets, whether the models come close to being fully descriptive is a matter of contention. For example, there is the question of whether the recent world wide run up in home prices constituted a “bubble” or was a rational response to economic conditions and expectations. As exemplified by Himmelberg, et al. (see C. Himmelberg, C. Mayer, and T. Sinai, Assessing High House Prices: Bubbles, Fundamentals and Misperceptions, Journal of Economic Perspectives, vol. 19:4, pp. 67-92 (Fall 2005)), one way to address that question is to use the economic models as a baseline to see if market prices are departing from “fundamentals.”

A set of “user cost” models, first applied to owner-occupied housing by Poterba (see J. Poterba, Tax Subsidies to Owner-Occupied Housing: An Asset Market Approach, Quarterly Journal of Economics, vol. 100, pp. 1-27 (February 1985)) and Hendershott and Slemrod (see P. Hendershott, P. and J. Slemrod, Taxes and the User Cost of Capital for Owner-Occupied Housing, Journal of the American Real Estate and Urban Economics Association, vol. 10:4, pp. 375-93 (Winter 1982)), are particularly relevant. These models use periodic costs and returns such as explicit or implicit rent, property taxes, depreciation and borrowing costs as primitives, similar to the approach used to compute the rate factor that drives ANZIE-DOOR. Under certain plausible conditions, the single period user cost models translate into conventional present value or growth models. This portion of the disclosure begins with some simple present value models and then considers the insights available from the user cost framework. Although the DOOR approach does not assume that the user cost framework fully describes reality, it is very useful to consider how DOOR looks in that framework. The ensuing insights are valuable for designing DOOR variants. At the same time, as part of the design process, it is important to allow for the possibility that actual markets deviate from the user cost framework and other rational-actor economic models.

The original application of user cost models to owner-occupied housing was to study the impact of taxes on housing prices and housing market equilibrium. This portion of the disclosure concludes with a discussion of the role of taxes in the computation of the rate factor for ANZIE-DOOR and related variants.

A Simple User Cost Model and Its Implications

Consider a simple continuous time model of housing. All variables are functions of time, t, but the discussion dispenses with the argument t unless it is required for clarity, e.g., when some quantities are assumed constant over time and others are not. Home value is H=L+S, where L is the land value and S is the value of the structure. Define the following instantaneous annualized rates of accrual as set forth above:

r: gross rent

d: depreciation

p: property tax.

Assume that these rates cover all imputed or actual cash flows. For an owner occupied structure, r is an imputed cash flow equal to “imputed rent.” When the owner rents the home out, r is an actual cash flow. The instantaneous annualized rate of accrual for “net rent” is n=r−d−p. That is, an owner who rents the home out realizes n dollars spread out evenly over the year, assuming the owner pays d per year to maintain the structure in the same condition.

Suppose that there is no inflation, a risk neutral economy, and a riskless instantaneous interest rate, i, that is constant over time. Thus, the term structure of interest rates is flat and constant over time with annual rate eⁱ−1.

If the scarcity of land and growing population causes net rent to grow from a time zero value of n at the constant instantaneous rate g per year, then home value at time t is:

$$H ( t ) = {\int }_{t}^{∞} n {e}^{- i s} {e}^{g ( s + t )} d s = {e}^{gt} \frac{n}{i - g} = {e}^{gt} H ( 0 ) .$$

Home value is increasing at the instantaneous rate g along with net rent. If physical depreciation is at a constant instantaneous rate, δ, and the owner pays d=(1−e^{-δ})S per year to maintain the home in its original state, then S and d remain constant. For H to grow at constant rate g, L initially must grow at a rate greater than g, declining asymptotically to g. This situation is artificial, but the goal here is to create a simple intuitive example.

If v is the instantaneous rate of net rent flow, α is the instantaneous rate of home value appreciation, and η is the appropriate risk premium, then, ignoring taxes, the instantaneous user cost relationship is:

v+α=i+η. (9)

Equation (9) describes a rational actor economic equilibrium. If a “bubble” or other departure from economic fundamentals exists, then the model is not fully descriptive of market outcomes but instead provides a baseline for assessing whether housing prices have departed from fundamental values. For example, Himmelberg, et al. (supra) compute an imputed price-to-rent ratio based on user cost and then compare it to actual price-to-rent ratios in various U.S. cities to determine whether home prices were driven primarily by fundamentals at various times. In the ensuring discussion, we begin by assuming that the user cost model is applicable. This approach creates considerable insight into the design of DOOR instruments, even if it only approximates reality.

For the growing perpetuity case we have just considered, η=0 because the economy is risk neutral, and α=g. As a result, v=i−g, and v>0 is required to avoid home value being infinite. (i−g>0 is the relevant transversality condition required to derive present value formulae, such as the formula stated at the beginning of this portion of the disclosure, from a period-by-period cost formula such as equation (9).)

The rate factor takes on a particularly simple form:

$${π}_{h} = \frac{i {L}_{P} - v}{v + α} = \frac{g}{i} - ( 1 - {L}_{P} ) .$$

For the rate factor to be positive: (i) the growth rate must be significant; and (ii) the priority block must be sufficiently large compared to the value of the home. Because g and i are constant while L_{P} falls as home value grows at rate g, it is evident that the rate factor eventually turns negative. As a result, ANZIE-DOOR is not suitable if the goal is to ensure that the homeowner's insured equity consistently accumulates at a substantial rate. Instead, the insured equity percentage eventually stops growing and begins to fall. It can become negative. Then insured equity accumulates in favor of the investor instead of the homeowner. Versions of ANZIE'S SIDE DOOR, LAZIE-DOOR, and FIXED-DOOR presented below address these problems while retaining some or all of the other desirable features of ANZIE-DOOR.

The numerical examples in the previous discussion had the feature that the insured equity percentage increased consistently and substantially in favor of the homeowner over time regardless of the home price path. Setting net rent to zero is one driver behind this result. The rate factor becomes:

$${π}_{h} = \frac{i {L}_{P}}{α}$$

which is always positive in environments where α>0.

The situation of zero or even negative net rent is not uncommon. It occurs and persists over long periods of time in certain “expensive” housing markets. Such markets are characterized by high price-rent ratios. One potential cause is that home prices and appreciation rates are very high because of speculative mania that has driven prices out of line with economics: Investors who rent out homes and homeowners who enjoy imputed rent are willing to live with zero or negative net rent to ride the artificial appreciation wave. However, zero or negative net rent conditions that persist for significant periods of time easily can be the result of market fundamentals as well. If market participants expect a future acceleration of growth in rents, then present net rents may be negative or zero. Consider a case where net rent is at level n at the current time t and persists at that level until some later time, T. At that time, it increases to a new higher level, n+Δ and remains at that level forever. Then, home value at time t is:

$$H ( t ) = n {\int }_{t}^{T} {e}^{- i ( s - t )} d s + {e}^{- i ( T - t )} \frac{n + Δ}{i} .$$

If n=0, then no value of H is logically excluded. In particular, H is very high if Δ is very large. In the United States, this story is plausible for many locales that are experiencing or have experienced zero, low or negative net rent regimes for some period of time. These regimes tend to occur in cities or regions where the potential for future new housing is limited due to geography or regulation, but where there is some business or lifestyle motivation to live in the city or region.

It is reasonable for market participants to expect premium rents in the future in such regimes as population swells.

The user cost relationship in equation (9) indicates an important empirical shortcut that is available if one is willing to assume that actual market conditions obey the user cost relationship. Knowing any three of v, α, i and η makes the fourth superfluous. If there is a dependable asset pricing model available, it may be relatively straightforward to estimate i and η. On the other hand, gross rents (and therefore net rents) as well as expected home price appreciation may be more ethereal.

Taxes

The original application of user cost models for owner-occupied housing was in studies of the impact of taxes on home prices and housing market equilibrium. The user cost equation for this application contains additional terms that capture features such as the deductibility of property taxes and mortgage interest (see J. Poterba, and T. Sinai, Tax Expenditures for Owner-Occupied Housing: Deductions for Property Taxes and Mortgage Interest and the Exclusion of Imputed Rental Income, American Economic Review, vol. 98:2, pp. 84-89 (May 2008)).

The rate factor computation for ANZIE-DOOR and related variants has a strong user cost flavor, although it is not required that the user cost relationship apply. An important question is whether the contribution elements that enter the rate factor calculation should be adjusted to take taxes into account. For instance, the homeowner is able to deduct property taxes but not depreciation. Another way of putting it is: Should the net contributions of the parties be measured on a pre-tax or after-tax basis? The answer is not entirely clear, but it is quite possible that using pre-tax quantities will suffice if the tax treatment of the parties remains similar to the treatment under existing alternative arrangements.

There is apparent complexity. The ultimate purpose of the rate factor is to create a situation where the DOOR instrument is mimicking a market deal at all times. After-tax quantities differ across taxpayers because taxpayers face different rates and different treatments with respect to other features, such as certain limitations on deductions. Absent a perfect accretion tax, market prices only can adjust to create a zero net present value deal—no economic profits—for one taxpayer type. This type is the “marginal investor” for the asset in question. Other types are inframarginal, and some may be able to walk away with a tax bonus that is not capitalized in the asset price.

It is possible for a single investor or investor type to be marginal across all assets, especially if capital markets are perfect or nearly so. However, if there are restrictions, such as limitations on certain types of borrowing, investors with different tax characteristics may be marginal with respect to different asset classes. The restrictions prevent investors from trading freely across all asset types and therefore permit the balkanization of marginal investor status. Dybvig and Ross (P. H. Dybvig, S. A. Ross, Tax Clienteles and Asset Pricing, Journal of Finance, vol. 41:3, pp. 751-62 (July 1986)) aptly draw and discuss this distinction.

Regardless of the particular tax treatment for DOOR instruments, some investors or homeowners will be inframarginal. What is important is whether DOOR instruments themselves admit new tax possibilities for the basic components of housing transactions. If so, there might be a tax motive to use or not use the instruments. A tax motive to use the instrument exists if the tax treatment creates a net joint benefit to the investor and homeowner versus alternative arrangements. A motive not to use the instrument exists if there is a net joint detriment.

An additional problem is that there is more than one margin where tax motives might arise. There are many financial arrangements that permit individuals or families to live in a home. Two conventional ones are renting from an investor-owner or owning the home using a mixture of debt and equity finance. These two approaches result in different tax constellations. The investor-owner is taxed on rents, is taxed on gains upon sale, can deduct losses upon sale, and can deduct property taxes, mortgage interest, and depreciation. The owner who occupies the home pays no taxes on the imputed rent, cannot deduct depreciation, can deduct mortgage interest and property taxes subject to certain limitations, can avoid gains on sale up to certain limits, but does not enjoy a deduction for losses upon sale. The non-financial ownership and control aspects under the DOOR scheme are almost identical to owner-occupation. For example, the occupant decides when to buy and sell the home and is responsible for maintenance. It therefore makes sense to consider owner-occupied housing as the baseline situation.

Given that baseline, it is easy to specify a tax treatment that gives the parties little or no tax motivation to choose a DOOR approach over the alternatives. The simplest way to do so is to begin with the bifurcation first developed above for ANZIE-DOOR. The instrument consists of a conventional “real” part plus a separate “notional” side deal. The side deal focuses on the accrual of insured equity. The conventional part involves a capital structure, property taxes, depreciation and, if the priority block is debt-financed, mortgage interest. The homeowner, at least under ANZIE-DOOR, pays the property taxes and mortgage interest. It makes sense to allow the homeowner to deduct these under the tax rules that apply to owner-occupants in the absence of a DOOR instrument. Similarly, because those tax rules bar a deduction for depreciation, the homeowner should not receive that deduction. Under ANZIE-DOOR, homeowner capital gains are not possible on the conventional side, but capital losses are. Committed equity cannot grow beyond what the homeowner has contributed (equals basis) but can be reduced or wiped out if the value of the home falls below the priority block amount. Again, paralleling the situation in the absence of a DOOR instrument, the appropriate treatment is to deny any loss, but there is a caveat that involves the side deal.

The side deal is very similar to a prepaid forward contract where the pre-payments occur over time. The homeowner's net contributions fund the accrual of insured equity, and the contract is settled upon sale of the home by a payment from the investor to the homeowner equal to the accrued percentage of home value. The homeowner experiences a gain if the money amount realized exceeds the aggregate contributions. In that case, the investor has a corresponding loss. It makes sense to treat these as capital gains and losses.

Now the caveat. In the situation of conventional ownership, the homeowner enjoys an exclusion of capital gains up to a limit under I.R.C. §121, but cannot deduct capital losses. One way to translate this rule into the Z capital structure setting is to combine the homeowner's gain or loss on the insured equity deal with any gain or loss with respect to committed equity and then subject the aggregate gain or loss to the usual treatment: denial of losses and exclusion of gains up the applicable limit. This treatment makes sense based on the fact that insured equity and committed equity under ANZIE-DOOR substitute for the homeowner's equity in a conventional arrangement.

Some DOOR variants involve a conventional capital structure. COZIE-DOOR, discussed below, is an example. The insured equity account accrues in favor of the investor. As a result, the substitution argument in the text does not apply, and an obvious tax treatment for the homeowner is to apply the usual rules to the conventional part of the transaction, but treat the side deal as if it were a non-housing notional financial transaction resulting in capital gain or loss. The result for the conventional part matches exactly the result that obtains under conventional homeownership, including the amount of §121 exclusion.

If the tax authorities treat ANZIE-DOOR instruments in the manner just described, the homeowner is in a very similar position to conventional ownership: mortgage interest and property taxes are deductible subject to certain limitations, depreciation is not deductible, capital losses are not deductible, and the §121 exclusion applies to capital gains.

How about the investor? The investor holds a leveraged position in the physical home and a notional short position in the side deal. If the investor paid mortgage interest, property taxes, and depreciation charges, all of them are deductible. Instead, under ANZIE-DOOR, the homeowner is making the payments. As a result, no deductions or basis adjustments for the investor are appropriate. In the side deal, the investor is taking an increasing short position in the notional home. The proceeds from the short position are the periodic net contributions of the homeowner to the investor. As is typical, taking a short position should not create immediate income equal to the proceeds but, instead, should result in consequences at sale, i.e., capital gain to the extent that the amount paid to close the short position on sale is less than the aggregate proceeds.

There are other possible tax treatments of the parties to an ANZIE-DOOR instrument. A comprehensive discussion of potential tax treatments would be lengthy as well as technical and is beyond the scope of this disclosure. The key point here is that there are tax treatments that leave the parties in a similar tax position to alternative arrangements, suggesting little or no harm from using pre-tax quantities in rate factor computations.

The actual tax treatment applied to various DOOR instruments will likely affect the market terms of the instruments. If so, it will be necessary to adjust the operation of the analytic machine appropriately: For all DOOR instruments not involving a subsidy, the terms must be such that the arrangement is a market deal at origination, and for neutral DOOR instruments, each adjustment must restore the arrangement to being a market deal at intrinsic value.

Variants discussed later herein involve features that are not present under ANZIE-DOOR, and this disclosure discusses possible tax treatments for some of them. From these discussions and the one in this section, the impact of various tax treatments on the adjustment mechanism for different DOOR variants will be apparent to skilled artisans.

DOOR's Flexibility

The DOOR adjustment process admits a very high degree of flexibility. ANZIE-DOOR has a particular set of fixed contract terms, e.g., the homeowner pays property taxes, and the instrument adjusts the insured equity account to achieve neutrality. The DOOR mechanism admits almost any pattern of fixed contract terms, and neutrality adjustments may involve features other than an insured equity account. It also is possible to relax neutrality with certain goals in mind, to make contract terms flexible, and even to create a capability to switch between neutral DOOR instruments “on the fly.”

Contract Terms

There are many ways in which fixed contract terms might differ from ANZIE-DOOR. For instance, one modification requires the investor to pay property taxes while at the same time specifying a fixed schedule of quarterly payments from the homeowner to the investor. The goal is to insulate the homeowner against changes in property tax rates, shifting that risk to the investor.

The contract itself may allow flexibility with respect to certain features. For example, the contract might permit the homeowner to make additional voluntary payments to the investor at any time. In an ANZIE-DOOR type of scheme, these payments result in a compensating increase in the speed of accrual for insured equity during the next period or during some small increment of time following the payment. It is not necessary to delay crediting the payments until the next scheduled adjustment. The payment itself generates an adjustment and creates the beginning of a new period.

The variants are endless. Payments from the homeowner to the investor might be periodic, occasional, a function of some variable or parameter such as interest rates, or be triggered by market conditions including the value of the home. The payments might be partially or entirely voluntary. Payments might flow in the other direction, e.g., from the investor to the homeowner. In an ANZIE-DOOR type of scheme this means a slower accrual of insured equity, but the homeowner benefits from a cash flow. In a retirement or home equity “cash out” setting, such a scheme might be useful.

The adjustment mechanism easily accommodates more fundamental shifts, equivalent to refinancing with a new and different instrument. For instance, there may be an option to shift at any time between the conventional version of ANZIE-DOOR and the version described above where the investor pays property taxes.

Whether the contract itself is being changed or the parties change the deal on the fly within the four corners of the contract, the DOOR neutrality mechanism accommodates the changes easily. All that is involved is an adjustment to the accumulation algorithm, i.e., an adjustment easily incorporated as an option in the applicable software program. It is easy to imagine implementing changes instantaneously and at almost no cost through a simple online procedure.

The flexibility of neutral DOOR instruments allows many tasks that currently are cumbersome to be accomplished easily and at low cost. For example, a home equity line of credit (“HELOC”) currently requires a separate formal loan. If a home increases substantially in value, an upward adjustment in the credit line is not automatic. It may require the homeowner to refinance. In contrast, a feature permitting the homeowner to create a HELOC type of loan as a virtually costless option is compatible with many DOOR variants. Furthermore, the available credit can vary in real time along with the value of the home and market conditions. Consider the ANZIE-DOOR framework. The homeowner can borrow up to the full amount of the priority block if desired. Absent a cash contribution, there are two ways in which the homeowner might expand the priority block: (i) by incurring more mortgage borrowing; (ii) by shifting insured equity to committed equity. The second route is quite easy under DOOR. The contract could permit a shift of insured equity to committed equity, perhaps subject to a minimum level of insured equity, e.g., ten percentage points, to ensure that the homeowner's maintenance incentives remain intact. The shift increases the borrowing capacity of the homeowner because it increases the size of the priority block by adding committed equity. Although insured equity drops, the rate of accrual of insured equity goes up, reflecting the now larger priority block. As a part of the adjustment program, a “quote” might be available at any time specifying the amount of insured equity available for a shift to the priority block. Of course, the DOOR contract also might include limits on borrowing against the priority block. These limits might be pre-specified or might fluctuate in real time along with the value of the home and other market parameters. Incorporating this kind of borrowing capability effectively requires consideration of data on the homeowner's credit condition as part of the analytic process for updating the corresponding DOOR instrument. Such data normally is available only with the consent of the homeowner.

The ease of the first route depends on the degree to which a third party is involved. If the investor is also the mortgage lender, then expanding the loan is an “internal” adjustment. It might involve certain closing costs, but the transaction cost probably is considerably lower than the alternative of a conventional refinance through a third party lender. There are other potential advantages of the ANZIE-DOOR investor rather than a third party being the mortgage lender. The ANZIE-DOOR contract creates positive externalities benefiting mortgagees that are internalized if the investor also is the mortgagee. Absent internalization, the parties may forgo joint gains or face higher negotiation costs. However, the DOOR investor may not be a very efficient mortgage lender. Other DOOR variants, discussed elsewhere herein, include features that avoid the externality problem entirely.

The Neutrality Mechanism

ANZIE-DOOR achieves neutrality through an insured equity account, i.e., a side arrangement that is independent of the capital structure outcomes for the home. This account accumulates the net contribution outcomes over time, translating them into notional offsetting short and long positions in the home. The net contribution balance shifts over time as the home value changes and economic parameters such as interest rates fluctuate. The insured equity account sops up this fluctuation, acting as the residual that evens out the deal between the homeowner and investor.

There are many alternative ways to even out the deal. One approach, already mentioned, is to accumulate the cash value of the net contribution amounts with interest in a “reconciliation account,” and then pay out this account at sale. This scheme has a “forced saving” aspect. The homeowner commits to accumulating the funds in a side account accessible only upon sale of the home—creating a “SAVING DOOR” variant. The account might be subject to reduction based on failure to maintain the home. An even simpler approach is to settle the net contribution amount for each period via a cash payment.

FIG. 6 is a flow chart diagram illustrating the analytic machine that implements SAVING-DOOR. It is identical to FIG. 5, the corresponding flow chart for ANZIE-DOOR, with three exceptions. First, the goal of the computation is to adjust the accrual rate for reconciliation (savings) account rather than the insured equity percentage. Accordingly, the final target hexagon on the right hand side is the reconciliation (savings) account and not the insured equity percentage. This account earns interest at the long term certainty equivalent rate, and this rate is being reset or initialized, thus the arrow from the hexagon where that rate is calculated indicating input of the new rate into the account calculations. Second, instead of computing a rate factor to use in accruing insured equity, SAVING-DOOR increments the reconciliation (savings) account by the amount of the homeowner's net contribution. The same factors (except for expected appreciation) go into the computation of that net contribution as into the rate factor computation. As a result, the homeowner net contribution hexagon in FIG. 6 replaces the rate factor hexagon in FIG. 5. Third, expected appreciation does not enter directly into the homeowner net contribution computation but only indirectly through its effect on the priority block imputed rate. As a result, the expected appreciation hexagon in FIG. 6 is not included in the grey-shaded stack of factors contributing directly to the homeowner net contribution computation. Instead it is separated from that stack and has an arrow going into the priority block imputed rate hexagon.

There are many other potential variations. For instance, instead of building up insured equity, the scheme might credit net contributions to committed equity. In this case, the priority block expands at the expense of the investor's equity, and the future net contribution of the homeowner increases, accelerating the accumulation of even more committed equity.

The choice of scheme depends on the goals of the DOOR variant. The ANZIE-DOOR approach of allocating the entire net contribution to the insured equity account aims at maximizing the build up of “safe” equity and at creating strong maintenance incentives. This scheme is ideal for workforce housing, for low wealth homeowners and, arguably, for the “typical” US homeowner.

Even holding to this set of goals, it is possible to imagine variations that might be desirable. The insured equity approach does have an insurance aspect with considerable bite when the home sells at or below the level of the priority block. In that case, the investor is on the line to pay the homeowner a percentage of home value despite having lost the entire investment and having no cash return at sale. The increase in the insured equity percentage under ANZIE-DOOR is not limited contractually, and the percentage can approach 100%. This open-endedness might make investment unattractive. A potential cure is to let the insured equity percentage build up to a limit, say 20%, and then make further net contribution adjustments some other way: cash payments, build up of committed equity, a reconciliation account, etc. This approach allows the homeowner to reach a significant equity target, and thus be “in the housing market game” regardless of the price level for homes, but at the same time limits the investor's insurance obligation.

Another downside of using the insured equity account as the residual depository of net contributions is that the fluctuating nature of the contributions makes the accumulation rate of insured equity uncertain. For many homeowners, a big attraction of the insured equity approach is the prospect of walking away at sale with a stable percentage share of home value and the consequent assurance of being “in the market” regardless of price conditions. Having the insured equity percentage accumulate stochastically is at least somewhat inconsistent with these goals. An alternative approach is to specify a fixed schedule of accumulation for insured equity and then let the stochastic residual element of net contributions manifest itself elsewhere, e.g., cash payments, as committed equity, etc. The result is to maintain the neutrality of the DOOR instrument, while at the same time making the future schedule of insured equity percentages certain.

As mentioned earlier, the neutrality mechanism implies a much more general kind of flexibility. It is not necessary to commit to a particular neutral DOOR instrument up front. Switching between neutral instruments on-the-fly is easy to accommodate and is the heart of the IS-A-DOOR variant discussed below.

Relaxing Neutrality

Neutral DOOR instruments have tremendous power and range, but there are situations where relaxing neutrality is desirable. There are several ways to depart from strict neutrality. First, an instrument might be neutral but involve infrequent adjustment. Under this approach, the operation of the instrument may depart widely from neutrality as economic conditions change in the absence of a recent adjustment. The extreme version is a static DOOR instrument defined by an up front schedule that specifies all future features of the instrument, such as the accrual path for insured equity in a way that is ex ante neutral. (“Ex ante” neutral means that the instrument's actual value is equal to its intrinsic value at origination.) This version may be quite useful. There is a trade-off between certainty and the costs of having embedded options. A static DOOR instrument creates certainty about aspects such as the accrual of insured equity, but embedded option value tends to build up. The homeowner has incentives to refinance if the terms of the DOOR instrument become less favorable than market or to remain in the home if the DOOR instrument terms have become more favorable than market.

A second type of departure from neutrality is to retain the adjustment mechanism but to remove the requirement that there be a strict balancing of benefits and detriments. For example, the instrument might blend a subsidy in the form of a dollar amount or a percentage of home value into the rate factor computation. This approach is valuable in workforce housing situations where a subsidy can create affordability for individuals in the geographical locales of their work.

DOOR variants that involve infrequent adjustment or subsidies are examples of “quasi-neutral” DOOR instruments. Some of the features of neutrality are present but not neutrality in its fullest, purest form. It also is possible to imagine useful DOOR instruments that are “non-neutral.” An example is a static DOOR instrument with schedules that are not ex ante neutral. The discussion below provides some examples of quasi-neutral and non-neutral DOOR instruments.

Multiple Variants

There clearly is a staggering set of possible DOOR variants, even if one restricts consideration to neutral ones. In most instances, it makes sense to begin with classes of investors and homeowners and specify the goals for each class. These goals suggest various features. Combining the desired features leads to a useful DOOR variant. This disclosure does not attempt to lay out all the possibilities or to delve into particular application areas in depth. The intention is to present enough variants to illustrate the scope and flexibility of inventive DOOR instruments in general.

In what follows, the focus is on several variants. ANZIE'S SIDE DOOR is an extension of ANZIE-DOOR that is useful in many contexts including low appreciation environments and situations where the goal is targeted home equity accumulation. ANZIE'S NU DOOR solves the problems associated with “underwater” homes and strategic default that arise when home value falls below the mortgage principal balance. ANZ TRIE DOOR and various partially recourse DOOR instruments shift priority block risk from the homeowner to the investor. COZIE-DOOR variants implement homeowner objectives to cash out home equity. IS-A-DOOR allows the homeowner to shift fluidly between DOOR variants. LAZIE-DOOR and FIXED-DOOR are examples of variants that are quasi-neutral or non-neutral.

ANZIE'S SIDE DOOR

ANZIE'S SIDE DOOR extends ANZIE-DOOR by adding payments (“SIDE payments”) between the homeowner and investor. These payments alter the net contribution balance and therefore cause insured equity to accrue at a faster or slower rate. The direction and specification of the side payments depend on the goals that motivate the particular application. Two applications are considered herein: (i) implementing the ANZIE-DOOR goals in locales or during time periods that involve low rates of home price appreciation; and (ii) insured equity targeting.

It is important to note that the side payments do not typically have a hard and fast interpretation in terms of traditional categories like “rent” or “interest.” Instead the payments represent a deliberate attempt to alter the “side deal” embodied in the accrual of insured equity. A coherent way to think of the “side payments” is that they simply are an aspect of the “side deal.”

The fact that the payments operate entirely within the side deal has tax implications. The discussion above suggested that this side deal should be treated like a prepaid forward or more simply as offsetting long and short positions held by the homeowner and investor respectively. Under that regimen, the side payments amount to purchases by the homeowner of a larger long position and are added to basis. On the other side of the transaction, the payments are the proceeds from repeated additional short sales, with basis implications. There are no current deductions or income items.

Addressing Low Appreciation Locales and Time Periods

Housing markets vary across geographic locales and time periods. In some locales, additional, conveniently located land is readily available for residential construction. Home price appreciation tends to be limited in these locales. Implicit or explicit rent looms large compared to appreciation as a factor in overall return. In other locales, home price appreciation is substantial and sustained, e.g., exceeding general price inflation consistently over long periods of time. Home values reach levels where net rent persists at zero or even negative values. These locales typically involve some kind of natural or government-induced scarcity, e.g., via building restrictions. Examples include many European cities, as well as coastal US cities such as San Francisco, Los Angeles, or New York. Even these locales sometimes experience a period of flat or declining home prices.

Unlike many asset prices, home price changes tend to be serially correlated, i.e., declines tend to be followed by further declines.

Both rent-intensive locales and periods of persistent price declines pose a challenge for equity based housing instruments. In the rent-intensive case, the homeowner's net contribution may be small, or it might even be the case that the investor is making a net contribution. The result for ANZIE-DOOR is very slow or even negative accumulation of insured equity. This result defeats the purpose of providing a vehicle that allows the typical homeowner to accumulate substantial “safe” equity.

The situation of persistent price declines for a period of time is even worse. Conventional equity based instruments that rely solely on appreciation for investor returns may not be viable. Homeowners may be able to exploit the persistence of price declines by financing via the appreciation-based instruments during the sour price period and then refinancing when markets begin to recover. The result is at best an interest free loan for the life of the instrument. Investors also lose “principal” if the homeowner engages in a strategic sale that takes out the equity note at the point where prices have dropped enough to eliminate some or all of the investor's equity in the home.

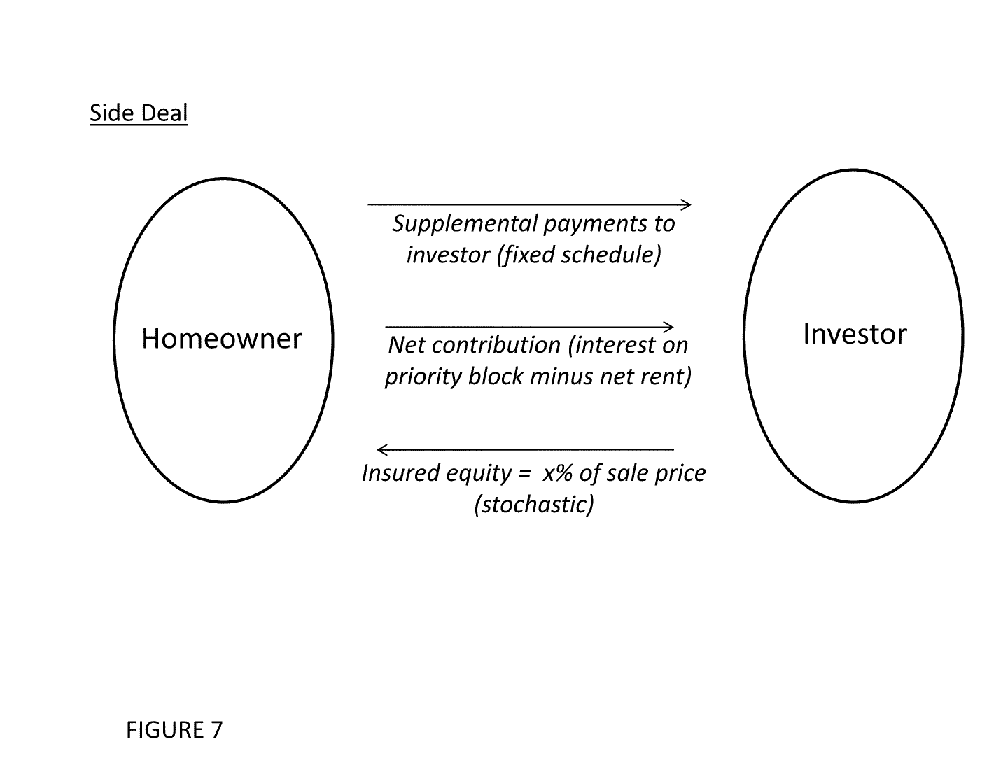

ANZIE-DOOR avoids many of these problems, but the goal of providing the homeowner with persistent accumulation of insured equity is frustrated in some cases. Under ANZIE-DOOR, the potential problems posed by rent-intensive locales and periods of persistent price declines stem from the fact that investor returns consist solely of price appreciation. It is easy enough to add a temporary or permanent periodic side payment from the homeowner to the investor. The result is a version of ANZIE'S SIDE DOOR. FIG. 7 is a block schematic diagram showing fixed supplemental payments to an investor for an ANZIE'S SIDE DOOR arrangement according to the invention.

In rent-intensive markets, this side payment might be perpetual, creating a substantial net contribution from the homeowner and resulting in a vigorous build up of insured equity. If there is a target or limit for insured equity, the instrument might specify a reduction in the side payment after the target or limit is attained.

The possibility of persistent price declines over several months or years requires a greater degree of flexibility and complexity. One solution is for the DOOR contract to require temporary side payments from the homeowner. The level of such payments is conditional on the currently applicable insured equity percentage, which reflects the amount of insured equity in the side account and also on the relationship of current home value to the priority block. If insured equity is ample enough, the contract might permit the insured equity percentage to be reduced with a floor, putting off or lessening side payments. Avoiding side payments or reducing them is a feature that might be desirable for the homeowner, especially when the decline in home values is associated with regional or national hard times. If home value is low enough relative to the priority block, the homeowner is making a large net contribution, eliminating the need for a side payment.

A situation that falls squarely in this category arises when price declines wipe out the investor's equity, i.e., home value is less than the priority block. In such a situation, the intrinsic and actual value of the investor's position is zero. Because the investor's interest in the home amounts to an out-of-the-money call option with positive value, it must be true that the homeowner is making a net contribution and accruing insured equity. The contribution is funding the call option, as discussed above. The insured equity build-up offsets the value of the call option, resulting in zero net value for the investor. The typical outcome in this situation is that insured equity is accruing to the homeowner at a rapid rate, obviating any need for a side payment. The need for side payments becomes acute when the investor has substantial equity despite the persistent declines that presage a high likelihood of further declines.

Numerical Example: “Rent-to-Own”

The example culminating in Table 7 above introduced along with ANZIE-DOOR is based on a high appreciation, low rent “baseline” situation where home prices increased at an expected rate of 7% per year and net rents remained constant at zero. This example is a very rough stylized version of some medium to high price locales in the U.S.

Consider altering this baseline model by holding the total expected annual return (expected net rent+expected appreciation) constant at the same 7%, but shifting the mix sharply toward rent: net rent is constant at 3% per year and expected appreciation is 4% per year. This change leaves the denominator of the rate factor equation the same but reduces the numerator by three percentage points. Insured equity accrues much more slowly. Leaving all the other model assumptions and parameters the same, the results under ANZIE-DOOR are as shown in Table 8 below.

TABLE 8
Example—High Rent Version, Non-recourse Case (ANZIE-DOOR)
End of Year Insured Equity Percentages & Home Value Extremes
net rent = 3% per year; expected appreciation = 4% per year

| | insured equity percentage—distribution over 100,000 runs | | | | | | | | home value | |
|---|---|---|---|---|---|---|---|---|---|---|
| year | mean | std dev | min | 1% | 10% | 90% | 99% | max | min val | max val |
| 1 | 0.71 | 0.00 | 0.71 | 0.71 | 0.71 | 0.71 | 0.71 | 0.71 | 0.70 | 1.44 |
| 2 | 1.32 | 0.25 | 0.56 | 0.84 | 1.02 | 1.64 | 2.06 | 3.50 | 0.65 | 1.63 |
| 3 | 1.84 | 0.56 | 0.29 | 0.78 | 1.19 | 2.54 | 3.50 | 6.98 | 0.55 | 1.95 |
| 4 | 2.27 | 0.91 | −0.19 | 0.55 | 1.21 | 3.41 | 4.96 | 10.68 | 0.58 | 2.18 |
| 5 | 2.61 | 1.30 | −0.95 | 0.17 | 1.11 | 4.22 | 6.49 | 14.88 | 0.58 | 2.57 |
| 6 | 2.86 | 1.73 | −1.77 | −0.35 | 0.87 | 5.00 | 8.02 | 17.59 | 0.52 | 2.99 |
| 7 | 3.04 | 2.17 | −2.77 | −1.03 | 0.54 | 5.70 | 9.60 | 19.93 | 0.52 | 3.22 |
| 8 | 3.13 | 2.63 | −3.99 | −1.76 | 0.11 | 6.32 | 11.30 | 22.76 | 0.47 | 3.57 |
| 9 | 3.15 | 3.10 | −5.22 | −2.59 | −0.42 | 6.90 | 12.90 | 27.88 | 0.46 | 4.08 |
| 10 | 3.09 | 3.59 | −6.52 | −3.55 | −1.00 | 7.47 | 14.47 | 32.97 | 0.50 | 3.67 |
| 11 | 2.96 | 4.08 | −7.88 | −4.52 | −1.68 | 7.93 | 16.20 | 36.94 | 0.42 | 4.01 |
| 12 | 2.76 | 4.57 | −9.21 | −5.65 | −2.43 | 8.32 | 17.49 | 39.79 | 0.42 | 4.40 |
| 13 | 2.49 | 5.06 | −10.55 | −6.76 | −3.28 | 8.70 | 18.45 | 41.88 | 0.47 | 4.56 |
| 14 | 2.16 | 5.56 | −12.00 | −7.95 | −4.20 | 8.92 | 19.50 | 44.50 | 0.48 | 5.33 |
| 15 | 1.76 | 6.06 | −13.54 | −9.21 | −5.19 | 9.15 | 20.39 | 46.48 | 0.45 | 5.84 |
| 16 | 1.30 | 6.57 | −15.25 | −10.57 | −6.24 | 9.33 | 21.39 | 49.00 | 0.46 | 6.26 |
| 17 | 0.78 | 7.08 | −17.01 | −11.97 | −7.33 | 9.44 | 22.35 | 51.35 | 0.49 | 7.48 |
| 18 | 0.20 | 7.59 | −18.95 | −13.50 | −8.55 | 9.51 | 23.38 | 53.78 | 0.45 | 7.10 |
| 19 | −0.45 | 8.10 | −20.97 | −15.04 | −9.77 | 9.49 | 23.99 | 56.57 | 0.43 | 7.13 |
| 20 | −1.15 | 8.61 | −23.02 | −16.66 | −11.09 | 9.48 | 24.81 | 59.10 | 0.47 | 8.35 |
| 21 | −1.91 | 9.13 | −25.12 | −18.35 | −12.47 | 9.38 | 25.49 | 61.32 | 0.45 | 8.62 |
| 22 | −2.72 | 9.65 | −27.26 | −20.01 | −13.92 | 9.25 | 26.25 | 64.06 | 0.45 | 9.61 |
| 23 | −3.60 | 10.16 | −29.49 | −21.88 | −15.38 | 9.05 | 26.86 | 66.68 | 0.47 | 10.74 |
| 24 | −4.53 | 10.68 | −31.76 | −23.74 | −16.94 | 8.85 | 27.52 | 68.77 | 0.43 | 12.64 |
| 25 | −5.51 | 11.21 | −34.07 | −25.68 | −18.54 | 8.57 | 28.08 | 71.13 | 0.42 | 14.10 |
| 26 | −6.55 | 11.73 | −36.38 | −27.81 | −20.20 | 8.25 | 28.62 | 73.40 | 0.36 | 15.61 |
| 27 | −7.64 | 12.27 | −38.73 | −29.84 | −21.94 | 7.95 | 29.42 | 75.94 | 0.37 | 18.19 |
| 28 | −8.79 | 12.81 | −41.14 | −31.96 | −23.72 | 7.53 | 29.76 | 78.22 | 0.39 | 19.25 |
| 29 | −9.99 | 13.35 | −43.62 | −34.26 | −25.51 | 7.05 | 29.71 | 80.10 | 0.43 | 19.90 |
| 30 | −11.24 | 13.90 | −46.10 | −36.62 | −27.45 | 6.58 | 29.72 | 81.65 | 0.40 | 19.29 |

Clearly, for most homeowners the outcomes do not achieve the goal of putting them “in the game” after a few years by building up substantial insured equity. The mean insured equity percentage across all price paths never exceeds 3.15%, it turns negative in year 19, and then it plunges, reaching −11.24% in year 30. Only very extreme instances (around the 99th percentile or above for accrual of insured equity, corresponding to low or negative price appreciation) result in the kind of accrual of insured equity that might be acceptable. Home price volatility is not adjusted lower in this new example, but is left the same as in the high expected appreciation example in Table 7. If lower volatility accompanies lower expected appreciation, then the extreme outcomes in Table 8 are even more unlikely than indicated in the table.

It is easy to specify a version of ANZIE'S SIDE DOOR where the homeowner makes an annual payment to the investor that fixes this problem. Suppose that the instrument requires the homeowner to pay the entire 3% net rent to the investor each year. Then the rate factor is restored to the same value as for the case of 7% appreciation and 0% net rent. The 3% payment to the investor is added to the numerator of the rate factor in equation (4) exactly offsetting the negative 3% term arising from net rent. The denominator, the total expected return for the home, is unchanged by the addition of the annual transfer payment from the homeowner to the investor. As a consequence, the results are the same as in Table 7, and the homeowner experiences a substantial accrual of insured equity across all price paths.

This situation is analogous to “rent to own” schemes except that the occupant is an owner from the start. The occupant is paying “full rent” (depreciation+property taxes+net rent) and also making payments on a mortgage. These mortgage payments are the net contribution and result in the rapid accrual of insured equity.

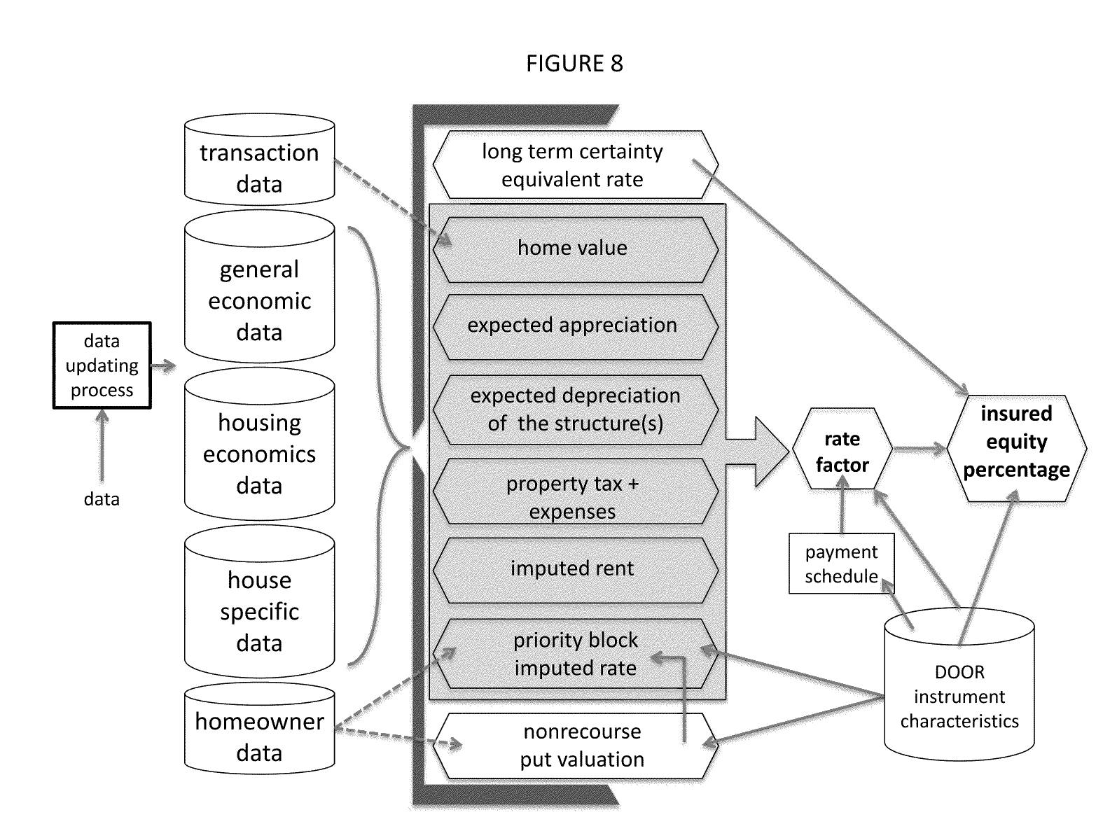

FIG. 8 is a flow chart diagram illustrating the analytic machine implementing versions of ANZIE'S SIDE DOOR that incorporates scheduled payments from the homeowner to the investor. The flow chart is identical to FIG. 5 for ANZIE-DOOR except for an additional flow of arrows from the DOOR instrument characteristics cylinder to the rate factor hexagon. This additional flow includes a non-bold rectangle labeled “payment schedule,” illustrating the fact that contract terms impose on the homeowner a certain schedule of payments to the investor. These payments enter into the rate factor computation. The other direct arrow from the DOOR instrument characteristics cylinder to the rate factor hexagon includes data and instructions already present in ANZIE-DOOR: the size of the priority block and the formula for the rate factor calculation.

Creating two arrows flow emphasizes the payment schedule aspect that transforms ANZIE-DOOR into a version of ANZIE'S SIDE DOOR.

Insured Equity Targeting

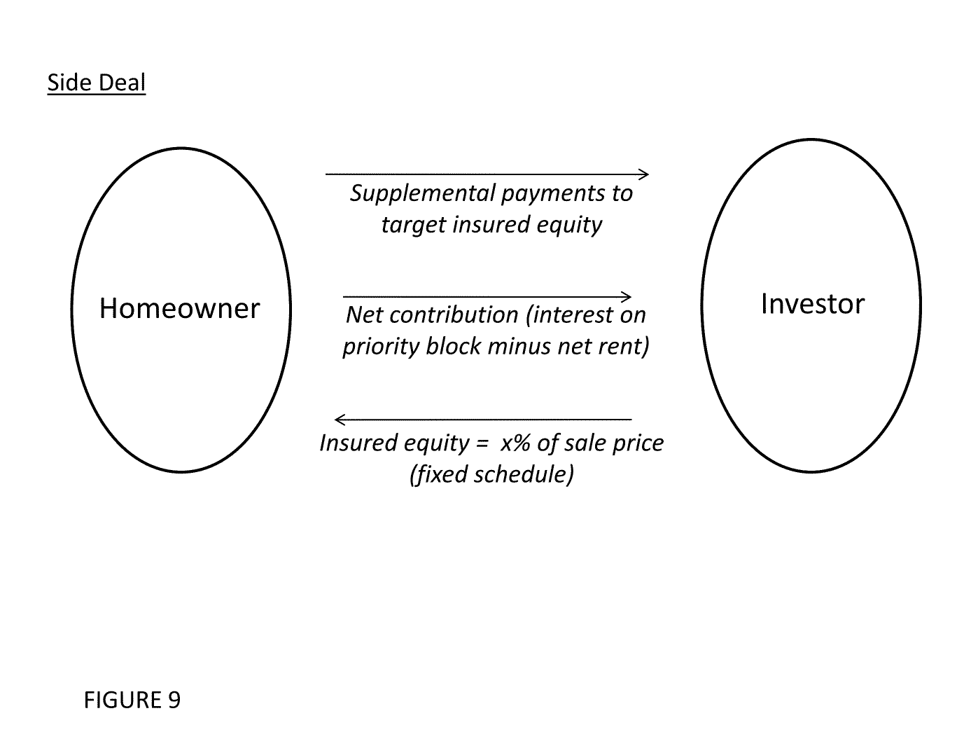

A different application of ANZIE'S SIDE DOOR addresses the situation where the homeowner prefers predictability of the accrual schedule for insured equity. One version of ANZIE'S SIDE DOOR that achieves this result requires stochastic payments between the homeowner and the investor in the direction and amount that achieves the desired accrual pattern. FIG. 9 is a block schematic diagram showing a targeted insured equity scheme that employs stochastic payments for an ANZIE'S SIDE DOOR arrangement according to the invention.

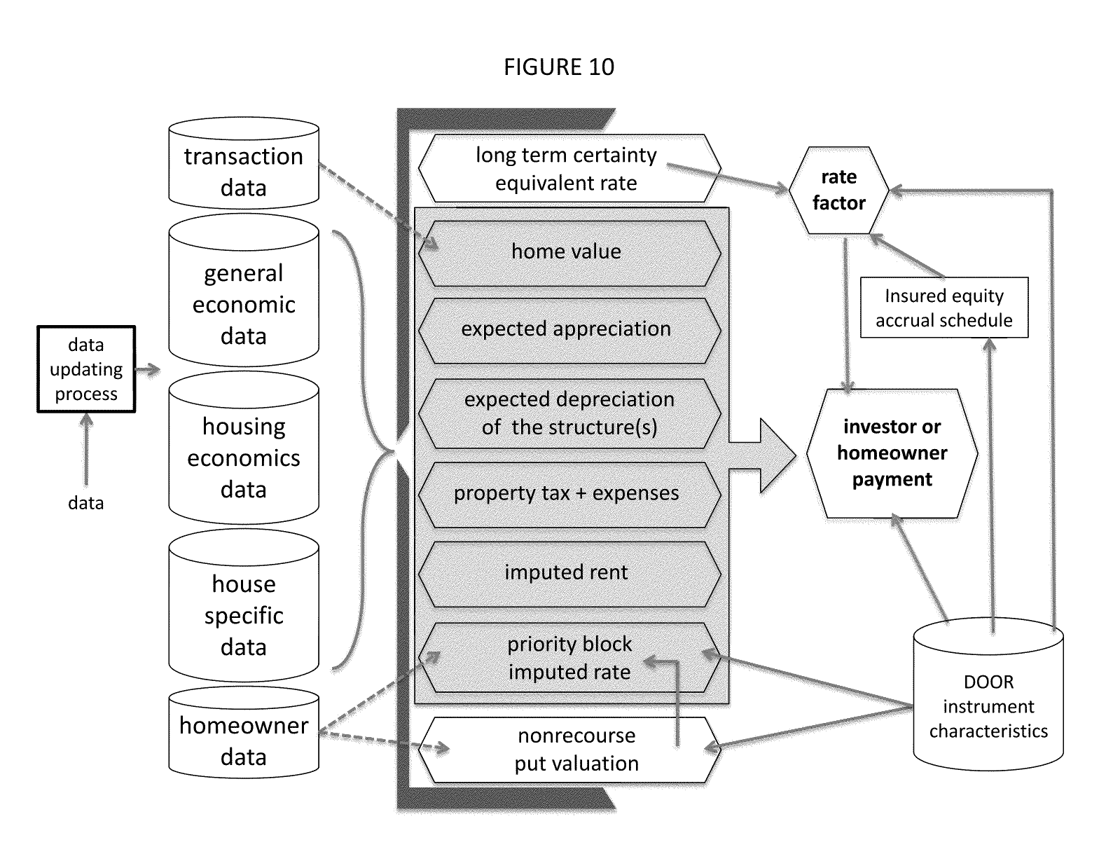

FIG. 10 is a flow chart diagram illustrating the analytic machine that implements a version of ANZIE'S SIDE DOOR that incorporates a targeted insured equity scheme by using stochastic payments as the residual balancing mechanism. It differs from the analytic machine for ANZIE-DOOR illustrated in FIG. 5 in three respects. First, the end product of the machine's operation is to specify a stream of payments between the homeowner and investor over the ensuing period that balances out the net contributions of the parties, allowing for any targeted insured equity accrual to the homeowner. Thus, the culminating hexagon on the far right of FIG. 10 represents the computation of the required payment flow rather than of the evolution of the insured equity percentage under ANZIE-DOOR in FIG. 5. A key input for this computation is the value of the rate factor that causes insured equity to evolve according to the fixed schedule specified under the applicable targeted insured equity version of ANZIE'S SIDE DOOR. With this input in hand, the computation proceeds using a rate factor relationship such as equation (4), inverted to determine the required payment stream.

Second, the rate factor calculation requires the long term certainty equivalent rate, the insured equity accrual schedule, past values of rates, and a relationship such as equation (5). The arrows into the rate factor hexagon indicate the required inputs.

Third, there are two separate flows of arrows from the DOOR instrument characteristics cylinder to the rate factor hexagon. One is a direct arrow as in FIG. 5 that indicates similar information flows as under ANZIE-DOOR: the past data and contractual specifications of the mathematical relationships required to compute the rate factor. The additional flow of arrows includes a non-bold box labeled “insured equity accrual schedule,” and the flow begins from the DOOR instrument characteristics cylinder, indicating that this schedule is contractual. This flow of arrows emphasizes that the rate factor computation requires the insured equity accrual schedule under the DOOR contract.

To make the targeted insured equity version of ANZIE'S SIDE DOOR more concrete, consider an example. Suppose that the homeowner wants to accrue 20 percentage points of insured equity by year 10 and then hold the percentage at that level. Imposing this kind of schedule results in stochastic payments that tend to flow from the homeowner to the investor in the first ten years and then in the opposite direction subsequently. Thus, after reaching the target insured equity percentage, the homeowner enjoys a revenue stream.

In an environment where expected appreciation is substantial, the homeowner might wish to make heavy payments in the earliest years to avoid having to make very large ones in the run up to year 10. Recall from equation (4) that with net rent equal to zero and fixed interest rates, the numerator of the rate factor tends to fall as the home appreciates due to the drop in the “loan to value” represented by the priority block. As a result, absent some kind of front loading the level of payments from the homeowner to the investor is likely to increase sharply during the ten year period.

But the homeowner does not have to front load. Any desired pattern is possible, and it is possible to build in dynamic elements. For instance, the homeowner might create caps and floors on the payment with a subsequent adjustment in future payments or in the length of time required to reach the target. The flexibility of the DOOR instrument admits even broader possibilities. For example, after insured equity reaches a certain minimum level, the DOOR contract might permit the homeowner simply to choose a payment level at the beginning of each period. Different payment level patterns result in different final levels of insured equity. The “hard target” version is not the only possibility.

Numerical Example: Insured Equity Targeting

For purposes of comparability it is convenient to use the high appreciation, low rent baseline model that generated the ANZIE-DOOR results in Table 7 above: home prices increase at an expected rate of 7% per year following geometric Brownian motion and net rent remains constant at zero. Consider a “hard target” example: The insured equity percentage builds up to 20 percentage points after 10 years and remains at that level thereafter. This requires an average rate factor of about 0.4463 during the initial ten-year period and a zero rate factor subsequently. Along price paths that represent home value appreciation close to the median, the homeowner makes additional payments to the investor during the first ten years and receives payments from the investor thereafter.

Assume that the homeowner desires reasonably flat payments during the first ten years. Because there is a strong tendency for home price appreciation, the homeowner wants to begin with a high target rate factor and end (in year ten) with a low target rate factor, compared to the required mean of about 0.4463 per year. Holding the mean of the rate factor constant and creating a pattern of exponential decline using the annual factor 1/(1.075) works fairly well.

Table 9 below displays the distribution of required payments expressed as a percentage of initial home value:

TABLE 9
Example—ANZIE'S SIDE DOOR with Hard Insured Equity Target
Target: 20 percentage points of insured equity after 10 years
priority block = 80% of initial home value
net rent = 0% per year; expected appreciation = 7% per year

| | required payments as a % of initial home value | | | | | | | | home value | |
|---|---|---|---|---|---|---|---|---|---|---|
| year | mean | std dev | min | 1% | 10% | 90% | 99% | max | min val | max val |
| 1 | 0.23 | 0.00 | 0.23 | 0.23 | 0.23 | 0.23 | 0.23 | 0.23 | 0.73 | 1.47 |
| 2 | 0.22 | 0.36 | −1.78 | −0.64 | −0.24 | 0.68 | 1.06 | 1.78 | 0.69 | 1.71 |
| 3 | 0.21 | 0.51 | −2.42 | −0.92 | −0.42 | 0.88 | 1.46 | 2.25 | 0.61 | 2.10 |
| 4 | 0.21 | 0.62 | −3.56 | −1.10 | −0.55 | 1.02 | 1.79 | 3.15 | 0.66 | 2.41 |
| 5 | 0.21 | 0.71 | −3.16 | −1.27 | −0.66 | 1.13 | 2.09 | 3.63 | 0.68 | 2.91 |
| 6 | 0.20 | 0.80 | −3.08 | −1.39 | −0.78 | 1.26 | 2.32 | 4.58 | 0.63 | 3.47 |
| 7 | 0.20 | 0.88 | −3.77 | −1.52 | −0.86 | 1.34 | 2.58 | 5.52 | 0.65 | 3.84 |
| 8 | 0.20 | 0.95 | −3.68 | −1.62 | −0.92 | 1.43 | 2.81 | 5.79 | 0.61 | 4.38 |
| 9 | 0.19 | 1.02 | −4.27 | −1.74 | −1.00 | 1.53 | 3.02 | 6.39 | 0.61 | 5.12 |
| 10 | 0.19 | 1.07 | −4.34 | −1.83 | −1.06 | 1.61 | 3.28 | 7.31 | 0.68 | 4.77 |
| 11 | −4.00 | 0.02 | −5.05 | −4.00 | −4.00 | −4.00 | −4.00 | −4.00 | 0.60 | 5.35 |
| 12 | −4.00 | 0.02 | −5.74 | −4.00 | −4.00 | −4.00 | −4.00 | −4.00 | 0.62 | 6.03 |
| 13 | −4.00 | 0.02 | −5.64 | −4.00 | −4.00 | −4.00 | −4.00 | −4.00 | 0.71 | 6.43 |
| 14 | −4.00 | 0.01 | −4.84 | −4.00 | −4.00 | −4.00 | −4.00 | −4.00 | 0.74 | 7.70 |
| 15 | −4.00 | 0.01 | −4.55 | −4.00 | −4.00 | −4.00 | −4.00 | −4.00 | 0.72 | 8.67 |
| 16 | −4.00 | 0.01 | −4.73 | −4.00 | −4.00 | −4.00 | −4.00 | −4.00 | 0.76 | 9.56 |
| 17 | −4.00 | 0.00 | −4.39 | −4.00 | −4.00 | −4.00 | −4.00 | −4.00 | 0.83 | 11.72 |
| 18 | −4.00 | 0.00 | −4.08 | −4.00 | −4.00 | −4.00 | −4.00 | −4.00 | 0.79 | 11.47 |
| 19 | −4.00 | 0.00 | −4.20 | −4.00 | −4.00 | −4.00 | −4.00 | −4.00 | 0.77 | 11.85 |
| 20 | −4.00 | 0.00 | −4.31 | −4.00 | −4.00 | −4.00 | −4.00 | −4.00 | 0.87 | 14.24 |
| 21 | −4.00 | 0.00 | −4.04 | −4.00 | −4.00 | −4.00 | −4.00 | −4.00 | 0.87 | 15.12 |
| 22 | −4.00 | 0.00 | −4.04 | −4.00 | −4.00 | −4.00 | −4.00 | −4.00 | 0.88 | 17.33 |
| 23 | −4.00 | 0.00 | −4.03 | −4.00 | −4.00 | −4.00 | −4.00 | −4.00 | 0.94 | 19.88 |
| 24 | −4.00 | 0.00 | −4.01 | −4.00 | −4.00 | −4.00 | −4.00 | −4.00 | 0.91 | 24.01 |
| 25 | −4.00 | 0.00 | −4.02 | −4.00 | −4.00 | −4.00 | −4.00 | −4.00 | 0.91 | 27.49 |
| 26 | −4.00 | 0.00 | −4.02 | −4.00 | −4.00 | −4.00 | −4.00 | −4.00 | 0.81 | 31.27 |
| 27 | −4.00 | 0.00 | −4.12 | −4.00 | −4.00 | −4.00 | −4.00 | −4.00 | 0.84 | 37.38 |
| 28 | −4.00 | 0.00 | −4.06 | −4.00 | −4.00 | −4.00 | −4.00 | −4.00 | 0.93 | 40.68 |
| 29 | −4.00 | 0.00 | −4.01 | −4.00 | −4.00 | −4.00 | −4.00 | −4.00 | 1.03 | 43.26 |
| 30 | −4.00 | 0.00 | −4.00 | −4.00 | −4.00 | −4.00 | −4.00 | −4.00 | 1.00 | 43.25 |

The mean results are quite satisfactory. For the first ten years the series of mean annual payments are all around two-tenths of a percent of original home value. After the end of ten years, the mean outcome is that the homeowner receives continuing annual payments equal to four percent of original home value or a little bit more for price paths resulting in very extreme low outcomes. The reason for this pattern is simple. Except for price paths that involve very low outcomes, the interest rate, i_{P}, used to compute the rate factor is constant at five percent. As a result, the dollar amount of the homeowner's contribution is flat because the priority block is of constant dollar size (0.8 of original home value). Because net rent is always zero, the dollar net contribution of the homeowner is constant at four percent of initial home value. Beginning in year 11, the investor simply pays the homeowner this amount in cash every year.

After ten years, the homeowner holds a 20% position in the home via the insured equity account. The overall pattern has a definite “life cycle” look. The individual builds up wealth by saving (through the extra payments) in early years and then receives an annuity in later years.

The maximum required payments may seem very high. They total about 40% of initial home value over 10 years. Of course, no single price path may involve the maximum payment every year. These maximum payments occur when appreciation outcomes are maximal. Although the payments are high, the value of the insured equity account also is high. For example, the maximum home value outcome after ten years is about 4.77 times the initial value. At that time the insured equity percentage is at 20. As a result, the value of the account is equal to about 95% of initial home value. If high payments are unacceptable, it is easy to build in an “out.” There are many possibilities. The homeowner may have the option to reduce any particular payment or all the payments may be voluntary, creating a “self-made” accumulation scheme. It is easy to provide the homeowner with information about the consequences of any one payment and of various patterns of payments over time.

Non-Neutral and Quasi-Neutral DOOR Instruments

Why Relax Neutrality?

Achieving neutrality through an adjustment process has many attractive features. It eliminates the role of embedded options along with the ensuing moral hazard and valuation problems by making the options nearly or actually worthless. It creates tremendous flexibility through an automatic compensating adjustment that allows the terms of neutral DOOR instruments to be shifted on-the-fly and at very low cost.

But neutrality and the associated adjustment process also create qualities that may not always be desirable. Most important, there must be some “residual” element that bears the brunt of the adjustments. For ANZIE-DOOR, that element is insured equity. It builds up at different rates depending on the impact of economic outcomes through the adjustment process. The homeowner may desire a more predictable build up of insured equity, but to obtain it and still maintain neutrality requires that some other element be the “residual.” In one version of ANZIE'S SIDE DOOR, for example, the insured equity build up pattern was fixed, but the homeowner made stochastic supplemental payments each year to maintain neutrality.

More generally, the adjustment process exposes the homeowner to a large set of different risks. The process balances out rent, depreciation, property taxes, the implied interest rate on the priority block, the size of the priority block versus home value, and the expected rate of appreciation. Many of these elements are stochastic. In particular, rents, interest rates, home values, and expected appreciation may fluctuate widely. The homeowner is exposed to these fluctuations directly through the ensuing changes in the residual element. For example, consider a one-time permanent and unexpected increase in rents, holding depreciation, property taxes, interest rates and expected appreciation constant. Presumably, home prices shift upward because these prices capitalize net rent values in the future. Recall the rate factor for ANZIE-DOOR from equation (4):

$${π}_{h} = \frac{{i}_{P} {L}_{P} - v}{v + α} .$$

A shift upward in home prices reduces L_{P} while the upward shift in rent prevents v, net rent per dollar of home value, from decreasing. The result is a drop in the rate factor. If the shift is extreme enough, the rate factor becomes negative, and insured equity accumulates much more slowly or even de-cumulates.

As pointed out cogently in Sinai and Souleles (supra), buying a home reduces and in some cases nearly eliminates rent risk for the homeowner. Instead of paying time-varying rents, the homeowner makes a one-time payment to purchase the home. The impact of varying rents only catches up to the homeowner at sale (because the house value capitalizes future rent), but sale may be far in the future so that the impact is heavily discounted. Sinai and Souleles use data on apartment rents to show that rent risk is substantial.

ANZIE-DOOR takes away the shield against fluctuations in rents. These fluctuations impact the build-up of insured equity and thus expose the homeowner to rental price risk via the adjustment process. If the adjustment process is frequent enough, e.g., daily, the homeowner may be exposed to more rental price risk than a renter. A renter at least locks in rents for the period of the lease.

This type of problem motivates some of the quasi-neutral and non-neutral variants discussed herein. But there are other motivations. One of them, discussed previously, is a desire to create a subsidy for certain homeowners. This desire may be made manifest by not adhering to strict neutrality, giving the homeowner more benefits or credit than is due based on the homeowner's net contribution.

There are many useful DOOR variants that involve abandoning or departing from neutrality. The following discussion focuses on two illustrative ones. LAZIE-DOOR typically is quasi-neutral: The adjustment process still operates, creating a tendency toward neutrality, but some of the elements (rent, depreciation, expected appreciation, etc.) are fixed and do not fluctuate to reflect their actual values. FIXED-DOOR is a DOOR instrument where the terms are set up front and there are no adjustments. FIXED-DOOR versions may be quasi-neutral or non-neutral.

LAZIE-DOOR

If the goal is to shield the homeowner against rent fluctuations, a simple approach is to alter ANZIE-DOOR by fixing net rent in the rate factor equation. If net rent is stationary, a natural approach would be to set it at its mean value. If rents are independent and identically distributed (“IID”) as well as stationary, then the adjustment process is approximately neutral in an ex ante sense under this approach. (Exact neutrality generally will not obtain because the expected level of the insured equity percentage at future times will shift due to Jensen's inequality. The adjustment mechanism translates elements such as net rent into insured equity percentages in a non-linear fashion.)

If mean net rents have a trend, e.g., real or nominal growth at a fixed rate, then net rent might be set at the expected mean value for all periods in the future, resulting in a fixed schedule. Because expected home appreciation reflects expected growth in rents among other factors, the approach of fixing net rent in the rate factor equation might be supplemented by fixing expected appreciation or by allowing it to be equal to general price inflation with an adjustment that reflects the expected real rate of growth in rents.

These approaches are instances of LAZIE-DOOR: “Limited Neutrality, Annually Adjusted, Z Capital Structure, Insured Equity DOOR instruments.” The “lazy” in LAZIE-DOOR derives from the fact that the adjustors are not bothering to observe the actual values of some elements of the rate factor calculation but instead are using fixed values for those elements.

LAZIE-DOOR permits some nicely targeted subsidy schemes. For example, if net rent is set at zero in a jurisdiction where mean net rent is positive, the homeowner is getting a subsidy, i.e., living in the home “net rent free.” This approach has a certain conceptual attractiveness in workforce housing situations but may provide too little or too much subsidy. In that case, the adjustor can substitute some level other than zero or some time-varying but fixed schedule for net rent.

Table 7 above illustrates the operation of ANZIE-DOOR under the baseline model assumptions that net rent is zero and expected appreciation is constant at a 7% annual rate. The example corresponds exactly to LAZIE-DOOR in an environment where net rents and expected appreciation fluctuate, but the adjustor has fixed them at 0% of home value and 7% per year respectively. The results are quite nice in a workforce housing context if these numbers involve a subsidy element, but also represent a good outcome for the typical homeowner when there is no subsidy element. The homeowner builds up substantial insured equity in all price path scenarios.

There are many possible versions of LAZIE-DOOR. The adjustor can hold any combination of parameters (rent, depreciation, property taxes, interest rates, inflation, expected appreciation, real rents, etc.) constant or impose a fixed future schedule. This flexibility permits tailoring to different situations whether or not they involve workforce housing.

When a parameter is held constant, the homeowner is insulated from fluctuations in that parameter for the duration of the DOOR instrument. At sale or when the DOOR instrument is otherwise terminated, the parameter's influence may reappear. For instance, suppose a LAZIE-DOOR instrument involves fixed net rent. The home price at sale reflects actual net rent levels, and, as a result, the homeowner receives a lower or higher dollar payoff for any given insured equity percentage depending on how net rent has evolved.

Holding one or more parameters constant means that neutrality is absent and embedded options regain their importance. For instance, if net rent is fixed and actual net rent fluctuates above the fixed value, the homeowner is receiving a bargain and has an artificial incentive to stay in the home because the DOOR instrument is more favorable than market. But it still may be worthwhile to use a version of LAZIE-DOOR. The parties may favor shifting the risk of fluctuation in one or more parameters to the investor, or LAZIE-DOOR may be a good vehicle for implementing a subsidy. Combining some pattern of subsidy and risk insulation is ideal for many workforce housing situations, where the homeowner is faced with a housing expenditure that looms large compared to income and carries a great deal of risk.

LAZIE-DOOR typically is “quasi-neutral.” The adjustment process is still present but some aspects of it are frozen. These aspects do not reflect the actual values that would drive neutrality. But other aspects do. The result is that some tendency toward neutrality is present but not neutrality in its fullest, purest form.

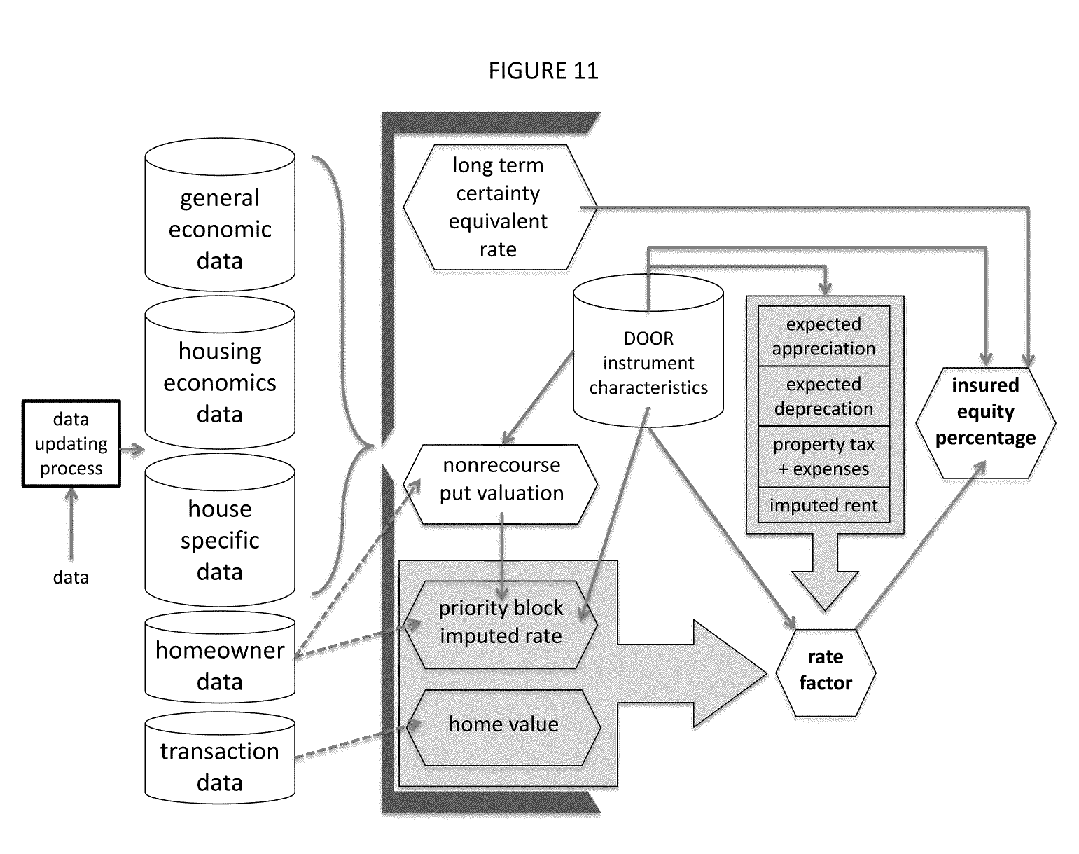

FIG. 11 is a flow chart diagram that illustrates the analytic machine for a version of LAZIE-DOOR where expected appreciation, expected depreciation, property taxes and imputed rent are fixed. (“Fixed” includes cases where a parameter varies but according to a determinate schedule as well as cases where the parameter is set at one value for the duration of the life of the instrument.) At each point of adjustment, the only rate factor inputs that are not fixed are home value and the priority block imputed rate. The ensuing figure is the same as FIG. 5 for ANZIE-DOOR except that four of the inputs for the rate factor are specified instead of estimated or observed. These four inputs thus emerge (as four stacked grey-shaded non-bold rectangles—determined not computed) from the DOOR instrument characteristics cylinder rather than from the data cylinders and then feed into the rate factor calculation.

There are other ways besides fixed values or fixed schedules to avoid going through the hard work of estimating a parameter such as rent or house value. One possibility is to adjust the initial rent or price levels using a regional or national rent or house price index. These indices show the aggregate proportional change in price or rents and can be used to inflate or deflate rent or price values observed at origination. This approach is “lazy” because the servicer is settling for an easily computed but less accurate estimate of rent or home value levels. The rent and home price changes for the property in question typically diverge at least somewhat from aggregate changes. On the other hand, no matter how sophisticated the analytic engine under ANZIE-DOOR is, the ensuing rent and home value estimates still are approximations. Using an index based approach to adjust can be conceived as merely using a rougher approximation but still within the ambit of ANZIE-DOOR itself. Whether one attaches the name ANZIE-DOOR or LAZIE-DOOR to a particular approach is not important. What is interesting is that using certain rough approximations to implement ANZIE-DOOR results in a DOOR instrument that resembles certain versions of LAZIE-DOOR.

FIXED-DOOR

FIXED-DOOR is a static DOOR instrument. None of the terms are conditional on future parameter values such as interest rates or home value. The evolution of insured equity or other accounts is pre-determined. These accounts may change over time, but only in accordance with a schedule that is fixed in advance.

FIXED-DOOR instruments may be “origination neutral” in the sense that the market value of the instrument at the time of issuance is equal to the amount of money advanced by the investor. At that one time, the market value of the instrument is equal to its intrinsic value. Absent conditioning on market parameters, this equality almost certainly disappears, even if the instrument terms evolve under a fixed schedule. Because FIXED-DOOR is static, the adjustment parameters deviate from the actual future values with probability one. As a result, market value deviates from intrinsic value almost surely.

An additional step toward neutrality is possible. One might build in a schedule of annual adjustments or other features that reflect expected outcomes for home prices, interest rates, and other parameters as of the time of origination. If the expected outcomes emerge consistently as actual outcomes, the instrument is neutral at all future times. Of course, that happy result would be an incredible coincidence. Nonetheless, setting up the instrument in this “projectively neutral” way tends to result in future states closer to actual neutrality.

Using expected future outcomes for the parameters is only one way to push future results toward neutrality. A more rigorous approach is to choose a fixed insured equity schedule that minimizes an aggregate deviation criterion (e.g., mean squared error or mean absolute deviation) based on some numerical measure of neutrality. In short, there is a broad class of “putatively neutral” insured equity accrual schedules that arise from various different ways of targeting neutrality.

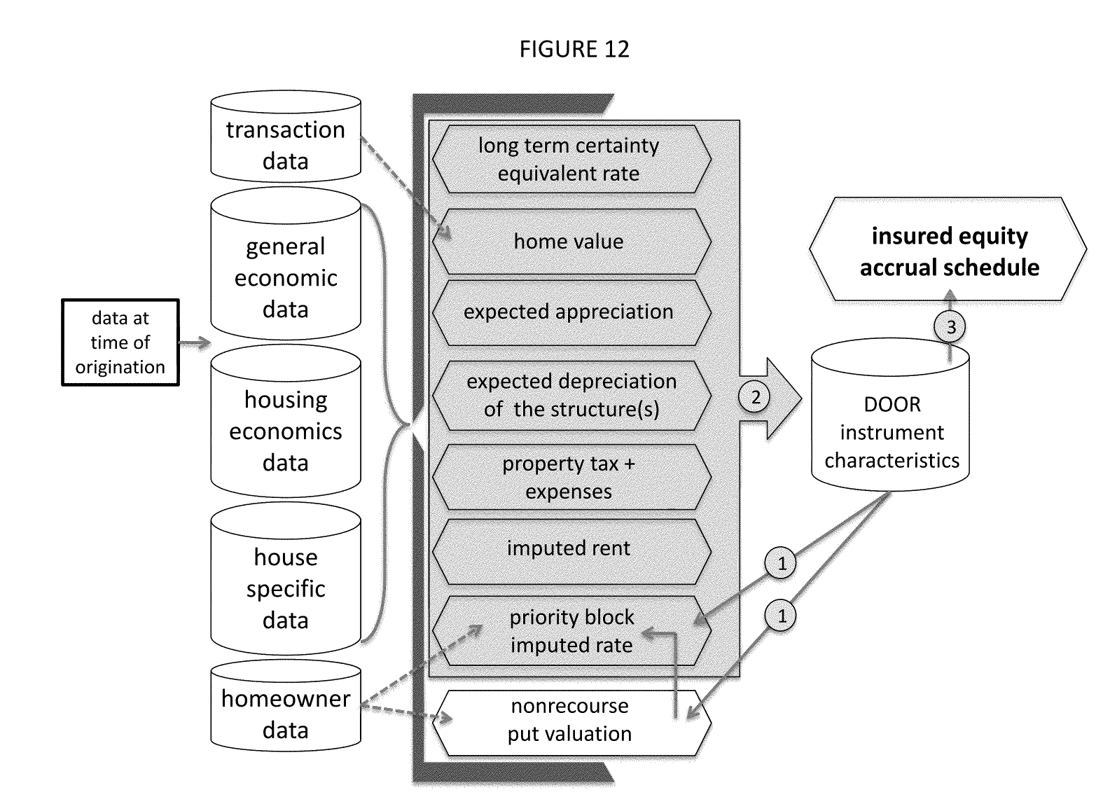

FIG. 12 is a flow chart diagram that illustrates the analytic machine for FIXED DOOR versions that generate putatively neutral insured equity accrual schedules. The machine operates only at one point in time: origination. Thus, in contrast to the analytic machine for ANZIE-DOOR illustrated in FIG. 5, the bold box on the left hand side of FIG. 10 reads “data at time of origination.” There is no updating process for data. Instead, the machine uses the data available at origination to create a putatively neutral schedule for accruing insured equity. This process is captured by the fact that the grey-shaded stack of computed parameters feeds into the DOOR instrument characteristics cylinder. Instructions contained in that cylinder specify a method for determining a putative neutral insured equity accrual schedule. The method and the relevant information from the computed parameters is then fed into the computing module, represented by the hexagon labeled “insured equity accrual schedule,” where the schedule is determined once and for all. Because some of the arrows associated with the DOOR instrument characteristics cylinder form a cycle, it is necessary to specify the order of the information flows. Numbering the arrows on the diagram indicates the order. First as step “1” in the diagram, data on the priority block and instructions flow from the DOOR instrument characteristics cylinder to the nonrecourse put valuation and priority block imputed rate computation modules (hexagons in the diagram). The output of these modules is the present and projected priority block imputed rates that are input (along with other parameters in the grey-shaded stack) back into the DOOR instrument characteristics cylinder, step “2” in the diagram. Finally, as step “3” in the diagram, these inputs combined with instructions for computing the desired kind of putatively neutral insured equity accrual schedule are shunted to the module that computes that schedule.

In some cases, it is desirable to issue FIXED-DOOR instruments that have no elements of neutrality. These “non-neutral” instruments are quite natural in workforce housing or other contexts where a subsidy is appropriate. For example, a FIXED-DOOR instrument might involve a predetermined schedule for accrual of insured equity that is ex ante favorable to the homeowner. At origination, the market value of such an instrument to a hypothetical investor is less than the amount of money advanced to the homeowner, reflecting the subsidy. The instrument also might accrue insured equity faster or slower than the expected rate during different parts of the instrument's life in order to tailor the insured equity schedule to the individual's preferences or needs.

ANZIE'S NU DOOR

“Underwater” Homes

The problem of “underwater” homes has been especially visible during the housing crisis that began in 2007. Once home value approaches or falls below the principal due on mortgage finance, problems arise that threaten to cause real economic losses. First, for many homeowners with non-recourse mortgages, default becomes financially desirable, even if the homeowner has ample income to continue servicing the mortgages. Default and subsequent short sales or foreclosures involve substantial transaction costs. Second, the situation is worsened by the fact that the homeowner's incentive to maintain the home and even to protect it against looters drops off or vanishes. Any such efforts benefit the lender, not the homeowner. Finally, the presence of homes in foreclosure, especially if they are not maintained, adversely affects the values of nearby homes. This effect contributes to further price declines and can result in more foreclosures and wholesale degradation of neighborhoods.

It is important to emphasize that this situation involves real economic losses, not merely a transfer of properties from one owner to another. The transaction costs, maintenance failures, and neighborhood externality effects all result in net losses in value.

The following discussion presents a DOOR variant that prevents the “underwater” situation from ever arising. This variant derives from ANZIE-DOOR, but it would be easy to add the particular features that prevent home value from being less than the mortgage balance to almost any DOOR variant. Discussion near the end of the disclosure describes DOOR approaches to the related problem of “rescue,” addressing the situation where the home already is “underwater” and on its way to foreclosure.

Staying Above Water—No More Housing Crises

ANZIE'S NU DOOR eliminates the “underwater” homes problem entirely by requiring the investor to pay down the homeowner's mortgage when the loan to value ratio for the home exceeds a target percentage, e.g., 85%. Otherwise ANZIE'S NU DOOR is the same as ANZIE-DOOR. (The added letters “SNU” stand for “sequentially never underwater.”)

When the investor pays down the homeowner's mortgage, the analytic engine underlying ANZIE-DOOR ensures that it is a “market deal.” Two benefits flow to the investor:

(1) The priority block shrinks and the investor's equity expands by the amount of the pay down.

(2) Because the priority block is smaller, insured equity accrues to the homeowner at a slower rate.

These two benefits are equal in risk-adjusted present value to the amount of cash required for the pay down.

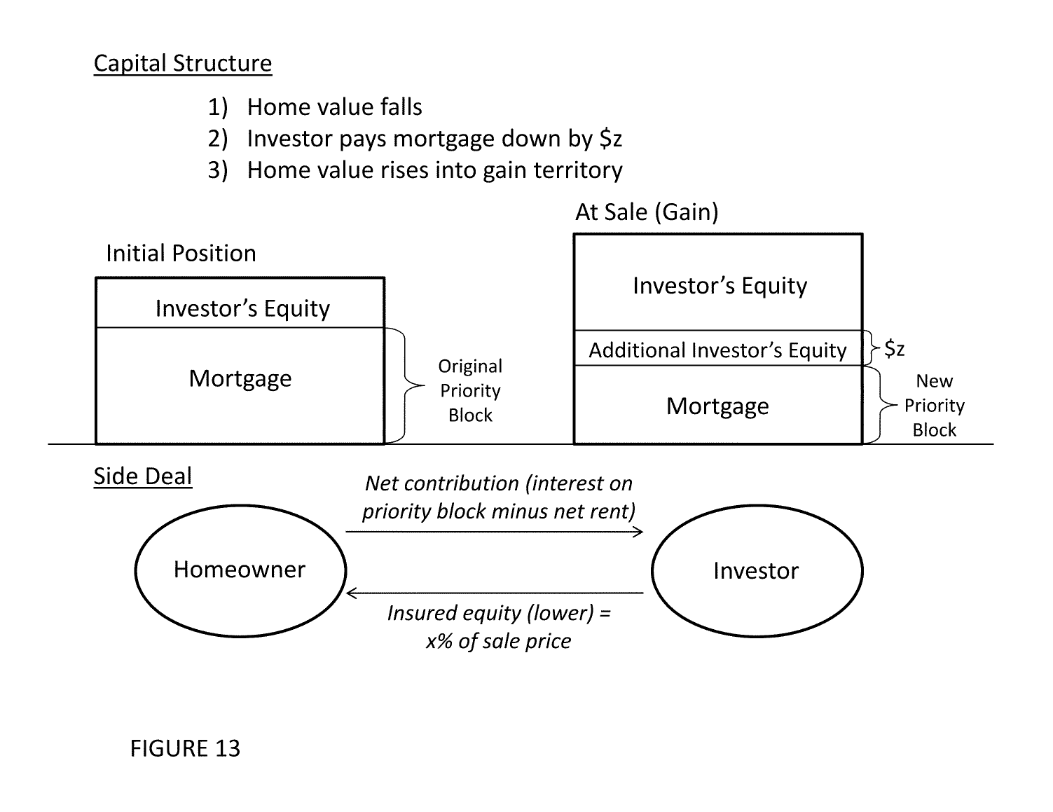

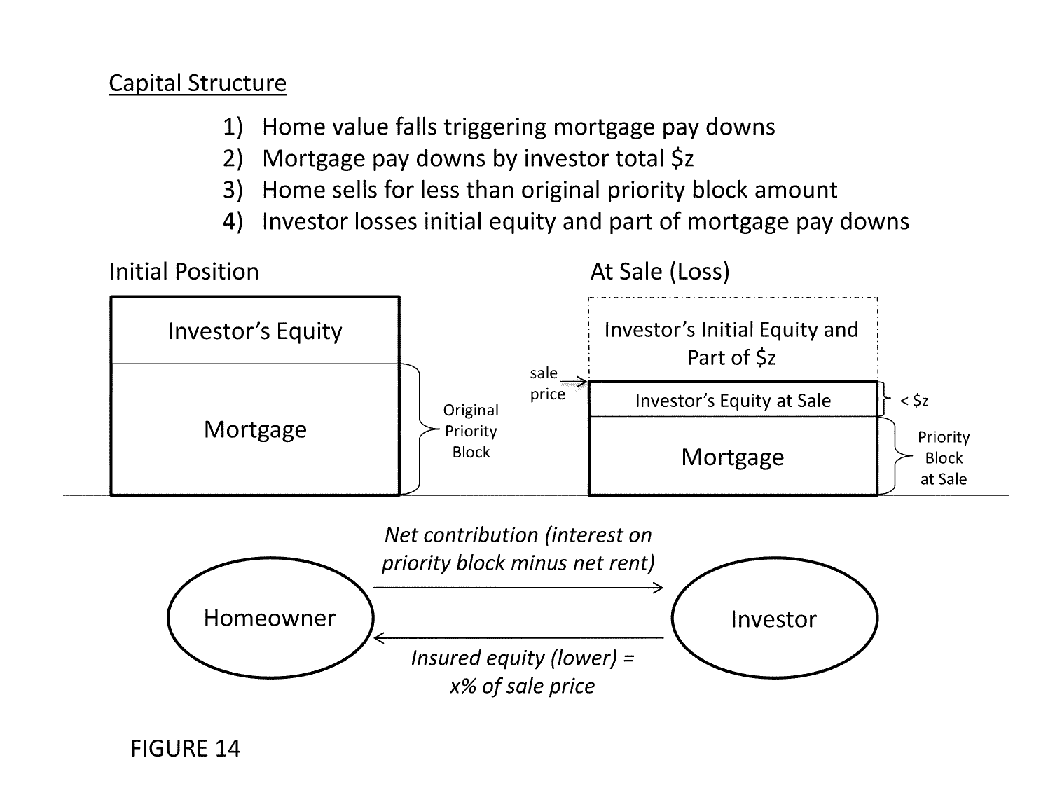

FIG. 13 is a block schematic diagram showing a gain case for an ANZIE'S NU DOOR arrangement according to the invention; and FIG. 14 is a block schematic diagram showing a loss case for an ANZIE'S NU DOOR arrangement according to the invention.

The tax treatment of the pay down event is best considered in the context of the entire arrangement. Normally, pay down of debt by a party other than the taxpayer results in discharge of indebtedness income. Here, however, there is a key difference. The benefit of the pay down does not accrue to the homeowner. Instead it creates an equal amount of additional equity for the investor as payer and also slows down the accrual of insured equity. It makes sense simply to add the amount of the payment to the investor's basis with respect to the conventional part of the deal and to subtract it from the homeowner's basis with respect to the priority block. There should be no other tax consequences.

It is worth noting that even after a pay down, it must be the case that the priority block is large compared to total home value. The mortgage loans are part of the priority block. When the loan-to-value based on those loans is high, only a relatively small amount of equity remains. Even if this equity is all investor equity, i.e., the homeowner's committed equity equals zero, the homeowner provides substantial leverage to the investor, and, consequently, insured equity accrues at a decent clip. It is true that the rate of accrual is lower than in the absence of a pay down feature, but the homeowner receives exact economic compensation in the form of reduced interest costs and a lower loan balance. The cash flow relief from lower mortgage payments may be quite welcome in the adverse economic environments associated with home price declines that induce high loan-to-value situations.

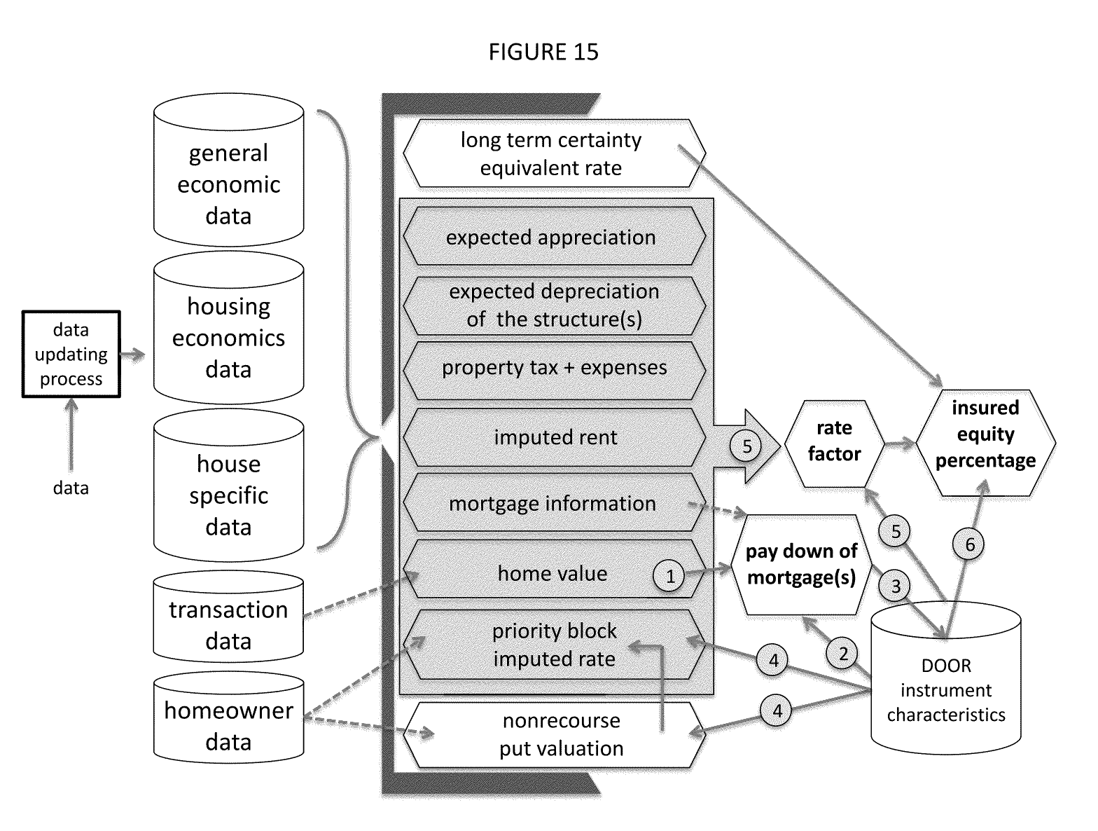

FIG. 15 is a cash flow diagram illustrating the analytic machine that implements ANZIE'S NU DOOR. The analytic machine is similar to the one illustrated in FIG. 5 that implements ANZIE-DOOR except for the addition of a group of steps associated with a mortgage pay down. Because this pay down reduces the size of the priority block and since the size of the priority block affects the computation of other parameters, the machine must compute the mortgage pay down prior to the rest of the computations. FIG. 15 includes a new hexagon labeled “pay down of mortgage(s) on priority block” that represents the pay down computation. To resolve ambiguities inherent in arrow cycles, certain arrows are numbered, indicating the order of information flows. The mortgage pay down computation requires the current home value (step “1”) estimated using information from the data cylinders and the pre-pay-down status of the priority block (step “2”) stored in the DOOR instrument characteristics cylinder. Information about the mortgages themselves (dashed line from the “mortgage information” hexagon) also may be required. Armed with the information from the first two steps, the pay down calculation occurs (“pay down of mortgage(s) on priority block” hexagon). The results are shunted back (step “3”) to the DOOR instrument characteristics cylinder, forming the basis of updated priority block information. The rest of the steps match the steps in ANZIE-DOOR. The update priority block information is input (step “4”) for computing the priority block imputed rate. This rate, along with the other parameters in the grey-shaded box, serves as input (step “5”) to the rate factor calculation. Step “5” also includes inputs from the DOOR instrument characteristics cylinder to the rate factor calculation, and there are inputs (step “6”) from that cylinder into the insured equity percentage computation.

If ANZIE'S NU DOOR is widely used, conventional housing crises that involve foreclosure waves will disappear. There also is a strong positive externality for mortgage lenders. The loan is always protected by an equity cushion. There are no strategic defaults, only “credit defaults” where a drop in income or other adverse circumstances reduces the ability of the homeowner to carry the mortgage.

In the credit default situation, both ANZIE-DOOR and ANZIE'S NU DOOR create a substantially different bargaining environment than at present, resulting in higher joint economic outcomes for the homeowner, mortgagee, and investor. Presently, the mortgagor and mortgagee are at odds after the mortgagor misses some payments. Foreclosure looms, the homeowner is receiving free habitation in the meantime, and the homeowner's incentives to maintain the home have collapsed. The classic picture of the homeowner changing to an unlisted phone number and throwing out mail from the creditor exemplifies the lack of incentives to cooperate. The failure of cooperation along with adverse homeowner incentives to maintain the home leads to real economic losses.

Under ANZIE-DOOR and ANZIE'S NU DOOR, the situation is very different. The homeowner typically has substantial insured equity and benefits from as high a sales price as possible. If the homeowner is liquidity constrained due to difficult economic circumstances, there is a strong incentive to realize these benefits quickly as well as completely. The homeowner's and mortgagee's incentives are aligned, and the homeowner takes phone calls from the mortgagee, if not initiating them. There is a mortgage-related problem that exists under ANZIE-DOOR, but not under ANZIE'S NU DOOR. The maintenance contract combined with the insured equity scheme under ANZIE-DOOR and ANZIE'S NU DOOR creates positive externalities for mortgagees that involve potential joint gains. In many cases, the homeowner has substantial insured equity at a time when foreclosure is imminent. As a result, the homeowner has a strong incentive to maintain and protect the home up to the point where the foreclosure sale closes. Otherwise, the homeowner's insured equity return at closing is lower on a dollar for dollar basis. The net result should be a big reduction in the physical degradation of homes going into the foreclosure process with consequent savings for the mortgagee. Assuming a competitive mortgage market, part or all of these potential savings might accrue to homeowners in the form of lower mortgage costs (interest rates, points, etc.) and possibly also in the form of an ability to borrow more. But there is more to it than a zero sum game. At least part of the savings, and possibly a substantial part, typically represents a joint gain. In many cases, a small expenditure of money on home maintenance at the right time obviates much larger corrective expenditures in the future, i.e., the classic “leaky roof” phenomenon. (Stopping leaks with an inexpensive patch early on often prevents water damage that requires expensive remediation.)

The problem is that the ANZIE-DOOR contract is between the homeowner and the investor, not between the homeowner and mortgagee. The investor does not have an incentive to include terms that buoy up home prices by making maintenance incentives ironclad in the face of foreclosure. The opposite is the case. The investor is better off if the home degrades sharply right before the foreclosure sale. The investor has no remaining equity to lose on the capital structure side, and a lower sale price reduces the investor's insured equity obligation to the homeowner. In short, ANZIE-DOOR terms that lower foreclosure costs create a positive externality for the mortgagee, possibly captured in part or entirely by the homeowner, but tend to harm the investor. If the DOOR instrument investor is the mortgagee, this externality is internalized. If not, then there is an impetus to work out the externality contractually. The third party mortgagee cares about the terms of the DOOR instrument, and might lay down certain requirements as a condition for favorable mortgage terms or as a condition to make a loan at all. Creating and enforcing these contractual terms involves obvious costs that are absent if the externality is internalized. On the other hand, the third party lender's expertise at mortgage financing versus the investor might be so substantial that the result is a more economical mortgage for the homeowner despite the extra costs inherent in addressing the externality.

Under ANZIE'S NU DOOR the externality problem is absent. The investor is obligated to pay down the mortgage to maintain a maximum LTV and therefore wants to avoid the nightmare scenario where maintenance incentives vanish and home value plummets due to the ensuing physical deterioration. On the downward price path, the investor ends up providing 100% mortgage insurance coverage, compensating the mortgagee completely and preemptively for any potential losses. For example, suppose the initial home value is $200,000, the mortgage principal balance is $90,000 and the contract specifies a maximum LTV of 90%. If home value falls to $50,000 the investor has to pay $45,000 to the mortgagee to bring the LTV back down to 90%. But that payment of $45,000 also creates $5,000 of equity for the investor. The net transfer is $40,000, exactly equal to what would have been the loss on the mortgage, i.e., initial principal balance ($90,000) minus home value ($50,000). In short, the investor stands in the mortgagee's shoes with respect to losses caused by suboptimal maintenance. There is no externality.

Is ANZIE'S NU DOOR “Recourse?”

ANZIE'S NU DOOR involves “recourse” aspects. To the extent that the homeowner has funded the priority block via mortgages, the investor is potentially on the hook for any losses. However, the instrument differs from a traditional recourse obligation where the obligation to make good on a loan only arises when there is an event of default or the loan terminates. ANZIE'S NU DOOR is preemptive in the sense that the investor must pay down the mortgage before default becomes a real possibility. This feature means that in some cases there is a pay down even though default would not have occurred.

There is another potential difference between ANZIE'S NU DOOR as it has been specified so far and a traditional recourse obligation. Preemptive pay down under ANZIE'S NU DOOR is tied to any mortgage obligation that the homeowner incurs. However, the homeowner chooses the amount of mortgage financing and may hold part of the priority block as committed equity. If the ANZIE'S NU DOOR instrument does not restrict mortgage borrowing, then the homeowner has an incentive to behave strategically when home values threaten to drop below the amount of priority block “principal.” In that situation, the homeowner wants to “finance out” the committed equity, converting it into a mortgage obligation. This move shifts the risk of loss with respect to what was committed equity to the investor. The entire priority block is financed, and the investor must pay it down if the value of the home falls by enough.

If all homeowners act strategically and mortgage finance costs are low, the priority block loan under ANZIE'S NU DOOR is fully recourse with an additional preemptive pay down feature. There is no possibility of loss for any mortgagee or for the homeowner. As a result, the investor is unwilling to pay imputed interest on the priority block at any rate higher than the riskless rate for loans of similar duration. If only some homeowners act strategically, the situation is messier. The instrument terms must price a probability of strategic behavior, and homeowners who follow through by financing out committed equity when it is optimal to do so receive favorable terms at the expense of homeowners who fail to protect their committed equity by financing out. There is an embedded option that a diligent homeowner wants to exercise when warranted. One way to fix this problem is to make the instrument explicitly recourse in addition to the mortgage pay down feature. Then there is no advantage to be gained by financing out committed equity. The homeowner is guaranteed to get it back in any event and earns an appropriate “market” level return on it in the meantime.

If all homeowners behave strategically, financing out may result in inefficiency if it involves significant transaction costs. Rather than incur these “moral hazard” costs and end up with the same result of an effectively recourse priority block obligation, it makes sense to make the entire block explicitly recourse in the first place, an approach that is described as ANZ'S NU TRIE DOOR below.

It is important to note that the preemptive pay off feature of ANZIE'S NU DOOR adds value even if the instrument also treats the entire priority block as a recourse obligation. The pay off reduces the homeowner's carrying costs at a point in time when the homeowner may not have the liquidity to pay down the loan to achieve that result. It is important to keep in mind the tendency for drops in home value to be correlated with an adverse financial environment for homeowners. A downturn in the local economy tends to impact incomes, job security, and home prices simultaneously. The pay off feature also provides security for the mortgagee. It removes any doubt about whether the investor to the DOOR instrument will perform on the recourse feature at some future point by compensating the mortgagee for the mortgage shortfall when the feature is triggered by sale or otherwise. This added security may translate into lower mortgage rates or the ability of the homeowner to finance a larger portion of the priority block.

Making the priority block obligation recourse is a potentially interesting feature even in the absence of a preemptive pay down obligation. The discussion below explores that possibility along with DOOR variants that are partially recourse. It also discusses the moral hazard issues with respect to ANZIE'S NU DOOR in greater detail.

Recourse and Partially Recourse DOOR Instruments

With the exception of ANZIE'S NU DOOR, all of the variants considered so far have been non-recourse with respect to the priority block. As a result, the imputed interest rate, i_{P}, includes a premium that compensates the homeowner for lending the priority block “principal” to the investor on a non-recourse basis. As discussed above, this premium soars when home value falls below the amount of priority block principal. The result is faster accrual of insured equity in favor of the homeowner. At the same time, the homeowner bears the risk of loss of the priority block principal directly on the portion that is committed equity or covered by a recourse mortgage and has paid extra for a mortgage default option on any part that is financed with non-recourse mortgage loan from a third party. Not all homeowners prefer this particular tradeoff between risk and return. As a result, there is scope for DOOR variants that are partially or totally recourse.

ANZ TRIE DOOR—A Totally Recourse Variant

ANZ TRIE DOOR is the same as ANZIE-DOOR, except that the priority block loan is totally recourse. (The “totally recourse” nature of the priority block leads to the addition of the letters “TR” to the ANZIE-DOOR name. Suggested pronunciation: “Ann's Tree Door.”) This variant is suitable for risk averse homeowners who fear losing part or all of the priority block due to adverse housing market outcomes. The investor is guaranteeing return of any committed equity and effectively provides 100% mortgage insurance for any loans the homeowner takes out secured by the priority block. This guarantee means that i_{P}, the imputed interest rate on priority block “principal,” does not include any premium to compensate the homeowner for lending on a non-recourse basis. As a consequence, insured equity accrues more slowly when house price outcomes are low. Table 10 below shows the ensuing results for the baseline model.

TABLE 10
Example—Baseline Model, Recourse Case (ANZ TRIE DOOR)
End of Year Insured Equity Percentages & Home Value Extremes
net rent = 0% per year; expected appreciation = 7% per year

| | insured equity percentage—distribution over 12,000 runs | | | | | | | | home value | |
|---|---|---|---|---|---|---|---|---|---|---|
| year | mean | std dev | min | 1% | 10% | 90% | 99% | max | min val | max val |
| 1 | 2.75 | 0.00 | 2.75 | 2.75 | 2.75 | 2.75 | 2.75 | 2.75 | 0.73 | 1.47 |
| 2 | 5.26 | 0.21 | 4.58 | 4.84 | 5.00 | 5.54 | 5.84 | 6.40 | 0.69 | 1.71 |
| 3 | 7.56 | 0.45 | 6.22 | 6.66 | 7.02 | 8.14 | 8.77 | 10.07 | 0.61 | 2.10 |
| 4 | 9.66 | 0.70 | 7.62 | 8.25 | 8.81 | 10.58 | 11.52 | 13.67 | 0.66 | 2.41 |
| 5 | 11.59 | 0.96 | 8.73 | 9.64 | 10.42 | 12.85 | 14.15 | 17.23 | 0.68 | 2.91 |
| 6 | 13.36 | 1.23 | 9.75 | 10.89 | 11.86 | 14.99 | 16.58 | 20.09 | 0.63 | 3.47 |
| 7 | 14.99 | 1.50 | 10.64 | 11.96 | 13.16 | 16.95 | 18.98 | 22.69 | 0.65 | 3.84 |
| 8 | 16.48 | 1.76 | 11.32 | 12.95 | 14.34 | 18.77 | 21.27 | 25.30 | 0.61 | 4.38 |
| 9 | 17.86 | 2.01 | 11.97 | 13.85 | 15.41 | 20.47 | 23.38 | 28.55 | 0.61 | 5.12 |
| 10 | 19.13 | 2.26 | 12.57 | 14.66 | 16.39 | 22.06 | 25.33 | 31.74 | 0.68 | 4.77 |
| 11 | 20.31 | 2.49 | 13.12 | 15.38 | 17.31 | 23.57 | 27.22 | 34.40 | 0.60 | 5.35 |
| 12 | 21.39 | 2.71 | 13.68 | 16.06 | 18.13 | 24.92 | 28.95 | 36.56 | 0.62 | 6.03 |
| 13 | 22.39 | 2.92 | 14.22 | 16.67 | 18.88 | 26.20 | 30.61 | 38.40 | 0.71 | 6.43 |
| 14 | 23.32 | 3.12 | 14.70 | 17.24 | 19.57 | 27.38 | 32.04 | 40.32 | 0.74 | 7.70 |
| 15 | 24.18 | 3.32 | 15.17 | 17.78 | 20.19 | 28.47 | 33.38 | 41.96 | 0.72 | 8.67 |
| 16 | 24.97 | 3.50 | 15.60 | 18.28 | 20.76 | 29.52 | 34.63 | 43.70 | 0.76 | 9.56 |
| 17 | 25.71 | 3.67 | 15.91 | 18.70 | 21.30 | 30.49 | 35.69 | 45.29 | 0.83 | 11.72 |
| 18 | 26.40 | 3.84 | 16.15 | 19.10 | 21.79 | 31.39 | 36.76 | 46.91 | 0.79 | 11.47 |
| 19 | 27.03 | 3.99 | 16.36 | 19.46 | 22.24 | 32.23 | 37.93 | 48.57 | 0.77 | 11.85 |
| 20 | 27.62 | 4.14 | 16.57 | 19.79 | 22.65 | 33.01 | 38.94 | 50.09 | 0.87 | 14.24 |
| 21 | 28.17 | 4.28 | 16.76 | 20.10 | 23.02 | 33.73 | 39.84 | 51.48 | 0.87 | 15.12 |
| 22 | 28.68 | 4.41 | 16.95 | 20.39 | 23.37 | 34.43 | 40.74 | 53.01 | 0.88 | 17.33 |
| 23 | 29.16 | 4.53 | 17.11 | 20.67 | 23.70 | 35.06 | 41.64 | 54.48 | 0.94 | 19.88 |
| 24 | 29.60 | 4.65 | 17.26 | 20.91 | 24.02 | 35.68 | 42.52 | 55.73 | 0.91 | 24.01 |
| 25 | 30.01 | 4.76 | 17.42 | 21.13 | 24.33 | 36.23 | 43.26 | 57.07 | 0.91 | 27.49 |
| 26 | 30.39 | 4.86 | 17.58 | 21.36 | 24.59 | 36.73 | 44.01 | 58.36 | 0.81 | 31.27 |
| 27 | 30.75 | 4.96 | 17.73 | 21.57 | 24.82 | 37.26 | 44.76 | 59.77 | 0.84 | 37.38 |
| 28 | 31.09 | 5.05 | 17.87 | 21.76 | 25.07 | 37.75 | 45.42 | 61.07 | 0.93 | 40.68 |
| 29 | 31.40 | 5.14 | 18.01 | 21.89 | 25.27 | 38.15 | 45.98 | 62.22 | 1.03 | 43.26 |
| 30 | 31.69 | 5.22 | 18.14 | 22.04 | 25.47 | 38.56 | 46.51 | 63.23 | 1.00 | 43.25 |

Comparing these results with Table 7 above, it is evident that non-recourse financing results in higher insured equity percentages along price paths that include very low outcomes. At 10 years, the maximum insured equity percentage across 12,000 price paths is about 5 points higher in the non-recourse case, and at 30 years the gap is about 3 points. The 99th percentile insured equity outcomes are a tiny bit higher, but there is little or no difference for lower percentiles or the mean outcome. The pattern of results depends heavily on the assumed value for home price volatility. Higher volatilities result in larger effects at all percentiles. For instance, a simulation not reported here using volatility equal to 11% instead of 9% results in an increase in the insured equity percentage by around one percentage point for the 99th percentile outcomes.

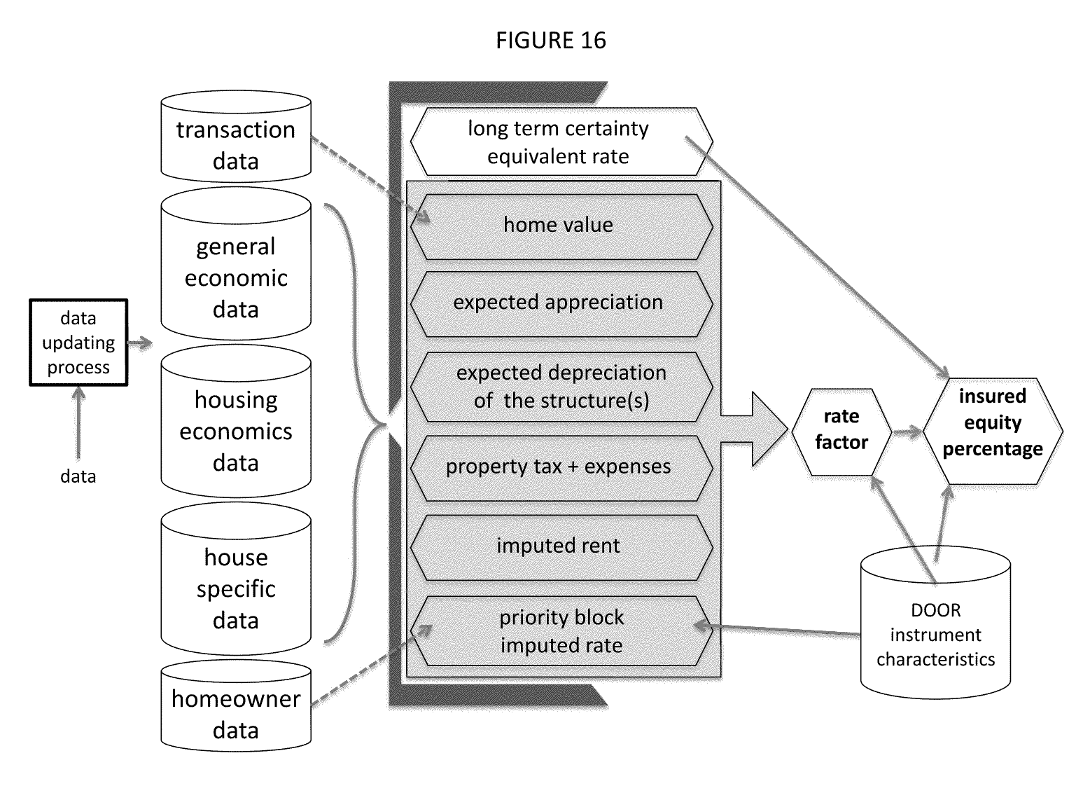

FIG. 16 is a flow chart diagram illustrating the analytic machine that implements ANZ TRIE DOOR. The analytic machine is identical to the one for ANZIE-DOOR illustrated in FIG. 5 except that the priority block imputed rate is computed differently. Under ANZ TRIE DOOR, there is no step computing quantities related to the non-recourse put, and the associated hexagon, evident in FIG. 5, does not appear in FIG. 16. The priority block loan is recourse under ANZ TRIE DOOR. As a result, the priority block imputed rate does not include a premium based on the nonrecourse nature of the loan, and it is unnecessary to value the associated put.

ANZ TRIE DOOR is a very powerful option for homeowners who are not in a position to take risk. Assuming a solvent investor, the homeowner cannot lose money. Committed equity in the form of a down payment or mortgage amortization is completely protected. Any mortgage lending is completely insured by the investor. This feature can create considerable “credit enhancement” because the investor's credit position stands behind the borrowing. The result should be very favorable rates on any mortgage.

The recourse arrangement must specify whether the payment from the investor is paid to the homeowner or to the mortgagee in the event the home ends up being worth less than the priority block principal amount. Suppose, for example, that there is $200,000 of priority block principal consisting of $20,000 of committed equity and an $180,000 mortgage balance. If the home sells for $160,000, does the investor: (i) pay the homeowner $40,000; or (ii) pay the mortgagee $20,000 and the homeowner $20,000? In the latter case, there is explicit mortgage insurance. In the former case, the homeowner may walk away with $20,000 leaving the mortgagee with a $20,000 loss. It seems that the explicit mortgage insurance version is the more useful approach of the two. In an insured equity arrangement, the homeowner already enjoys significant protection in the low sale price situation. Typically, there is no need to provide a larger payoff. As a result, it is presumed in the discussion that the contractual arrangement is the mortgage insurance version.

The powerful credit enhancement benefits for the homeowner stem from the commitment of the investor to stand behind the priority block 100%. There are less extreme degrees of commitment that may create much of the value, but also may be more attractive to investors due to limitations on liability. Some examples of “partially recourse” arrangements are described below.

Before doing so, it is worth emphasizing that a totally recourse variant is a perfect complement to the sequential preemptive pay down feature introduced in the discussion of ANZIE'S NU DOOR. That is, an interesting variant is “ANZ'S NU TRIE DOOR.” The investor guarantees any committed equity and preemptively pays down any mortgages to keep the priority block LTV from exceeding some maximum. This variant eliminates completely the moral hazard problem with ANZIE'S NU DOOR. There is no reason for the homeowner to shift committed equity to mortgage borrowing to avoid losing the committed equity. The investor already has guaranteed the committed equity.

Partially Recourse Variants

There are many possibilities for creating useful “partially recourse” variants. One approach is for the priority block loan to be recourse, but only up to a certain dollar amount. For example, consider the case where the priority block is $200,000. The investor might commit to recourse status only with respect to the first $20,000 of loss. If the home ended up selling for $180,000 or less, the investor pays the homeowner or the mortgagee for $20,000 of the loss. Under this arrangement, the homeowner could accumulate up to $20,000 of committed equity with no risk of loss. At the same time, the investor's liability is limited, and the homeowner and investor benefit jointly from the homeowner's default option on any mortgage borrowing less than $180,000 in amount.

This approach is sensible if the price for the default option appears reasonable to the parties.

In deciding on the form of the arrangement, it is useful to consider the homeowner and investor as joint venturers vis-à-vis the mortgagee. If the investor is willing to provide the default option for a lower price than the mortgagee, the parties can agree on a fully recourse DOOR instrument. The homeowner and investor can split the “benefits” of doing so. In some cases, the investor may have more information than the mortgagee about the homeowner or the home that enables the investor to offer the lower price for providing the default option.

Another possibility is for the investor to provide explicit mortgage insurance but not any guarantee with respect to committed equity. There are many versions of this arrangement. In a comprehensive mortgage insurance scheme, the investor stands 100% behind any and all mortgages. The pricing could be dynamic, based on the analytic machine that underlies neutral DOOR instruments. At the beginning of each formal adjustment period, the market value of providing mortgage insurance for the ensuing period is a credit to the investor in the net contribution computation, slowing down the accrual of insured equity or other balancing residuals in favor of the homeowner. An interim adjustment is made whenever mortgage borrowing changes other than through amortization schedules, e.g., when the homeowner borrows more or prepays part or all of one of the mortgages present at the beginning of the period. A comprehensive mortgage insurance arrangement has a nice balancing feature from the investor's perspective. If home value falls to or below the priority block principal amount, insured equity or other residual accounts accrue sharply in favor of the homeowner. The mortgage insurance “credit” in favor of the investor mitigates this tendency, moderating the rate of accrual. As is the case in general for neutral DOOR instruments, the investor receives market-based compensation for the mortgage insurance obligations incurred.

This version with a comprehensive mortgage insurance feature amounts to ANZIE'S NU DOOR without a preemptive pay off feature. The insurance covers default by the homeowner at sale, but there is no obligation to pay down any mortgage prior to sale. The adjustment mechanism that “prices” the insurance benefit, adjusts as mortgage balances shift, and rationalizes ANZIE'S NU DOOR. Any increase in borrowing results in additional “mortgage insurance” compensation for the investor. However, the adjustment process does not eliminate the potential moral hazard issues. There is an asymmetric information problem. If a homeowner knows that a move is likely in the near future and the current value of the home is not very far above the principal amount of the priority block, then the homeowner has an incentive to cash out any committed equity by increasing mortgage borrowing. As indicated by the results in Table 5, the short expected duration of homeownership should translate into a heavier mortgage insurance “premium” for the investor. However, the investor may have no reason to suspect, other than the cash out event itself, that a short duration is likely. These situations may require a contractual response such as limiting or delaying the insurance provided for the cashed-out portion. As discussed above, ANZ'S NU TRIE DOOR combines a totally recourse instrument with preemptive payoff to provide a complete solution, eliminating moral hazard and avoiding any associated contractual or negotiation costs.

Another way to avoid this moral hazard problem is by eliminating the link between the recourse obligation and the mixture of mortgage versus committed equity in the priority block. For example, suppose that there is $200,000 of priority block principal. The investor might commit to “insuring” $60,000 of loss but only to the extent that home value drops below $160,000. Sales prices below $160,000 trigger payments to the homeowner or a mortgagee, depending on which party is financing the portion of the block less than $160,000. The investor's liability depends only on the sale price, not on the mix between mortgage and committed equity. There is no moral hazard problem due to the homeowner's ability to alter the mixture.

There are many other possibilities. For example, the contract might call for the investor to offer mortgage insurance, with the premiums creditable to the investor in the net contribution computation, whenever the homeowner initiates a new loan. Because the investor has a choice with respect to the offer price, the investor can address potential moral hazard situations by pricing the offer high when the circumstances dictate it is wise to do so. This type of arrangement might be particularly attractive if the investor is itself a sophisticated mortgage lender or insurer.

COZIE-DOOR—Cashing Out or Retiring in Peace

Equity Draw Downs and Income Streams

Homeowners sometimes wish to cash out equity from their homes. Cashing out can be a rational move in a life cycle setting. A classic example is a retired person who needs income and is living in a cherished mortgage-free home that has substantial value. The homeowner wants to continue living in the home but would like to take money out to buy an annuity or otherwise generate a cash return. Various market devices such as reverse-amortization mortgages, as well as sale-leasebacks, address this situation. The problem with many of these approaches is that they involve interest or rent payments, i.e., cash flow going in the wrong direction. In addition, with devices such as reverse mortgages there is a strong element of uncertainty. If the homeowner lives a long time and house prices are stagnant or decline, the mortgage can eat up all of the home equity. Typically, reverse mortgage contracts require the homeowner to pay a premium up front to compensate the mortgagee against this possibility of a shortfall. The reverse mortgage also leaves the homeowner's equity in the riskiest position.

For retired homeowners, the cash out strategy works best if it does not involve interest or other payments, is as predictable as possible with respect to future outcomes, and requires minimal attention or management. The flexibility of DOOR creates many possibilities to satisfy this agenda. This portion of the disclosure focuses on a group of variants under the acronym “COZIE-DOOR” where the “CO” stands for “cash out.” These variants include an insured or committed equity component, the Z capital structure, and neutrality. They differ from ANZIE-DOOR in the sense that the positions of the homeowner and investor are reversed. Before explicating COZIE-DOOR, it is worth discussing ANZIE-DOOR type approaches and the associated problems that might motivate the reversal.

A very simple approach using ANZIE-DOOR is to compute the maximum possible cash out that is neutral at origination and then freeze the deal, i.e., no periodic adjustments. For example, suppose a retired individual owns a home worth $600,000 free of any mortgage debt. There is some amount, say $250,000, that an investor would advance under ANZIE-DOOR such that at origination there is no flow of insured equity in either direction. The priority block leverage exactly offsets the net rent. With no periodic adjustments, the homeowner takes a quarter million dollars of equity out and lives rent free indefinitely. There are no mortgage interest payments, and the homeowner's remaining $350,000 has priority over the investor's $250,000 of equity, very much like a first mortgage. The homeowner does not have to take any steps to manage any aspect of the home finance package and could simply live rent free for the remainder of his or her life span with the added element of the income from a $250,000 annuity or other investment.

This outcome is very attractive, but there are some hidden problems. Neutrality exists only at origination. Suppose that the home value falls afterwards. Then the homeowner has an incentive to pay off the instrument and refinance with a new one. This new instrument should permit the homeowner to take even more equity out than before. Suppose in the previous example, the home value drops from $600,000 to $350,000. The drop wipes out the investor's equity. The homeowner is engaging in a strategic refinance. If that is barred by the terms of the instruments, the homeowner can accomplish the same result via a strategic sale. A sale combined with purchase of an equivalent home means disruption and loss of the surplus value of staying in the cherished home. For some homeowners, this consumer surplus is so high that they would not engage in a strategic sale even though it has powerful financial benefits. Nonetheless, other homeowners would behave strategically in this situation. At a minimum, certain options, such as moving into a retirement community with potential assisted living, become more attractive if there is a substantial added financial inducement in the form of gains from a strategic sale.

The situation is the same as exists for conventional equity instruments. The investor's position has zero intrinsic value, but the investor has a potentially very valuable call option: the right to all future appreciation on the home. Having wiped out the investor, the homeowner can take more equity out, perhaps $150,000 of the remaining $350,000, on similar terms to the first deal.

If this type of strategic behavior actually occurs frequently, then investors will demand a “moral hazard” premium up front. To realize the full financial benefit of the deal, homeowners must behave strategically and spend energy doing so. In the case where strategic refinances are contractually barred, acting strategically requires moving out of the cherished homestead.

If the home appreciates, the opposite situation prevails. The homeowner is not able to take out the amount of equity equal to the investor's current share in a new deal involving a home at the appreciated price. Thus, if the homeowner sells and moves to an equivalent home, the financial deal is much worse. Suppose, for example, that the $600,000 home appreciates to $1,200,000. If the homeowner sells and extracts the $350,000 of committed equity and then attempts to buy an equivalent ($1,200,000) home, the homeowner must put in more equity or take out a very large loan. If we double the original deal, the DOOR instrument finances only $500,000 of a $1,200,000 home, leaving the homeowner short by $350,000 of the $700,000 required to move in.

Thus, this simple approach is problematic. Under an ANZIE-DOOR type of instrument, it is desirable to adjust frequently enough to make the embedded options associated with the instrument of negligible value. But with frequent adjustments, starting out right on the edge of insured equity going in either direction potentially creates problems similar to reverse amortization mortgages. If the home appreciates in value, then the investor accumulates insured equity. If the appreciation persists, the investor's insured equity stake can end up being worth more than the homeowner's committed equity!

One possible answer is to stick with ANZIE-DOOR but to change the terms to achieve results consistent with the homeowner goals of:

(1) Enhancing cash returns.

(2) Ensuring stability.

For instance, the amount withdrawn might be less than the amount that is necessary to zero out initial insured equity build up. This approach creates a “cushion” that tends to prevent the situation where there is negative insured equity. If the value of the home falls and insured equity builds up very quickly, the instrument might cash out insured equity in excess of a certain percentage. On the other hand, if the home appreciated in value, the instrument might build up committed equity rather than insured equity. The result is greater “priority block” leverage and a tendency to maintain a positive flow of insured equity to the homeowner.

There are several problems with this approach. First, the homeowner's returns are uncertain, contrary to the goal of stability. Second, part of the economic value of the home is being devoted to creating a cushion consisting of insured equity. Maintaining that cushion is a cost rather than a benefit given the objective of cashing out. The cushion is necessary because ANZIE-DOOR is not very stable with respect to the cash flow elements that matter to the homeowner.

COZIE-DOOR Approaches

A superior alternative in many situations is to reverse the capital structure and equity accrual positions of the homeowner and the investor that exist under ANZIE-DOOR. The result is various versions of COZIE-DOOR. It is useful to consider at least two dimensions in categorizing these versions. First, there are different “cash out” schemes. Two of these schemes are considered below: periodic payments and a single lump sum distribution, i.e., “annuity versions” and “lump sum versions” respectively. The other dimension involves the choice of residual account that balances the net contributions of the parties. Under ANZIE-DOOR, insured equity is the residual account. The corresponding “insured-equity” versions of COZIE-DOOR precisely reverse ANZIE-DOOR by accruing insured equity in favor of the investor instead of the homeowner. However, in some COZIE-DOOR applications, it is better to balance using a different residual account. This disclosure considers “committed-equity” versions of COZIE-DOOR where committed equity rather than insured equity is the residual account.

There is one aspect of COZIE-DOOR that does not involve reversing the positions of the homeowner and investor under ANZIE-DOOR. Under both COZIE-DOOR and ANZIE-DOOR, the homeowner occupies the home and benefits fully from the imputed rent. Some versions of COZIE-DOOR considered below share another similarity with ANZIE-DOOR: The homeowner is responsible for depreciation and property taxes. Under these COZIE-DOOR versions, net rent as well as imputed rent accrues to the homeowner, just as they do under ANZIE-DOOR.

Annuity Versions

One cash out scheme under COZIE-DOOR requires the investor to pay fixed or scheduled payments to the homeowner indefinitely, i.e., an “annuity.” In exchange, insured or committed equity builds up in favor of the investor under the same kind of periodic adjustment mechanism that underlies ANZIE-DOOR. Computation of the rate factor is somewhat different. The numerator on the right hand side of equation (4) does not include the net rent term. Net rent is flowing to the homeowner, not to the investor, and should not be subtracted to compute the investor's net contribution. That net contribution is equal to the cash payments, and the numerator consists of the cash payment rate for the applicable period as a proportion of home value.

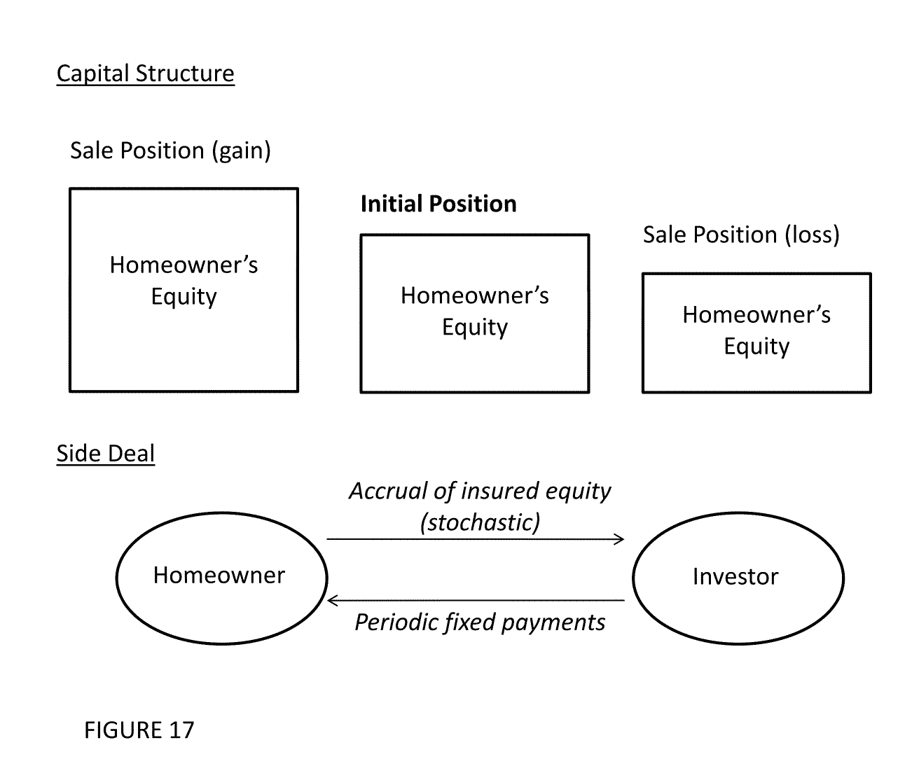

FIG. 17 is a block schematic diagram showing an insured equity annuity version of a COZIE-DOOR arrangement according to the invention.

Although there is no reason to exclude the committed-equity annuity version of COZIE-DOOR, for the sake of brevity only the insured-equity version is considered in this introduction to COZIE-DOOR. Of course, certain investors and homeowners may prefer the committed-equity version in the annuity cash-out situation. The committed-equity version is particularly useful in some rescue situations, and it is discussed as part of that topic below.

As is the case under ANZIE-DOOR, the rate of accrual of insured equity under COZIE-DOOR is stochastic and subject to wide variation based on the many different market conditions possible in the future. This risk affects the investor's return. The numerical example in Table 7 indicates what investor returns under insured-equity versions of COZIE-DOOR might look like in the baseline model scenario. The example corresponds precisely to COZIE-DOOR if one reverses the position of the homeowner and the investor. The baseline model assumes that net rent is zero in computing insured equity. That assumption is “true” for COZIE-DOOR because net rent is not subtracted in the rate factor computation. The picture is bright for the investor in the baseline model scenario since the investor emerges with a substantial insured equity percentage even for price path outcomes where that percentage increases at an unusually slow rate.

Although the homeowner is on the other side of this arrangement, in exchange for surrendering insured equity the homeowner realizes a low risk predictable return that stretches indefinitely into the future. The return may be quite large relative to home value at origination. For example, it might equal several percentage points of home value at origination per year, with an inflation adjustment if desired.

Unlike a reverse-amortization mortgage, there is no way that the accrual of insured equity can become so high that the instrument must terminate. The insured equity percentage cannot exceed 100. See equation (5) above.

In addition, the homeowner remains the residual claimant. If home prices surge, the homeowner realizes a substantial part of the gains, making it easier to make a future move, if desired.

This version of COZIE-DOOR is particularly suitable for a person who owns a home with no debt and wishes to continue living in the home but needs cash flow. In this situation, it is possible to protect the investor's returns by barring mortgage borrowing secured by the home. Under that arrangement, the investor has assurance that the homeowner has the means to translate the relevant insured equity percentage into the corresponding amount of actual home value at sale.

This version of COZIE-DOOR requires that the instrument terminate at death of the homeowner, as well as at sale. Otherwise, a family is able to continue the payments from the investor indefinitely without ever paying up on insured equity by continually passing the home to the next generation via gift or inheritance. Termination at death has a more general application. It is useful whenever contract terms turn on homeowner traits such as credit worthiness. In such cases, the investor wants to have at least the option of terminating the instrument rather than continuing to stand by it after the home has passed to a new owner by some means other than sale.

There are potential maintenance issues. If the insured equity percentage builds up to high levels, the consequences of failing to maintain the home have far less than a dollar-for-dollar impact on the homeowner. One way to address this situation is to create a maintenance obligation similar to the one under ANZIE-DOOR, except that the contract obligates the homeowner to make up any shortfall at the time of sale from the homeowner's sale proceeds rather than from the insured equity account. That account belongs to the investor.

Other than a possible maintenance obligation, this version of COZIE-DOOR requires little or no active management on the part of the homeowner. The homeowner does not have to make any financial decisions but simply “clips coupons.” It really is “cozy.”

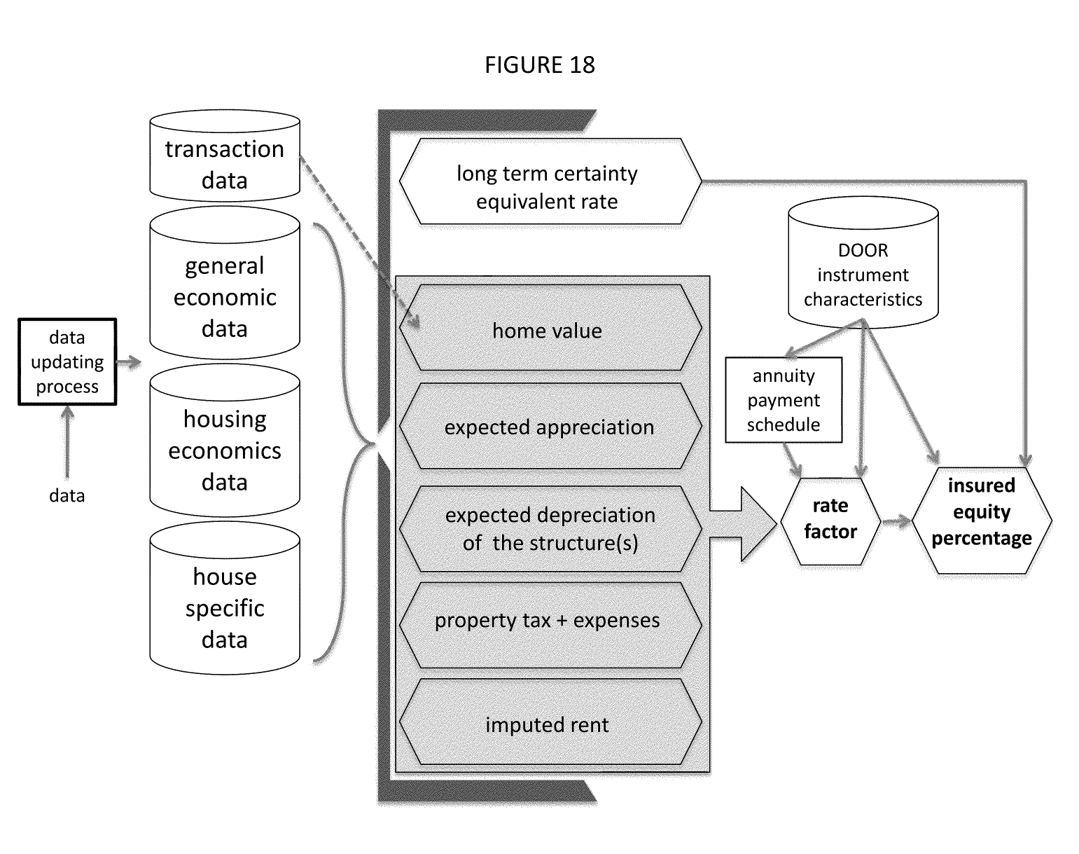

FIG. 18 is a flow chart diagram illustrating the analytic machine that implements the insured equity annuity version of COZIE-DOOR. This version of COZIE-DOOR involves an insured equity computation. The computation is similar in some ways to the one illustrated in FIG. 5 for the analytic machine underlying ANZIE-DOOR, but there are important differences. The investor's net contribution determines the rate factor under COZIE-DOOR versus the homeowner's under ANZIE-DOOR. Since the investor is not providing priority block funds that leverage the homeowner's stake in the home, the priority block imputed rate does not enter into the rate factor computation. The four key elements that do are: net rent, expected appreciation, home value and the annuity payments from the investor to the homeowner. The numerator of the rate factor is the annuity payments over the next period divided by home value and the denominator is the rate at which net rent accrues plus the expected appreciation rate. Turning to FIG. 18, five computed parameters comprise the grey-shaded block that is input into the rate factor computation. Three of these (imputed rent, expected depreciation and property tax) are elements of net rent. In order to emphasize the role of annuity payments for this COZIE-DOOR version, two sets of arrow flows go from the DOOR instrument characteristics cylinder to the rate factor hexagon. One set indicates that DOOR contractual provisions residing in the DOOR instrument characteristics cylinder specify the annuity payments schedule (the non-bold box labeled “annuity payment schedule” in the arrow flow) that is input to the rate factor computation. The other arrow flow stands for the remaining inputs from the DOOR instrument characteristics cylinder including specification of the algorithm to compute the rate factor. The rest of the figure follows FIG. 5 for ANZIE-DOOR exactly. For instance, the updated long-term certainty equivalent rate is a necessary input into the insured equity percentage computation.

Lump Sum Versions

The homeowner may desire a lump sum withdrawal of home equity rather than a periodic cash payment. It is easy to accommodate this desire under COZIE-DOOR. The investor advances a sum of money and then takes a priority block position in the home equal to the amount of the advance. The homeowner is the residual claimant. In exchange for advancing the money, the investor accrues insured equity or committed equity. (As is the case for the annuity version, the rate factor calculation is different. There is no net rent term in the numerator of the right hand side of equation (4) because the homeowner receives the net rent.)

These two lump sum versions, one involving accrual of insured equity and the other committed equity, are similar in many respects to the annuity version discussed above. The homeowner is receiving a riskless up-front payment in exchange for the stochastic, and potentially very uncertain, accrual of insured or committed equity. As residual claimant, the homeowner is at least partially protected from an unexpectedly high rate of appreciation.

There are differences between the two versions, and one difference is particularly important: If the investor accrues insured equity, there is a potential problem that is similar to the danger of excess “reverse-amortization.” Although the insured equity percentage can never exceed 100, the value of the investor's insured equity position will exceed the homeowner's equity in the home after a period of time along some price paths that involve low appreciation or actual drops in value. This possibility requires adaptations such as one or more of the following: (i) limiting the applicability of the insured-equity lump sum version to homeowners likely to be solvent in case the insured equity account exceeds the homeowner's equity at sale; (ii) requiring additional security from the homeowner adequate to ensure performance; or (iii) adding contractual terms that protect the insured equity build up, e.g., requiring cash infusions from the homeowner or terminating the instrument and requiring a pay out of insured equity if the homeowner's equity falls below the level required to cover the insured equity. These adaptations are either “un-cozy” because the homeowner faces major future financial contingencies, such as required cash infusions, or conflict with the goal of “cashing out” by requiring posting of additional security or both.

Fortunately, there is no need to face the problems associated with an insured equity approach. Accruing committed equity avoids all of the problems and results in a coherent approach that is very attractive to many homeowner-investor pairs. The investor has an increasing position with preferred status in the capital structure. If there is no mortgage, the investor owns all of the “safe money” part of home value. At the same time, the homeowner is the residual claimant and thus has protection in case there is a runaway market to the upside. In that situation, it still is possible to move to an equivalent home if desired by using the large upside equity build up to buy the new home. If prices fall or don't appreciate very much, it is possible that the homeowner's equity is wiped out and that the home is worth less than the priority block that includes the investor's increasing stake in the form of committed equity.

But this is not a problem. As indicated by Table 5, the result is that committed equity accrues very quickly as a percentage of home value to compensate the investor for the risk of providing a non-recourse loan to the homeowner when the homeowner has little or no equity. The investor faces risk of loss, but the analytic machine is providing exactly appropriate compensation. It also still is the case that the investor holds all the “safe” money with respect to the home. The homeowner's financial stake in the home takes the form of an out of the money call along with an obligation to pay “interest” on the priority block. Of course, the homeowner continues to enjoy the imputed rental value of living in the home.

The homeowner's main goal was to cash out, and that goal has been accomplished: A big chunk of the homeowner's original home equity is no longer invested in the home. Finally, accruing committed equity rather than insured equity restores “coziness.” The homeowner does not need to do much more than enjoy the returns from investing the lump sum and living in the home.

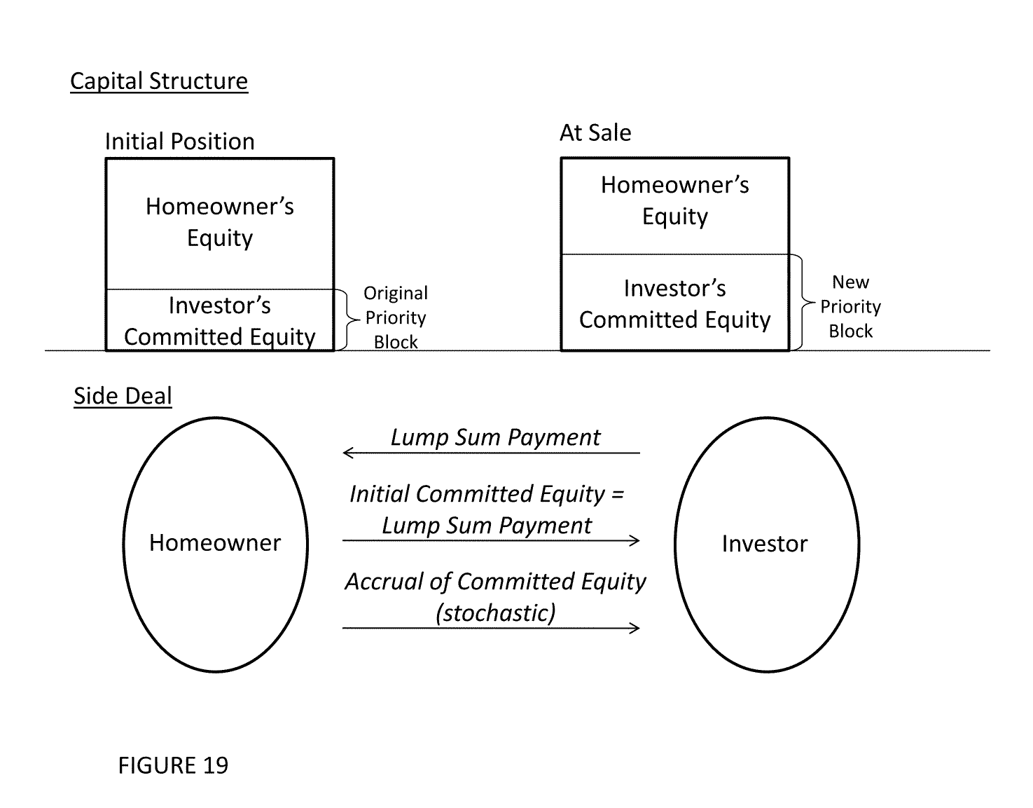

FIG. 19 is a block schematic diagram showing a committed equity lump sum version of a COZIE-DOOR arrangement according to the invention.

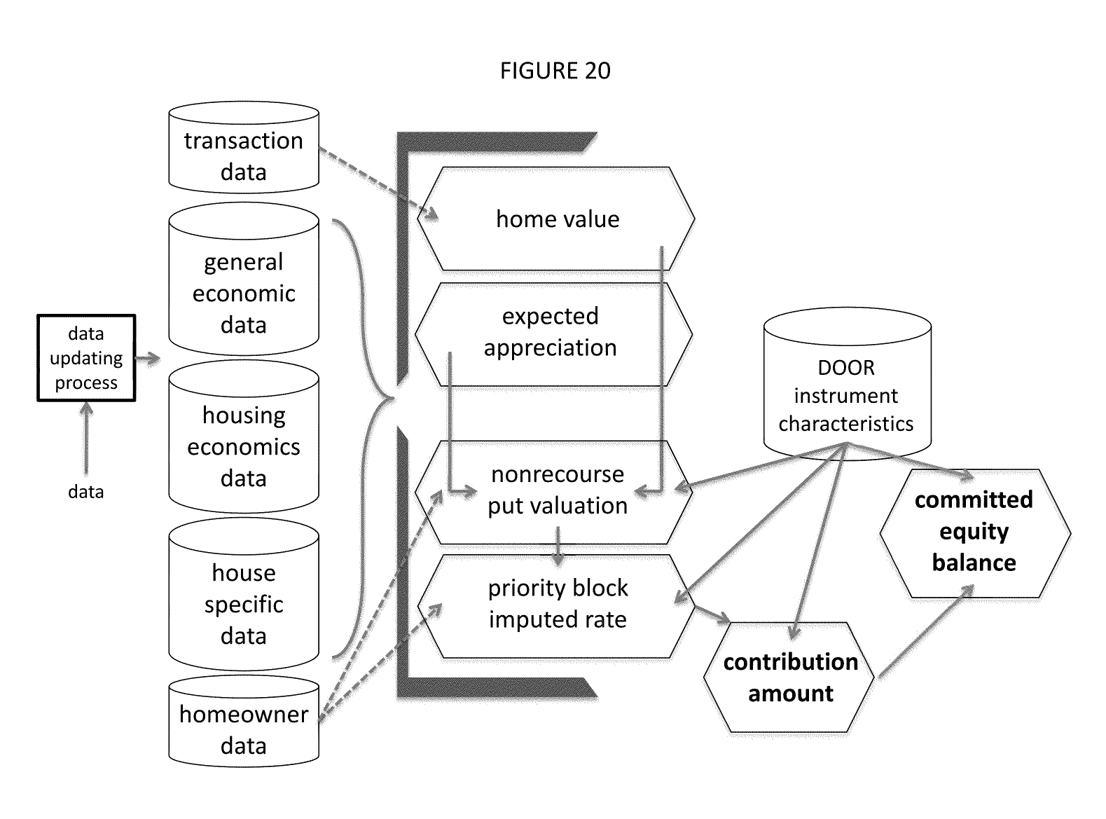

FIG. 20 is a flow chart diagram illustrating the analytic machine that implements the committed equity lump sum version of COZIE-DOOR. The output for this machine is an updated committed equity balance in favor of the investor, represented by the “committed equity balance” hexagon on the right hand side of the figure. Computation of the new balance requires the old balance, an increment that compensates the investor for lending the priority block, and instructions on how to compute the new balance. The old balance and the relevant instructions originate from the DOOR instrument characteristics cylinder as indicated by the arrow from that cylinder to the computation hexagon for the committed equity balance. The compensating increment is computed in the “contribution amount” hexagon. The inputs for this computation are the priority block imputed rate originating from the priority block imputed rate computation hexagon and information on priority block size from the DOOR instrument characteristics cylinder. The priority block imputed rate computation requires information about the nonrecourse put, home value and the expected appreciation rate for the home. These three information items are computed from the data, and in the case of the nonrecourse put, information on the priority block size from the DOOR instrument characteristics cylinder.

Lump Sum Plus Annuity Version and Other Possible Features

It is simple to combine versions, resulting in an approach that yields a lump sum payment plus an annuity type of payment. The investor accrues insured equity, committed equity, or some mix between the two each period based on the payment to the homeowner for that period plus that period's credit for imputed interest on the priority block. The numerator in the rate factor calculation for this combined version would include both these elements, but net rent would not be subtracted because net rent accrues to the homeowner. Cf. equation (4).

It is easy to add other features. For instance, the instrument might require the investor to pay whatever property taxes are due. These payments go into the rate factor calculation and result in faster accrual of insured or committed equity in favor of the investor. This arrangement makes the situation even more “cozy” for the homeowner. There is no need to worry about semi-annual or annual property tax obligations.

COZIE-DOOR has the same flexibility as DOOR instruments in general. For instance, it is possible to tailor the payment scheme under the annuity version to taste. There might be a maximum and minimum monthly payment. The homeowner receives the minimum automatically but could request an amount up to the maximum. A related scheme accumulates “unused” withdrawal capacity equal to the shortfall of withdrawals compared to the maximum with interest in a “savings account.” In this scheme the homeowner is able to draw from this account at any time. These arrangements and many others are easy to accommodate. It also is possible to allow the homeowner to change the particular arrangement that applies, selecting some new arrangement from a menu at any time. The dynamic mechanism under DOOR automatically creates the relevant offsetting adjustments for whatever changes the parties implement.

The Investor's Position

The investor's position under COZIE-DOOR is quite different than under ANZIE-DOOR, and the difference goes beyond a simple reversal of positions with the homeowner. The elements that have a simple reversal (“symmetric”) flavor include:

(1) The homeowner instead of the investor is the residual claimant, facing both losses and gains at the margin as the home price fluctuates.

(2) In the lump sum versions, the investor rather than the homeowner has a committed equity position with priority over the residual claimant to sale proceeds.

There are elements that are not symmetric after reversal. There is no reversal with respect to maintenance obligations. The homeowner maintains the home under all COZIE-DOOR versions, as well as under ANZIE-DOOR. The incentive structure differs from ANZIE-DOOR and the nature of the difference depends on whether one is comparing ANZIE-DOOR to insured-equity or committed-equity versions of COZIE-DOOR. At origination under COZIE-DOOR, the proper dollar-for-dollar incentive exists because no insured or committed equity has accrued and the homeowner is the residual claimant. Under insured-equity versions of COZIE-DOOR, the incentive drops further and further below the dollar-for-dollar level as insured equity builds up. Absent a maintenance contract, exactly the opposite sequence occurs under ANZIE-DOOR. Under committed-equity versions of COZIE-DOOR, the dollar-for-dollar incentive persists as long as the homeowner has equity in the home.

Another non-symmetric element involves the sign of the rate factor. Under ANZIE-DOOR, it is possible for the rate factor to be negative because the numerator in the rate factor equals the imputed interest on the priority block minus net rent. Under all COZIE-DOOR versions, net rent does not enter into the calculation. The homeowner continues to enjoy the imputed rental benefits. As a result, all of the elements in the rate factor numerator are positive. The investor is contributing payments (under the annuity version), imputed interest on a priority block loan (under the lump sum version), or both, and may contribute in other ways, e.g., by paying property taxes. As a result, the rate factor always is positive, and insured equity always accrues to the investor. There is no such guarantee for the homeowner under ANZIE-DOOR.

Under insured-equity versions of COZIE-DOOR, the guarantee of positive build up is icing on the cake for investors attracted by the prospect of accruing an unleveraged percentage ownership in a home over time. In contrast, under ANZIE-DOOR the investor faces a high risk of loss as residual claimant in a leveraged scheme. Due to the guarantee of positive build up, insured-equity versions of COZIE-DOOR give the investor an even more conservative stake in the home than the already very conservative stake the homeowner receives under ANZIE-DOOR. Clearly, the two categories of instruments are of interest to different kinds of investors. ANZIE-DOOR investors receive a pure dose of leveraged real estate ownership, a position that is ideal for diversification in large institutional accounts and for speculative investments in owner-occupied housing in general or in housing with specific geographic, demographic or other characteristics. In contrast, insured-equity versions of COZIE-DOOR are a much more conservative way to build up an equity stake. The enhanced expected return and higher risk from leverage are absent.

Committed-equity versions of COZIE-DOOR involve risks from leverage if the investor finances part of the priority block with mortgage debt, but the investor's equity is in a preferred position compared to being the residual claimant under ANZIE-DOOR. The risk of total loss for the investor is higher under committed-equity versions of COZIE-DOOR with mortgage borrowing than under insured-equity versions because total loss under the latter only occurs if the home ends up having zero value. On the other hand, if there is enough of a homeowner (residual claimant) equity cushion under the committed-equity version of COZIE-DOOR, the investor is not affected by moderate drops in home value. There is a loss to the investor under insured-equity versions from any decline in home value because the value of the insured equity position is lower if home value is lower. These different risk profiles follow from the shape of each arrangement: The investor's equity position under committed-equity versions is a “horizontal” slice in the middle of the capital structure. Under insured-equity versions, it is a “vertical” slice consisting of a percentage of total home value.

It is easy to visualize a “standard” tax treatment for the parties under COZIE-DOOR that is very similar to the treatments suggested herein for the other variants. Whichever party pays property taxes or mortgage interest (if any) deducts them. Under insured-equity versions, the insured equity account results in capital gain/capital loss not subject to any special owner-occupied housing rules such as the §121 exclusion. The homeowner's gains and losses on the home itself are subject to such rules under all versions. Periodic payments to the homeowner do not result in current income or deductions for the parties but have basis implications for the insured equity side deal under insured-equity versions and for the homeowner's residual claimant position, along with the investor's committed equity position under committed-equity versions. Similarly, a lump sum payment to the homeowner combined with an offsetting priority block position for the investor results solely in basis adjustments, and the homeowner's basis in the home drops, but not below zero. (Capital gain would result to the extent a lump sum payment exceeded basis.) The investor's initial basis in the priority block position is equal to the amount of the lump sum payment. Accrual of committed equity under committed-equity versions increases basis for the investor's committed equity position and decreases the homeowner's basis but does not result in current income or deductions.

IS-A-DOOR

Shifting Homeowner Objectives

Homeowner objectives shift over time and with changing circumstances. Many young homeowners want to build up home equity but with a minimum of committed funds and without unbalancing their portfolios. ANZIE-DOOR and derivative variants such as ANZIE'S SIDE DOOR are ideal for this purpose. In later parts of the life cycle the objective might be to stay in a particular home but realize a stream of income corresponding to the home equity. Versions of COZIE-DOOR are effective at satisfying this objective.

Aside from life cycle considerations, homeowners may face temporary circumstances that make an existing arrangement suboptimal. For instance, they might be faced with unexpected medical costs that make withdrawing home equity desirable. On the other side of the coin, a homeowner might experience unexpected success that makes a different DOOR variant more attractive.

Low Cost “Refinancing” Via IS-A-DOOR

Much of the need for flexibility can be built into each DOOR variant. Provision might exist to withdraw or add funds in lump sum or via periodic or occasional payments. But the inherent flexibility that stems from the analytic adjustment engine admits much more radical possibilities, such as IS-A-DOOR. Under IS-A-DOOR, the homeowner can switch at any time between any one neutral DOOR instrument and any other one. Thus, all we can say is that what the homeowner has “is a DOOR.”

IS-A-DOOR builds in a very low cost, very broad, and on-going refinancing option. Instead of requiring an appraisal, large closing costs, lots of paperwork and lost time, refinancing requires only a few minutes on the phone or at a keyboard. Because both the old instrument and the new instrument are neutral, the analytic engine adjusts appropriately for whatever changes the homeowner desires.

There might be some limits to the possible changes. For example, changes that extinguish built up insured equity in favor of the homeowner might imperil the effectiveness of any attached maintenance contract. Nonetheless, incredible breadth and flexibility is possible.

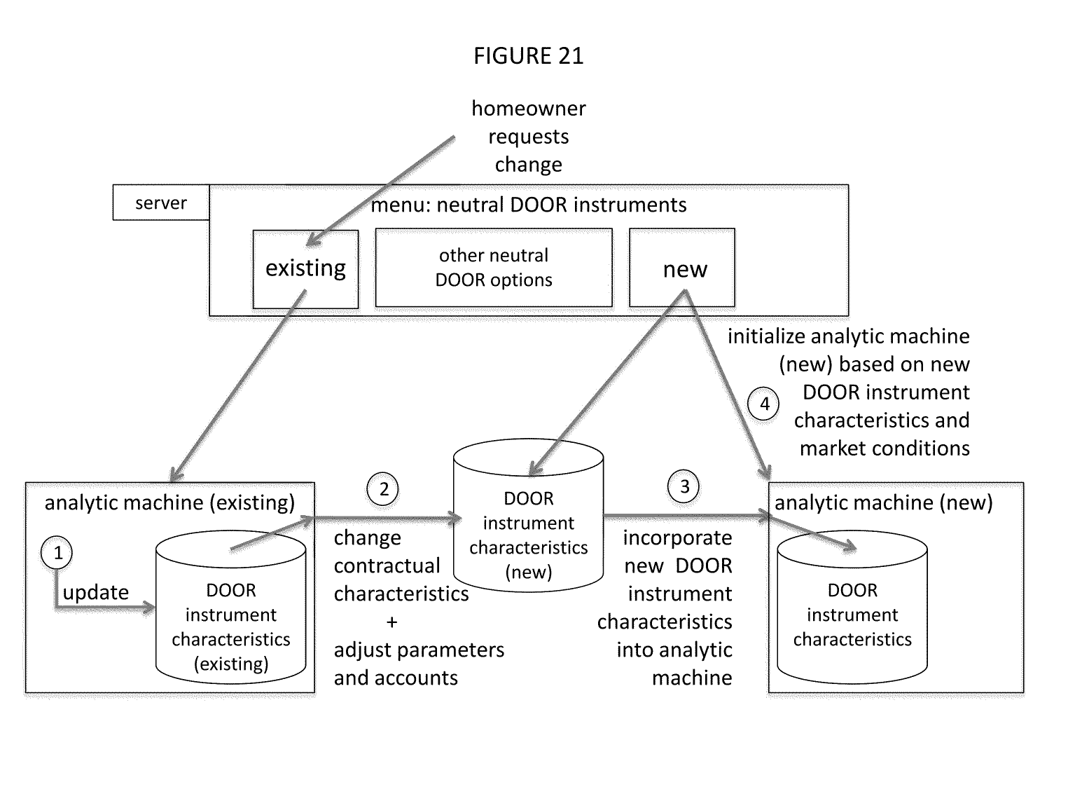

FIG. 21 is a flow chart diagram illustrating the machine that implements IS-A-DOOR. This machine executes homeowner requested shifts between neutral DOOR instruments. As shown at the top of the figure, the process begins with a homeowner request for a change. This request is processed by a server or other device that contains a menu of available neutral DOOR instruments. The device locates the existing instrument and the requested new instrument. The analytic machine for the existing DOOR instrument includes a DOOR instrument characteristics cylinder that contains the instructions for the instrument as well as the values and history of all critical accounts such as insured equity updated (as step “1”) using the existing analytic machine to be current as of the time of the homeowner's request. A biological analogy is apt: The DOOR instrument characteristics cylinder is like the nucleus of a cell; the analytic machine itself being the cell. The nucleus contains all of the critical information that directs the cell operations. Changing DOOR instruments involves removing the nucleus, altering it, and then implanting it in a new cell, the analytic machine for the new DOOR instrument. The alterations (step “2”) include: (i) replacing the operating instructions for the existing DOOR instrument with the operating instructions for the new one; and (ii) adjusting the parameters and accounts to be compatible with the new instrument and its analytic machine. For example, if the existing instrument is a version of ANZIE-DOOR and the new instrument an insured equity annuity version of COZIE-DOOR, then the homeowner's insured equity balance under the existing instrument needs to be converted to actual homeowner “residual claimant” equity under the new instrument. The current insured equity balance is available from the existing DOOR instrument characteristics cylinder because both home value and the insured equity percentage have been currently updated in step “1” by the analytic machine for the existing instrument and then stored in that cylinder. The insured equity account under the new DOOR instrument will belong to the investor not the homeowner. After the alterations are complete, the new DOOR instrument characteristics cylinder is incorporated (step “3”) into an appropriate analytic machine for the new instrument. This analytic machine runs (step “4”), creating initial parameters for the operation of the new DOOR instrument.

DOORs for Rescue

During the current housing crisis, “rescue,” the process of refinancing homeowners in an “underwater” position where mortgage debt exceeds home value, has proven very challenging. The situation is particularly difficult when the homeowner is mortgagor on more than one mortgage and the mortgages are part of securitized pools. Workouts require the assent of all of the mortgagees, and pool trustees may refuse participation, reluctant to make concessions because of potential legal challenges from pool investors. Even in the situation where there is only one mortgagee and the mortgage is not part of a pool, some mortgagees have been reluctant to forgive principal or take other steps to rationalize the situation, hoping that homeowners personally attached to their homes keep paying, even when they should default. Many homeowners caught in this situation are in extremis, at least in a balance sheet sense. The home may have been their primary asset, and much of their wealth is gone.

Several DOOR variants apply strongly to this situation. It is quite possible to “rescue” the homeowner but leave the loan balances intact, with the home still “underwater.” One route is an ANZIE-DOOR type of variant. The first mortgagee or a third party such as a government might issue an ANZIE-DOOR instrument to the homeowner. The homeowner gives up the risky appreciation inherent in the leverage but builds up a stake in the form of insured equity. The existing loans comprise the priority block, and the homeowner continues to pay interest. Because the home is underwater, insured equity accrues very fast. Table 5 shows how high the rate factor is for a home that is about 17% underwater. It is high indeed, most likely greater than 1. The insured equity percentage goes from zero to 5% or so during the first year.

This fast accrual compensates the homeowner completely for continuing to service the loans, and there is no longer an incentive to default. If the homeowner needs some assistance in meeting the servicing obligation, some versions of ANZIE'S SIDE DOOR are very effective. For instance, the deal might include a periodic side payment to the homeowner at the cost of somewhat slower accrual of insured equity.

A second route is to use a committed-equity annuity version of COZIE-DOOR. Under this version, the homeowner continues to service the loans and receives substantial periodic payments that enable the servicing. The investor builds up committed equity while the homeowner retains the “high-powered” equity that emerges if the home price rebounds and clears the level of the loans and committed equity. This type of arrangement might be ideal for risk-averse local governments or non-profit entities. Their equity stake has preferred status over the homeowner's equity but still builds up over time.

It also would be possible to use an insured-equity annuity version of COZIE-DOOR, but, in rescue situations, using the committed-equity annuity version typically is a much better approach. The insured-equity version only works if the homeowner's commitment to pay the insured equity at sale is credible. This credibility is particularly problematic in rescue situations: The homeowner has no conventional equity in the home at the beginning of the arrangement, and a significant amount of appreciation may be necessary before the homeowner's equity covers the insured equity obligation. The application discussed elsewhere herein involved a very different initial situation: The home was not mortgaged all. As discussed, the insured-equity annuity version of COZIE-DOOR typically might ensure that this initial situation continues by barring mortgage borrowing against the home. Doing so protects the investor's insured equity position by ensuring that adequate funds are available to cover that position at sale.

ANZIE-DOOR and the committed-equity version of COZIE-DOOR are not the only two attractive approaches. The possibilities are as broad as the very wide set of options under DOOR. An interesting one is to introduce a debt pay-off element similar to ANZIE'S NU DOOR or ANZIE'S NU TRIE DOOR. The investor might pay off part of the homeowner's debt based on a schedule or even conditional on certain market conditions, e.g., further declines in price. Unlike conventional debt forgiveness, the investor receives market-based compensation in some form that depends on the basic nature of the instrument: a slower accrual of insured equity in favor of the homeowner (ANZIE-DOOR), a faster accrual in favor of the investor (COZIE-DOOR), lower support payments to the homeowner (ANZIE'S SIDE DOOR), etc.

These debt pay off variants suggest a general point. One reason that mortgagees are reluctant to write off debt is that they, along with homeowners, are trapped in a system that is: (i) filled with perverse incentives that arise from embedded options; and (ii) characterized by extreme inflexibility because refinancing into a more appropriate deal is very costly. In the DOOR world, there is no reason to maintain debt levels and hold the homeowner underwater. Writing down debt results in a market deal that compensates the former creditor appropriately. The underwater situation has no particular appeal to DOOR investors. Under ANZIE-DOOR, for example, in the underwater situation the investor has the hope that a housing rebound will restore investor equity in the home, i.e., a powerful call option. But at the same time, the investor is paying for this option by allowing insured equity to accrue at very high rates in favor of the homeowner.

In sum, DOOR instruments provide an incredibly powerful array of tools for the rescue situation. The exact approach can be tailored to the tastes and goals of the homeowner and the rescuer.

Computer Implementation

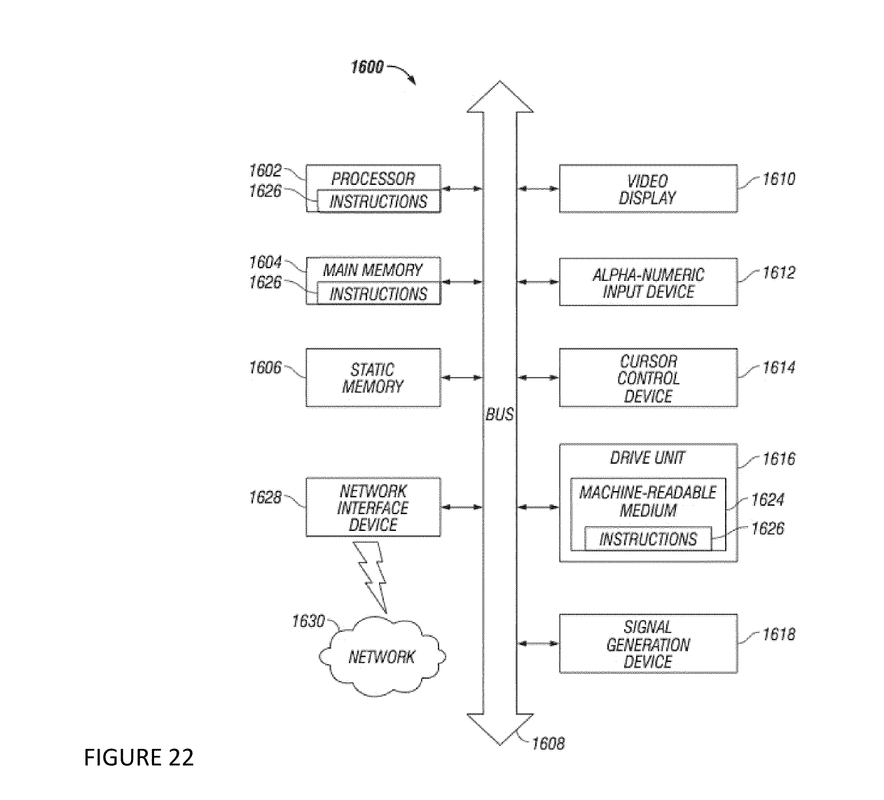

FIG. 22 is a block schematic diagram of a machine in the exemplary form of a computer system 1600 within which a set of instructions for causing the machine to perform any one of the foregoing DOOR methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Conclusion

Current housing markets are dysfunctional, in large part because current finance methods are defective. The common methods result in inappropriate financial positions for many homeowners, create moral hazard and valuation difficulties due to embedded options, result in inadequate maintenance incentives, and are inflexible because refinancing is costly, even when the parties want to change relatively minor aspects of the deal. It is easy to design DOOR variants that eliminate all of these problems. DOOR instruments are a vastly superior approach across a wide spectrum of homeowner goals: building up home equity without sacrificing portfolio balance, entry level home ownership from a position of low wealth, retirement income, rescue, and more. At the same time, DOOR instruments offer new and extremely valuable vehicles for investors with respect to a very large but relatively inaccessible asset class: owner-occupied real estate.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-program product tangibly embodied in a non-transitory, machine-readable storage medium having instructions stored thereon, the instructions operable to cause a data processing apparatus to perform operations including simulating large scale automatic data combinations, the method comprising:
displaying representations of multiple equity models to provide equity simulations specified by equity type and stakeholder with regard to economic, housing, and personal characteristics data;
accessing inputs that represent a selection of at least one of the equity models and the identities of the stakeholders;
updating or initiating model-independent dynamic databases stored within a storage medium of the computer system that include said data, accessing said data from public or private network-accessible sources in two streams, a directly transferable stream and a stream that includes irregular data; said updates occurring both on a periodic basis and when required by either stakeholder;
dynamically organizing both data streams, identifying any discrepancies or irregularities in the acquired data, wherein data imputation routines are executed by a computational element to address and correct said discrepancies and irregularities;
converting all data stored within the storage medium of the computer system having dissimilar formats into a single common format;
accessing and receiving over a network connection and from another computer system a third data stream that includes initialization data and simulation instructions embodied in the selected model associated with a contractual commitment transaction that represents a particular real-time relationship between a first stakeholder amount and a second stakeholder amount, wherein the first stakeholder account and the second stakeholder account are associated with a first entity and a second entity, respectively, that are parties to the contractual commitment transaction;
accessing and receiving from another computer system data representing relevant information of a duration of the contractual commitment transaction and data representing relevant information of the history of the underlying real property ownership stakes;
when the selected model includes insured equity allocations to the one of the stakeholders:
evaluating, based on an input stream from another computer system, whether an ownership interest in real property of the contractual commitment transaction has been sold and, if so, whether an initial ownership stake has been set and whether previous ownership stakes have been computed;
upon determining the ownership interest in real property has been sold, automatically updating the storage medium of the computer system based on the determination, incorporating data on previous ownership stakes, if any;
evaluating the initialization data and generating a transaction data stream that represents initial and historical states of the contractual commitment transaction;
accessing the relevant data from the storage medium of the computer system including new data retrieved from any of the public or private network-accessible databases or from the other computer system and processed in said updating or initiating data step;
accessing simulation instructions associated with the selected model and computing adjusted values of said relevant data accordingly;
identifying the net contribution of said stakeholder;
computing a percentage of insured equity held by such stakeholder upon said real property value,
wherein the percentage is computed by increasing or decreasing an initial percentage specified at the time the contractual commitment transaction was initiated on the other computer system, and
wherein the increase or decrease is determined by computing:
a termination percentage at the time of termination for each of a plurality of time segments that includes an initial time segment and a termination time segment,
and for each time period:
a net contribution rate of said stakeholder divided by an expected unleveraged market rate of return on the real property,
a time at which each time segment begins,
a riskless rate for an investment of the same duration as the real property, and
a length of each time segment;
electronically calculating allotted ownership interests in the real property for the first stakeholder account and for the second stakeholder account managed by the computer system in accordance with equity allocations of different types computed by the computer system based on the contributions of the stakeholders, the debt obligations of the stakeholders, and the computed percentage of insured equity allocated to one of the stakeholders;
displaying the simulated allotted ownership interests for the real property in the first stakeholder account and for the second stakeholder account by equity type based upon the inputted identity of the stakeholders and the results of the simulation; and
redisplaying the representations of multiple equity models to allow selection of a new model for simulation.
